(19) United States
(12) Patent Application Publication
(10) Pub. No.: US 2026/0263938 A1
(43) Pub. Date: Sep. 10, 2026

(54) METHOD OF GENERATING PARTICLE EFFECT

(71) Applicant: Tencent Technology (Shenzhen) Company Limited, Shenzhen (CN)

(72) Inventors: Mengyu ZHU, Shenzhen (CN); Xiange HAN, Shenzhen (CN); Yi ZENG, Shenzhen (CN); Gongxian CAI, Shenzhen (CN); Tingting LI, Shenzhen (CN); Yang HU, Shenzhen (CN)

(73) Assignee: Tencent Technology (Shenzhen) Company Limited, Shenzhen, GD (CN)

(21) Appl. No.: 19/561,494

(22) Filed: Mar. 9, 2026

Related U.S. Application Data
(63) Continuation of application No. PCT/CN2024/116321, filed on Sep. 2, 2024.

(30) Foreign Application Priority Data
Nov. 17, 2023 (CN) 202311551186.5

(51) Int. Cl. A63F 13/63; A63F 13/52; A63F 13/537; G06T 13/20; G06T 19/20

(52) U.S. Cl. CPC A63F 13/63; A63F 13/52; A63F 13/537; G06T 13/20; G06T 19/20; A63F 2300/6638; G06T 2200/24; G06T 2210/12; G06T 2210/62; G06T 2219/2012; G06T 2219/2016

(57) ABSTRACT

In a method of generating a particle effect in a virtual environment, an editor interface of a user generated content (UGC) editor is displayed on a display of a terminal. In the method, a particle generator disposed in the virtual environment is displayed on the editor interface of the UGC editor, the particle generator including a base that is visible on the editor interface and hidden on a play mode interface of the UGC editor. In the method, at least one attribute parameter for the particle generator is received based on an attribute setting operation on the editor interface. In the method, the particle effect in the virtual environment is generated based on the at least one attribute parameter, the particle effect corresponding to a visualization of at least one particle generated by the particle generator in the virtual environment.

### RELATED APPLICATIONS

The present application is a continuation of International Application No. PCT/CN2024/116321, filed on Sep. 2, 2024, which claims priority to Chinese Patent Application No. 202311551186.5, filed on Nov. 17, 2023. The entire disclosures of the prior applications are hereby incorporated by reference.

### FIELD OF THE TECHNOLOGY

This disclosure relates to the field of gaming, including an effect generation method and apparatus in a game program, a device, a computer-readable storage medium, and a computer program product.

### BACKGROUND OF THE DISCLOSURE

User Generated Content (UGC) refers to self-created content shared by users on the Internet. In the gaming industry, developers encourage users to participate in designing game content such as level maps, gameplay mechanics, and ecosystems by providing corresponding UGC editing capabilities in a game. To enhance the diversity of user-created level maps, developers integrate various effect components into UGC editors, allowing users to use these effect components to incorporate effects into their level maps.

However, effect components provided in related technologies are typically pre-designed by developers, resulting in a lack of diversity in UGC effects that users can create.

### SUMMARY

This disclosure provides an effect generation method and apparatus in a game program, a device, a computer-readable storage medium, and a computer program product.

According to an aspect of this disclosure, a method of generating a particle effect in a virtual environment is provided. In the method, an editor interface of a user generated content (UGC) editor is displayed on a display of a terminal through execution of a game program by processing circuitry of the terminal. In the method, a particle generator disposed in the virtual environment is displayed on the editor interface of the UGC editor, the particle generator including a base that is visible on the editor interface and hidden on a play mode interface of the UGC editor. In the method, at least one attribute parameter for the particle generator is received based on an attribute setting operation on the editor interface. In the method, the particle effect in the virtual environment is generated based on the at least one attribute parameter, the particle effect corresponding to a visualization of at least one particle generated by the particle generator in the virtual environment.

According to an aspect of this disclosure, an apparatus for generating a particle effect in a virtual environment is provided. The apparatus includes a display and processing circuitry coupled to the display. The processing circuitry is configured to display, on the display through execution of a game program by the processing circuitry, an editor interface of a user generated content (UGC) editor. The processing circuitry is configured to display a particle generator disposed in the virtual environment on the editor interface of the UGC editor, the particle generator including a base that is visible on the editor interface and hidden on a play mode interface of the UGC editor. The processing circuitry is configured to receive at least one attribute parameter for the particle generator based on an attribute setting operation on the editor interface. The processing circuitry is configured to generate the particle effect in the virtual environment based on the at least one attribute parameter, the particle effect corresponding to a visualization of at least one particle generated by the particle generator in the virtual environment.

According to an aspect of this disclosure, a non-transitory computer-readable storage medium storing instructions of a game program is provided. The stored instructions, which when executed by a processor, cause the processor to perform a method of generating a particle effect in a virtual environment. In the method, an editor interface of a user generated content (UGC) editor is displayed on a display of a terminal. In the method, a particle generator disposed in the virtual environment is displayed on the editor interface of the UGC editor, the particle generator including a base that is visible on the editor interface and hidden on a play mode interface of the UGC editor. In the method, at least one attribute parameter for the particle generator is received based on an attribute setting operation on the editor interface. In the method, the particle effect in the virtual environment is generated based on the at least one attribute parameter, the particle effect corresponding to a visualization of at least one particle generated by the particle generator in the virtual environment.

According to an aspect of this disclosure, an effect generation method in a game program is provided, the method being performed by a terminal, the terminal running the game program, the game program including a user generated content UGC editor, and the method including: displaying a particle generator on an editor interface of the UGC editor; receiving, in response to an attribute setting operation on the particle generator, an attribute parameter set for the particle generator; and generating, in response to a trigger operation on the particle generator, a particle effect based on the attribute parameter, the particle effect including at least one particle generated by the particle generator.

According to an aspect of this disclosure, an effect generation apparatus in a game program is provided, the game program including a user generated content UGC editor, and the apparatus including: a first display module, configured to display a particle generator on an editor interface of the UGC editor; a first setting module, configured to receive, in response to an attribute setting operation on the particle generator, an attribute parameter set for the particle generator; and a first generation module, configured to generate, in response to a trigger operation on the particle generator, a particle effect based on the attribute parameter, the particle effect including at least one particle generated by the particle generator.

According to an aspect of this disclosure, a computer device is provided, the computer device including processing circuitry (e.g., a processor) and a memory, the memory including a non-transitory computer readable storage medium having a computer program stored therein, the computer program being loaded and executed by the processor to implement the foregoing UGC effect generation method in a game program.

According to an aspect of this disclosure, a non-transitory computer-readable storage medium is provided, having a computer program stored therein, and the computer program, when executed by processing circuitry (e.g., a processor), implementing the foregoing UGC effect generation method in a game program.

According to an aspect of this disclosure, a computer program product is provided, the computer program product including a computer program, the computer program being stored in a non-transitory computer-readable storage medium, and the computer program being read from the non-transitory computer-readable storage medium and executed by processing circuitry (e.g., a processor) of a computer device to cause the computer device to perform the foregoing UGC effect generation method in a game program.

The beneficial effects brought by the technical solutions provided in this disclosure at least include:

The foregoing solution adds a user-customizable particle generator to a UGC editor. Users can customize various particle effects by adjusting attribute parameters of the particle generator, thereby enriching effects in the UGC editor, meeting customization needs of the users, and improving the quality of effect generation.

### BRIEF DESCRIPTION OF THE DRAWINGS

To describe the technical solutions in the embodiments of this disclosure, the following briefly introduces the accompanying drawings. The accompanying drawings in the following description show merely some aspects of this disclosure.

FIG. 1 is an architectural diagram of a computer system according to an embodiment of this disclosure.

FIG. 2 is an architectural diagram of a computer system according to an embodiment of this disclosure.

FIG. 3 is a flowchart of a UGC effect generation method in a game program according to an embodiment of this disclosure.

FIG. 4 is a schematic diagram of a UGC effect generation method in a game program according to an embodiment of this disclosure.

FIG. 5 is a schematic diagram of a UGC effect generation method in a game program according to an embodiment of this disclosure.

FIG. 6 is a schematic diagram of a UGC effect generation method in a game program according to an embodiment of this disclosure.

FIG. 7 is a schematic diagram of a UGC effect generation method in a game program according to an embodiment of this disclosure.

FIG. 8 is a schematic diagram of a UGC effect generation method in a game program according to an embodiment of this disclosure.

FIG. 9 is a schematic diagram of a UGC effect generation method in a game program according to an embodiment of this disclosure.

FIG. 10 is a schematic diagram of a UGC effect generation method in a game program according to an embodiment of this disclosure.

FIG. 11 is a schematic diagram of a UGC effect generation method in a game program according to an embodiment of this disclosure.

FIG. 12 is a schematic diagram of a UGC effect generation method in a game program according to an embodiment of this disclosure.

FIG. 13 is a schematic diagram of a UGC effect generation method in a game program according to an embodiment of this disclosure.

FIG. 14 is a schematic diagram of a UGC effect generation method in a game program according to an embodiment of this disclosure.

FIG. 15 is a schematic diagram of a UGC effect generation method in a game program according to an embodiment of this disclosure.

FIG. 16 is a schematic diagram of a UGC effect generation method in a game program according to an embodiment of this disclosure.

FIG. 17 is a schematic diagram of a UGC effect generation method in a game program according to an embodiment of this disclosure.

FIG. 18 is a schematic diagram of a UGC effect generation method in a game program according to an embodiment of this disclosure.

FIG. 19 is a schematic diagram of a UGC effect generation method in a game program according to an embodiment of this disclosure.

FIG. 20 is a schematic diagram of a UGC effect generation method in a game program according to an embodiment of this disclosure.

FIG. 21 is a schematic diagram of a UGC effect generation method in a game program according to an embodiment of this disclosure.

FIG. 22 is a schematic diagram of a UGC effect generation method in a game program according to an embodiment of this disclosure.

FIG. 23 is a schematic diagram of a UGC effect generation method in a game program according to an embodiment of this disclosure.

FIG. 24 is a schematic diagram of a UGC effect generation method in a game program according to an embodiment of this disclosure.

FIG. 25 is a schematic diagram of a UGC effect generation method in a game program according to an embodiment of this disclosure.

FIG. 26 is a flowchart of a UGC effect generation method in a game program according to an embodiment of this disclosure.

FIG. 27 is a flowchart of a UGC effect generation method in a game program according to an embodiment of this disclosure.

FIG. 28 is a structural block diagram of a UGC effect generation apparatus in a game program according to an embodiment of this disclosure.

FIG. 29 is a schematic structural diagram of a computer device according to an embodiment of this disclosure.

### DESCRIPTION OF EMBODIMENTS

To describe the objectives, technical solutions, and advantages of this disclosure, the following describes implementations of this disclosure in further detail with reference to the accompanying drawings.

When the following description involves the accompanying drawings, unless otherwise indicated, the same numerals in different accompanying drawings represent the same or similar elements. The implementations described in the following embodiments do not represent all implementations consistent with this disclosure. On the contrary, the described embodiments are merely examples of apparatuses and methods. Other embodiments are within the scope of the present disclosure.

The terms used in the present disclosure are for the purpose of describing various embodiments only and are not intended to limit the present disclosure. The singular forms of “a” and “the” used in the present disclosure and the appended claims are intended to include the plural forms as well, unless the context indicates otherwise. The term “and/or” used herein indicates and includes any or all possible combinations of one or more associated listed items.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Although the terms such as “first” and “second” may be used in the present disclosure to describe various information, the information is not to be limited to these terms. These terms are merely used to distinguish between information of the same type. For example, without departing from the scope of the present disclosure, the first parameter may also be referred to as the second parameter. Similarly, the second parameter may also be referred to as the first parameter. Depending on the context, for example, the term “if” used herein may be interpreted as “while” or “when,” or “in response to determination.”

For ease of understanding of the technical solutions provided in the embodiments of this disclosure, some examples of key terms used in the embodiments of this disclosure are explained below. The descriptions of the terms are provided as examples only and are not intended to limit the scope of the disclosure.

User Generated Content (UGC) may correspond to self-created content shared by users on the Internet. In the gaming industry, developers encourage users to participate in designing game content such as level maps, gameplay mechanics, and ecosystems by providing corresponding UGC editing capabilities in a game. Users are allowed to design game content, so that the sense of belonging of users is enhanced, and the diversity of game content is enriched, thereby better meeting personalized needs.

Virtual environment: A virtual environment may be displayed (or provided) when a client runs on a terminal. The virtual environment may be a simulated environment of the real world, or may be a semi-simulated and semi-fictional environment, or may be a fictional environment. The virtual environment may be any one of a two-dimensional virtual environment, a 2.5-dimensional virtual environment, and a three-dimensional virtual environment. This is not limited in this disclosure. The following embodiments are described by using an example in which the virtual environment is a three-dimensional virtual environment.

A particle generator may correspond to an editable component configured to generate a particle effect. The particle generator can generate one or more particles to form a particle effect. The particle generator is usually added to an application that needs to produce an effect, for example, post-processing software and a game engine. A user can edit, by modifying code of the particle generator or using an open graphical interface of the particle generator, a particle effect finally generated by the particle generator, to obtain various particle effects.

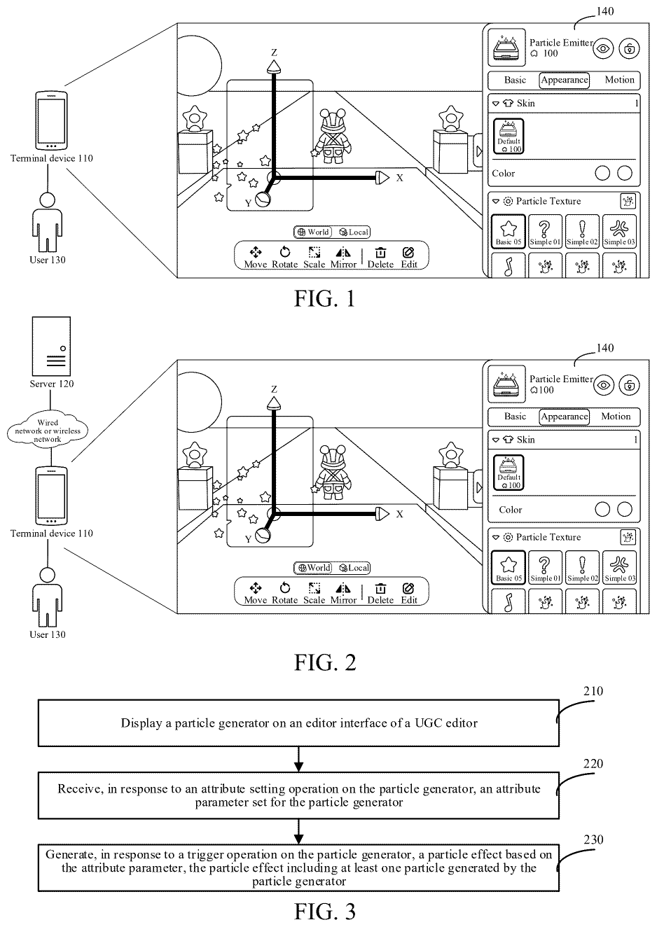

FIG. 1 and FIG. 2 are schematic diagrams of a computer system according to an embodiment of this disclosure. The computer system may include a terminal device 110 and a server 120.

The terminal device 110 may be a laptop portable computer, a desktop computer, a mobile phone, a tablet computer, an e-book reader, a video game console, or the like.

The terminal device 110 includes a memory and processing circuitry (e.g., a processor). The memory may include one or more computer-readable storage media. The computer-readable storage medium includes at least one of a random access memory (RAM), a read-only memory (ROM), and a flash memory. In some examples, the memory may include a non-transitory computer-readable storage medium. An operating system and a game program are installed in the memory (e.g., in the non-transitory computer-readable storage medium).

The game program may be any one of a level-based game, a casual competitive game, a massive multiplayer online game (MMOG), a board or card game, a multiplayer online battle arena (MOBA) game, a simulation game (SLG), a virtual reality application, a three-dimensional map program, a first-person shooting game (FPS) game, a multiplayer shooter survival game, a casual game, a party game, or a sandbox game.

A UGC editor is added to the game program, so that a user 130 can participate in the design of the game program. A developer of the game program provides the user 130 with maps or levels designed by the developer. The user 130 may play these maps or levels. After the UGC editor is added to the game program, the user 130 may design maps or levels using the UGC editor, and these maps or levels can also be played by the user 130. In this way, the sense of participation and the sense of belonging the user 130 toward the game program can be improved. The UGC editor is a tool provided by the developer for the user 130 to design maps or levels. The UGC editor includes interfaces opened by the developer to the user 130. To simplify the creation of maps or levels, these interfaces usually exist in the form of graphical interfaces. To be specific, the user 130 can obtain an exquisite map or level using the UGC editor only through simple operations such as clicking and sliding.

UGC editors added to different types of game programs have different focuses. For example, UGC editors added to MMOG games and SLG games mainly play an auxiliary role. For example, the user 130 can edit scenes in home space using the UGC editor. The home space is a virtual environment belonging to an area of the user 130. Level-based games, casual competitive games, party games, and sandbox games are usually centered around a UGC editor, so that the user 130 can freely create maps or levels and share these maps or levels with other users. In this type of games, the diversity of creation functions provided by the UGC editor significantly affects the gaming experience of the user 130.

The operating system is basic software that provides secure access to computer hardware for the game program. The operating system may be an Android system or an iOS system. The operating system supports downloading, installation, and running of the game program.

For example, the terminal device 110 further includes a touchscreen. The touchscreen may be a capacitive screen or a resistive screen. The touchscreen is configured to implement interaction between the terminal device and the user 130. In the embodiments of this disclosure, the terminal device obtains, through the touchscreen, interaction operations triggered by the user 130 on an editor interface 140 of the UGC editor in the game program.

The game program is installed and run on the terminal device 110. The editor interface 140 is designed in the game program.

The editor interface 140 allows the user 130 to edit, save, publish, and perform operations on the virtual environment. When editing the virtual environment, the user 130 may set up different virtual environments using virtual objects. The UGC editor allowing the user 130 to set a particle effect for a virtual environment to enrich the virtual environment. The particle effect is generated using a particle generator, thereby improving user operability and entertainment value.

The terminal device 110 is a terminal device used by the user. The user 130 operates the editor interface 140 using the terminal device 110. The user 130 may save a virtual environment that is being edited or has been edited to the terminal device 110. For example, the terminal device 110 is configured to upload virtual environment information saved by the user 130 to the server 120. Alternatively, the terminal device 110 is configured to provide a virtual environment and data information of the particle generator to the game program. Alternatively, the terminal device 110 is configured to store attribute parameters of the particle generator.

In some embodiments, the computer system further includes the server 120, as shown in FIG. 2. The server 120 may be any one of a plurality of servers, virtual cloud storage, or a cloud computing center. For example, the server 120 is configured to save the virtual environment information uploaded by the terminal device 110. Alternatively, the server 120 is configured to store the attribute parameters of the particle generator uploaded by the terminal device 110. Alternatively, the server 120 is configured to provide a virtual environment and data information of the particle generator to the game program.

In some embodiments, the terminal device 110 and the server 120 are connected to each other by a wired or wireless network.

FIG. 3 is a schematic diagram of a UGC effect generation method in a game program according to an embodiment of this disclosure. The method is performed by a terminal device. The terminal device may be the terminal device shown in FIG. 1 and FIG. 2. The method includes the following operations.

Operation 210: Display a particle generator on an editor interface of a UGC editor. For example, an editor interface of a UGC editor is displayed on a display of a terminal through execution of a game program by processing circuitry of the terminal. A particle generator disposed in a virtual environment is displayed on the editor interface of the UGC editor. In some examples, the particle generator may include a base that is visible on the editor interface and hidden on a play mode interface of the UGC editor. In some examples, the base of the particle generator may be hidden on a gaming interface of the game program. In some examples, the editor interface may include various control elements (or simply referred to as “controls” in this disclosure) configured to facilitate the configuration of the particle generator.

In some embodiments, a virtual environment picture is displayed on the editor interface of the UGC editor. The virtual environment picture is a picture obtained by capturing a three-dimensional virtual environment using a camera model. A user may control the camera model through interaction operations on a touchscreen to change display content of the virtual environment picture.

In some embodiments, the particle generator is an element configured to generate a particle. The element can be added to a virtual environment. In some embodiments, the element can be configured for decorating the virtual environment. Alternatively, the element can provide interaction for the user. The element may also be referred to as a component. The user can trigger at least one of an addition operation, a movement operation, a rotation operation, a scale operation, a deletion operation, and an editing operation on the particle generator. The addition operation is configured for adding a new particle generator to the virtual environment. The movement operation is configured to changing a position of the particle generator in the virtual environment. The rotation operation is configured for changing an angle of the particle generator in the virtual environment. The scale operation is configured for changing a size of the particle generator in the virtual environment. The deletion operation is configured for deleting a particle generator selected from the virtual environment. The editing operation is configured for changing an attribute parameter of the particle generator.

In some embodiments, at least one particle generator is displayed on the editor interface of the UGC editor. The at least one particle generator may have the same or different attributes. The attribute corresponds to one attribute parameter. The particle generator having the attribute can generate a particle having the corresponding attribute parameter.

Operation 220: Receive, in response to an attribute setting operation on the particle generator, an attribute parameter set for the particle generator. For example, at least one attribute parameter for the particle generator is received based on an attribute setting operation on the editor interface.

In some embodiments, the attribute setting operation may be an editing operation on the particle generator. To be specific, an attribute parameter edited for the particle generator is received in response to the editing operation on the particle generator. The attribute parameter set for the particle generator is an attribute parameter of a particle that can be generated by the particle generator.

In some embodiments, the particle generated by the particle generator includes at least one attribute parameter. The attribute parameter includes at least one of a color parameter, a scale parameter, a transparency parameter, a brightness parameter, an emission velocity, an emission position, a rotation angle, a rotation speed, a cycle period, a particle texture, a generation rate, and an acceleration. The color parameter indicates a color of the particle generated by the particle generator in the cycle period. The scale parameter indicates a scaling factor of the particle generated by the particle generator in the cycle period. The scaling factor indicates a scaling ratio relative to a default particle size. The transparency parameter indicates a transparency level of the particle generated by the particle generator in the cycle period. The brightness parameter indicates a brightness level of the particle generated by the particle generator in the cycle period. The emission velocity indicates an initial motion velocity of the particle generated by the particle generator. The emission velocity includes at least one of an x-axis emission velocity, a y-axis emission velocity, and a z-axis emission velocity. The emission position indicates an initial position of the particle generated by the particle generator. The rotation angle indicates an initial rotation angle of the particle generated by the particle generator. The rotation speed indicates a rotation speed of the particle generated by the particle generator. The cycle period indicates duration of existence of the particle generated by the particle generator. The particle texture indicates a texture of the particle generated by the particle generator. The generation rate indicates a quantity of particles generated by the particle generator in a first unit time. The acceleration indicates an acceleration of the particle of the particle generator. The acceleration includes at least one of an x-axis acceleration, a y-axis acceleration, and a z-axis acceleration.

Operation 230: Generate, in response to a trigger operation on the particle generator, a particle effect based on the attribute parameter, the particle effect including at least one particle generated by the particle generator. For example, the particle effect is generated in the virtual environment based on the at least one attribute parameter. In some examples, the particle effect corresponds to a visualization of at least one particle generated by the particle generator in the virtual environment.

In some embodiments, in response to the trigger operation on the particle generator, the particle generator starts generating the particle based on the attribute parameter. The at least one particle generated by the particle generator forms the particle effect.

In some embodiments, an effect generation control may be provided for the particle generator. Based on this, Operation 230 may be implemented by performing the following operation: generating, in response to a trigger operation on the effect generation control, a particle effect based on the attribute parameter, the particle effect including at least one particle generated by the particle generator.

In summary, the method provided in the embodiments of this disclosure adds a user-customizable particle generator to a UGC editor. Users can customize various particle effects by adjusting attribute parameters of the particle generator, thereby enriching effects in the UGC editor, meeting customization needs of the users, and improving the quality of UGC effect generation.

The terminal device receives, in response to the attribute setting operation on the particle generator by the user, the attribute parameter set for the particle generator. This disclosure shows three different attribute setting operations, and an attribute setting manner of an attribute parameter includes, but is not limited to, at least one of the following three setting manners (the sequence does not represent the quality of implementations):

Setting Manner 1: Set the attribute parameter based on a key frame control.

Setting Manner 2: Set an attribute parameter interval based on an attribute parameter interval setting control.

Setting Manner 3: Set the attribute parameter directly.

Any one of the three setting manners may be used for different attribute parameters. This is not limited in this disclosure.

The following separately describes the foregoing three setting manners.

### Setting Manner 1: (Key Frame Control)

In the embodiment based on FIG. 3, Operation 220 may be implemented as Operation 221 and Operation 222 instead.

Operation 221: Display at least two key frame controls on the editor interface in response to the attribute setting operation on the particle generator. For example, at least two key frame control elements are displayed on the editor interface based on the attribute setting operation on the particle generator. In some examples, the at least two key frame control elements correspond to different key frame moments within a cycle period.

The at least two key frame controls are configured to edit attribute parameters of the particle at at least two key frame moments in a cycle period. The cycle period indicates duration from generation to disappearance of the particle. The key frame controls are in a one-to-one correspondence with the key frame moments, and each of the key frame moments is a moment corresponding to one of the key frame controls in the cycle period.

In some embodiments, the key frame control includes at least one of a Button control, an ImageButton control, and a User Created control.

In some embodiments, at least two key frame controls are displayed on the editor interface in response to the attribute setting operation on the particle generator. In some embodiments, the 1^{st} key frame control is also referred to as a start frame control, and the last key frame control is also referred to as an end frame control.

In some embodiments, the key frame control is displayed as a simple graphic, for example, a circle, a square, or a triangle. Alternatively, the key frame control is displayed as an icon.

In some embodiments, when the key frame control is in a selected state, the key frame control is highlighted. For example, the key frame control is displayed as a circle, the key frame control in a selected state is displayed as a ring, and the ring is highlighted.

In some embodiments, the attribute parameter includes the cycle period, and the cycle period indicates the duration from generation to disappearance of the particle.

In some embodiments, the attribute parameter of the particle is related to the cycle period. When the attribute parameter is set using a key frame control, each key frame control corresponds to one moment in the cycle period. The moment is a key frame moment corresponding to the key frame control.

In some embodiments, the start frame control corresponds to the beginning of a cycle period. To be specific, a key frame moment corresponding to the start frame control is the 0^{th} second of particle generation. The end frame control corresponds to the end of a cycle period. To be specific, a key frame moment corresponding to the end frame control is a current moment at which the particle disappears, i.e., a moment corresponding to the end of the cycle period. For example, the cycle period is 3 seconds. Each key frame control corresponds to one key frame moment in the cycle period. For example, the 0^{th} second moment corresponds to one key frame control (i.e., the start frame control), the 1^{st} second moment corresponds to one key frame control, the 2^{nd} second moment corresponds to one key frame control, the 3^{rd} second moment corresponds to one key frame control (i.e., an end frame control), and so on.

Operation 222: Determine, in response to a trigger operation on an i^{th} key frame control of the at least two key frame controls, that an attribute parameter of the particle at an i^{th} key frame moment is an attribute parameter corresponding to the i^{th} key frame control, i being a positive integer. For example, an attribute parameter for each of the key frame moments is obtained based on a trigger operation on the respective key frame control element.

In some embodiments, the determining that an attribute parameter of the particle at an i^{th} key frame moment is an attribute parameter corresponding to the i^{th} key frame control is precisely: determining that an attribute parameter value of the particle at an i^{th} key frame moment is an attribute parameter value corresponding to the i^{th} key frame control. For example, if the user sets the attribute parameter value to 1 using the i^{th} key frame control, the attribute parameter value of the particle at the i^{th} key frame moment is the attribute parameter value 1 set by the user using the i^{th} key frame control.

In some embodiments, the attribute parameter value of the particle in the cycle period changes step by step, i.e., changes abruptly, as per attribute parameter values that correspond to the first key frame control to the last key frame control. For example, 4 key frame controls are provided, and attribute parameter values corresponding to the 4 key frame controls are 0, 3, 2, and 4, respectively. The cycle period of the particle is 3 seconds. Key frame moments corresponding to the 4 key frame controls are the 0^{th} second, the 1^{st} second, the 2^{nd} second, and the 3^{rd} second, respectively. The attribute parameter value of the particle is 0 from the 0^{th} second to the 1^{st} second, and changes abruptly to 3 at the 1^{st} second. The attribute parameter value is 3 from the 1^{st} second to the 2^{nd} second, and changes abruptly to 2 at the 2^{nd} second. The attribute parameter value is 2 from the 2^{nd} second to the 3^{rd} second, and changes abruptly to 4 at the 3^{rd} second, and then the particle disappears. Alternatively, the attribute parameter value of the particle in the cycle period changes gradually, i.e., transitions, as per attribute parameter values corresponding to the first key frame control to the last key frame control. A gradual change process of the attribute parameter value satisfies a straight line with two adjacent key frame controls as endpoints. Alternatively, the gradual change process of the attribute parameter value satisfies a curve passing through two adjacent key frame controls. For example, 3 key frame controls are provided, and attribute parameter values corresponding to the 3 key frame controls are 0, 1, and 0, respectively. The cycle period of the particle is 3 seconds. Key frame moments corresponding to the 3 key frame controls are the 0^{th} second, the 1^{st} second, and the 3^{rd} second, respectively. It may be obtained that a straight line between the 1^{st} key frame control and the 2^{nd} key frame control is y=x, and a straight line between the 2^{nd} key frame control and the 3^{rd} key frame control is y=−0.5x+1.5. x is a corresponding moment in the cycle period, and y is the attribute parameter value of the particle. To be specific, a relationship between the attribute parameter value of the particle from the 0^{th} second to the 1^{st} second and the corresponding moment in the cycle period satisfies the straight line y=x. For example, the attribute parameter value at the 0.5th second is 0.5. A relationship between the attribute parameter value from the 1^{st} second to the 3^{rd} second and the corresponding moment in the cycle period satisfies y=−0.5x+1.5. For example, the attribute parameter value at the 2^{nd} second is 0.5.

In summary, the method provided in the embodiments of this disclosure provides a manner for the user to set the attribute parameter using a key frame control. Because each key frame control corresponds to one key frame moment in the cycle period, i.e., the user may set, using a key frame control, the attribute parameter value of the particle at a key frame moment in the cycle period. In this manner, a change of the attribute parameter of the particle generated by the particle generator in the cycle period can be flexibly set.

In some embodiments, the particle generated by the particle generator includes at least one attribute parameter. The attribute parameter includes at least one of a color parameter, a scale parameter, a transparency parameter, a brightness parameter, an emission velocity, an emission position, a rotation angle, a rotation speed, a cycle period, a particle texture, a generation rate, and an acceleration. In some examples, the at least one attribute parameter includes at least one of a cycle period, a color parameter indicating a color of the at least one particle, a scale parameter indicating a scaling factor of the at least one particle, a transparency parameter indicating a transparency level of the at least one particle, and a brightness parameter indicating a brightness level of the at least one particle. In some examples, the at least one attribute parameter includes at least one of an emission velocity indicating an initial motion velocity of the at least one particle, an emission position indicating an initial position of the at least one particle, a rotation angle indicating an initial rotation angle of the at least one particle, and a rotation speed indicating an initial rotation speed of the at least one particle. In some examples, the at least one attribute parameter includes at least one of the cycle period indicating a duration from generation to disappearance of the at least one particle, an emission position indicating an initial position of the at least one particle, a particle texture indicating a texture of the at least one particle, a generation rate indicating a quantity of particles generated by the particle generator in a first unit time, and an acceleration indicating an acceleration of the at least one particle.

In some examples, the receiving the at least one attribute parameter may include determining an attribute parameter interval based on the attribute setting operation on the editor interface, the attribute parameter interval indicating a parameter range of the at least one attribute parameter of the at least one particle. In some examples, the receiving the at least one attribute parameter may include determining an attribute parameter value based on the attribute setting operation on the editor interface.

The user can set one or more of the foregoing attribute parameters in Setting Manner 1. For example, the attribute parameter set in Setting Manner 1 includes at least one of the color parameter, the scale parameter, the transparency parameter, and the brightness parameter.

Setting manners of setting the attribute parameter using a key frame control are separately described below.

### 1.1 Set the Color Parameter Using a Key Frame Control

In some embodiments, the color parameter indicates a color of the particle generated by the particle generator in the cycle period.

In some embodiments, Operation 221 may be implemented as Operation 2211, and Operation 222 may be implemented as Operation 2221.

Operation 2211: Display at least two color key frame controls and a particle color selection operation control in response to a trigger operation on a color setting entry of the particle generator.

In some embodiments, in response to the trigger operation on the color setting entry of the particle generator, at least one of at least two color key frame controls, a color coordinate axis, a particle color selection tab, and a particle color selection operation control is displayed on an editor interface. The at least two color key frame controls are located on the color coordinate axis. The color coordinate axis indicates color changes of the particle in the cycle period. The particle color selection tab indicates a color selection mode. The particle color selection tab includes at least one of a color palette tab, a color picker tab, and a history tab. Different particle color selection tabs correspond to different particle color selection operation controls. The color palette tab corresponds to a color palette color selection control. The color picker tab corresponds to a color picker color selection control. The history tab corresponds to a history color selection control. The particle color selection operation control is configured to select a color from the at least one candidate color.

In some embodiments, each of the color key frame controls includes at least one of a Button control, an ImageButton control, and a User Created control. The color coordinate axis includes at least one of an Image control, ImageView, and a User Created control. The particle color selection tab includes at least one of a TabLayout control and a User Created control. The particle color selection operation control includes at least one of a Button control, an ImageButton control, an Image control, and ImageView.

In some embodiments, the color coordinate axis indicates a color change of the particle in the cycle period, and two ends of the color coordinate axis correspond to the 1^{st} color key frame control and the last color key frame control, i.e., the start frame control and the end frame control, respectively.

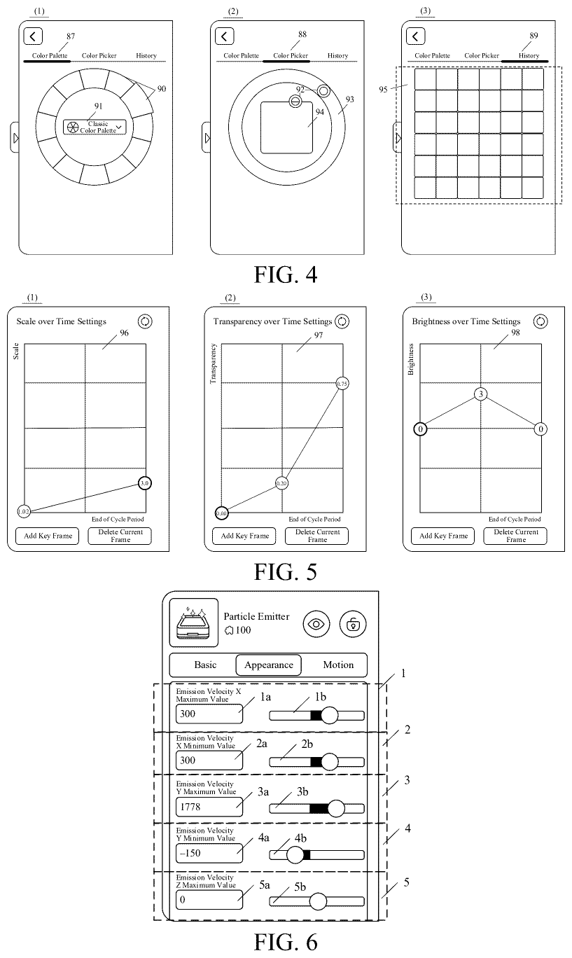

In some embodiments, as shown in FIG. 4, the particle color selection tab includes at least one of a color palette tab 87, a color picker tab 88, and a history tab 89. As shown in the schematic diagram (1) of FIG. 4, the color palette tab 87 corresponds to a color palette color selection control 90, and the color palette color selection control 90 is configured to select a color from the at least one candidate color. The color palette tab 87 further includes a color palette switch control 91. The color palette switch control 91 is configured to switch candidate colors of different color combinations. As shown in the schematic diagram (2) of FIG. 4, the color picker tab 88 corresponds to a color picker color selection control 92. The color picker color selection control includes a color wheel control 93 and a lightness control 94. The color wheel control 93 is a Red Green Blue (RGB) color wheel or a Red Yellow Blue (RYB) color wheel, i.e., a color selection interval obtained by mixing red, green, and blue or red, yellow, and blue as primary colors. The lightness control 94 indicates the intensity of color brightness. The lightness change displayed by the lightness control 94 is that from bottom to top, the lightness increases, i.e., the color gradually changes from black to white, and from left to right, the lightness decreases, i.e., the color gradually changes from white to black. When the user performs a color selection operation on the color wheel control, the lightness control displays lightness transformation information corresponding to a color selected from the color wheel control. As shown in the schematic diagram (3) of FIG. 4, the history tab 89 corresponds to a history color selection control 95, and a color in the history tab 89 is a color that has been selected or used by the user.

Operation 2221: Determine, in response to a trigger operation on the particle color selection operation control when an i^{th} color key frame control of the at least two color key frame controls is in a selected state, that the attribute parameter of the particle at the i^{th} key frame moment is a color parameter selected by the particle color selection operation control, i being a positive integer.

The i^{th} color key frame control being in a selected state means that the i^{th} color key frame control is selected. The particle color selection operation control is configured to select a target color from at least one candidate color. Color values (i.e., values of the color parameter) of different candidate colors are different. The color parameter selected based on the particle color selection operation control is precisely a color value of the target color selected based on the particle color selection operation control.

For example, 3 color key frame controls are provided. The user selects 2^{nd} color key frame control. The color selection tab includes the color palette tab, the color picker tab, and the history tab. The user selects a color using the color palette color selection control of the color palette tab, and a color value selected by the user using the color palette color selection control is set to a color value of the particle at the 2^{nd} key moment. Alternatively, the user selects a color using the color picker color selection control of the color picker tab, and a color value selected by the user using the color picker color selection control is set to a color value of the particle at the 2^{nd} key moment.

In summary, the method provided in the embodiments of this disclosure provides the user with an operation manner of setting the color parameter using a color key frame control. When selecting a color, the user may select a color in any one of three different color selection modes, and set a selected color value as a color value of a corresponding particle at a key frame moment. In the three provided color selection modes, it is convenient and fast to select a color using a color palette, and the color palette may be set to different styles, so that a user can select a color of a corresponding style. Color picker color selection supports more varied colors and can provide a larger color selection range for a user. The history color selection may store a color that has been used or selected by the user, so that without performing color adjustment again, the user can obtain a special color previously obtained through color adjustment. In addition, the history color selection helps a user maintain a consistent color scheme when designing a virtual environment. On one hand, the user can have greater operational freedom and a wider range of choices when selecting a color. On the other hand, the user can change the color of the particle through the operation, so that the color effect of the user-defined effect is richer. In addition, the foregoing implementation is easy and convenient to operate, and improves the efficiency of human-computer interaction, thereby improving the generation efficiency of effects of more different colors.

During attribute setting using key frame controls, in addition to the foregoing manner of setting the color parameter, the scale parameter, the transparency parameter, and the brightness parameter may be set in the following manners.

In some embodiments, Operation 221 may be implemented as Operation 2212, and Operation 222 may be implemented as Operation 2222.

Operation 2212: Display, in response to a trigger operation on an attribute setting entry of the particle generator, an attribute coordinate system and at least two key frame controls located in the attribute coordinate system on the editor interface, a first coordinate axis of the attribute coordinate system indicating the cycle period, and a second coordinate axis of the attribute coordinate system indicating the attribute parameter.

In some embodiments, each of the key frame controls includes at least one of a Button control, an ImageButton control, and a User Created control. The attribute coordinate system includes at least one of an Image control, ImageView, and a User Created control.

In some embodiments, the first coordinate axis is a horizontal axis, and the second coordinate axis is a vertical axis. Alternatively, the first coordinate axis is a vertical axis, and the second coordinate axis is a horizontal axis. In the embodiments of this disclosure, an example in which the first coordinate axis is a horizontal axis and the second coordinate axis is a vertical axis is used for description. However, specific directions of the first coordinate axis and the second coordinate axis are not limited.

In some embodiments, the attribute coordinate system includes the first quadrant of the two-dimensional Cartesian coordinate system; or the attribute coordinate system includes the second quadrant of the two-dimensional Cartesian coordinate system; or the attribute coordinate system includes the third quadrant of the two-dimensional Cartesian coordinate system; or the attribute coordinate system includes the fourth quadrant of the two-dimensional Cartesian coordinate system; or the attribute coordinate system includes the first quadrant and the second quadrant of the two-dimensional Cartesian coordinate system; or the attribute coordinate system includes the first quadrant and the third quadrant of the two-dimensional Cartesian coordinate system; or the attribute coordinate system includes the first quadrant and the fourth quadrant of the two-dimensional Cartesian coordinate system; or the attribute coordinate system includes the second quadrant and the third quadrant of the two-dimensional Cartesian coordinate system; or the attribute coordinate system includes the second quadrant and the fourth quadrant of the two-dimensional Cartesian coordinate system; or the attribute coordinate system includes the first quadrant, the second quadrant, and the third quadrant of the two-dimensional Cartesian coordinate system; or the attribute coordinate system includes the first quadrant, the second quadrant, the third quadrant, and the fourth quadrant of the two-dimensional Cartesian coordinate system. The embodiments of this disclosure lists display ranges of some attribute coordinate systems, and display ranges of the remaining attribute coordinate systems are not listed one by one in the embodiments of this disclosure. However, the scope of this disclosure is not limited thereto.

Operation 2222: Determine, in response to a drag operation on the i^{th} key frame control when the i^{th} key frame control of the at least two key frame controls is in a selected state, that the attribute parameter of the particle at the i^{th} key frame moment is an attribute parameter corresponding to the i^{th} key frame control in the attribute coordinate system, i being a positive integer.

The i^{th} color key frame control being in a selected state means that the i^{th} color key frame control is selected. In some embodiments, a display manner of the i^{th} color key frame control in a selected state may be different from a display manner of a color key frame that is not in a selected state.

In some embodiments, in response to the drag operation on the i^{th} key frame control, it is determined that the value of the attribute parameter (i.e., the attribute parameter value) of the particle at the i^{th} key frame moment is the value of the attribute parameter corresponding to the i^{th} key frame control in the attribute coordinate system.

A specific moment corresponding to a key frame moment may be adjusted through dragging along a direction indicated by the first coordinate axis, and an attribute parameter value of an attribute parameter corresponding to a key frame control may be adjusted through dragging along a direction indicated by the second coordinate axis.

In some embodiments, a corresponding attribute parameter value is displayed on a key frame control.

In some embodiments, the 1^{st} key frame control (also referred to as the start frame control) and the last key frame control (also referred to as the end frame control) can only be dragged vertically but cannot be dragged horizontally. Horizontal coordinates corresponding to the start frame control and the end frame control cannot be changed, and only vertical coordinates corresponding to the start frame control and the end frame control can be changed.

In summary, the method provided in the embodiments of this disclosure shows a manner of setting the attribute parameter based on a key frame control. At least two key frame controls in this manner are located in an attribute coordinate system, and a user may change an attribute parameter value corresponding to a key frame control and a specific moment corresponding to a key frame moment in a dragging manner. This manner facilitates adjustment of a change trend of an attribute parameter value by a user, so that the user can more conveniently customize different particle effects. In addition, the foregoing implementation is easy and convenient to operate, and improves the efficiency of human-computer interaction, thereby improving the generation efficiency of more different effects.

### 1.2 Set the Scale Parameter Using a Key Frame Control

In some embodiments, Operation 2212 may be implemented as Operation 310, and Operation 2222 may be implemented as Operation 320.

Operation 310: Display, in response to a trigger operation on a scale setting entry of the particle generator, a scale coordinate system and at least two scale key frame controls located in the scale coordinate system on the editor interface, a first coordinate axis of the scale coordinate system indicating the cycle period, and a second coordinate axis of the scale coordinate system indicating the scale parameter.

In some embodiments, each of the scale key frame controls includes at least one of a Button control, an ImageButton control, and a User Created control. The scale coordinate system includes at least one of an Image control, ImageView, and a User Created control. The key frame control included in the scale setting entry is at least one of a Button control, an ImageButton control, and a User Created control.

In some embodiments, the scale parameter (i.e., the particle scale parameter) indicates the scaling factor of the particle generated by the particle generator in the cycle period, and the scaling factor is the particle size of the generated particle relative to the default particle size. A minimum value of the particle scale parameter is 0. When the particle scale parameter is 0, the particle size is 0 times the default particle size. When the particle scale parameter is 1, the particle size is 1 time the default particle size. When the particle scale parameter is 2.5, the particle size is 2.5 times the default particle size.

In some embodiments, an upper limit of the scale parameter is a preset value. For example, the upper limit of the scale parameter is 10. In some embodiments, a lower limit of the scale parameter may alternatively be a preset value. For example, the lower limit of the scale parameter is 0.1.

For example, as shown in the schematic diagram (1) of FIG. 5, the scale coordinate system 96 is a two-dimensional Cartesian coordinate system that uses the cycle period as a horizontal axis and the scale parameter as a vertical axis, and the scale coordinate system 96 includes the first quadrant of the two-dimensional Cartesian coordinate system.

In some embodiments, an upper limit of the value of the horizontal coordinate of the scale coordinate system is the end of the cycle period. Alternatively, the upper limit of the value of the horizontal coordinate of the scale coordinate system is the cycle period.

Operation 320: Determine, in response to a drag operation on an i^{th} scale key frame control of the at least two scale key frame controls when the i^{th} scale key frame control is in a selected state, that the attribute parameter of the particle at the i^{th} key frame moment is a scale parameter corresponding to the i^{th} scale key frame control in the scale coordinate system, i being a positive integer.

In some embodiments, in response to the drag operation on the i^{th} key frame control, it is determined that the value of the attribute parameter (i.e., the attribute parameter value) of the particle at the i^{th} key frame moment is the value of the scale parameter (i.e., the scale parameter value) corresponding to the i^{th} key frame control in the scale coordinate system.

In the scale coordinate system, a specific moment corresponding to a key frame moment may be adjusted through dragging along a direction indicated by the first coordinate axis, and a scale parameter value of a scale parameter corresponding to a key frame control may be adjusted through dragging along a direction indicated by the second coordinate axis.

In some embodiments, a corresponding scale parameter value is displayed on a scale key frame control.

In some embodiments, the at least two scale key frame controls include two initial scale key frame controls, i.e., the 1^{st} scale key frame control (also referred to as a scale start frame control) and the last scale key frame control (also referred to as a scale end frame control).

In some embodiments, when the scale key frame control is in a selected state, the scale key frame control is highlighted.

In summary, the method provided in the embodiments of this disclosure shows a manner of setting the scale parameter based on a scale key frame control. At least two scale key frame controls in this manner are located in a scale coordinate system, and a user may change a scale parameter value corresponding to a scale key frame control and a specific moment corresponding to a key frame moment in a dragging manner. This manner facilitates adjustment of a change trend of a scale parameter value by a user, so that the user can more conveniently customize the scaling factor of the particle based on a change of the cycle period. In addition, the implementation is easy and convenient to operate, and improves the efficiency of human-computer interaction, thereby improving the generation efficiency of more effects of different scale parameters.

### 1.3 Set the Transparency Parameter Using a Key Frame Control

In some embodiments, Operation 2212 may be implemented as Operation 330, and Operation 2222 may be implemented as Operation 340.

Operation 330: Display, in response to a trigger operation on a transparency setting entry of the particle generator, a transparency coordinate system and at least two transparency key frame controls located in the transparency coordinate system on the editor interface, a first coordinate axis of the transparency coordinate system indicating the cycle period, and a second coordinate axis of the transparency coordinate system indicating the transparency parameter.

In some embodiments, each of the transparency key frame controls includes at least one of a Button control, an ImageButton control, and a User Created control. The transparency coordinate system includes at least one of an Image control, ImageView, and a User Created control. The key frame control included in the transparency setting entry is at least one of a Button control, an ImageButton control, and a User Created control.

In some embodiments, the transparency parameter indicates a transparency level of the particle generated by the particle generator in the cycle period. A value range of the transparency parameter is 0 to 1. When the transparency parameter is 0, the particle is displayed as completely opaque. When the transparency parameter is 1, the particle is displayed as completely transparent.

For example, as shown in the schematic diagram (2) of FIG. 5, the transparency coordinate system 97 is a two-dimensional Cartesian coordinate system that uses the cycle period as a horizontal axis and the transparency parameter as a vertical axis, and the transparency coordinate system 97 includes the first quadrant of the two-dimensional Cartesian coordinate system.

In some embodiments, an upper limit of the value of the horizontal coordinate of the transparency coordinate system is the end of the cycle period. Alternatively, the upper limit of the value of the horizontal coordinate of the transparency coordinate system is the cycle period.

Operation 340: Determine, in response to a drag operation on an i^{th} transparency key frame control of the at least two transparency key frame controls when the i^{th} transparency key frame control is in a selected state, that the attribute parameter of the particle at the i^{th} key frame moment is a transparency parameter corresponding to the i^{th} transparency key frame control in the transparency coordinate system, i being a positive integer.

In some embodiments, in response to the drag operation on the i^{th} key frame control, it is determined that the value of the attribute parameter (i.e., the attribute parameter value) of the particle at the i^{th} key frame moment is the value of the transparency parameter (i.e., the transparency parameter value) corresponding to the i^{th} key frame control in the transparency coordinate system.

In the transparency coordinate system, a specific moment corresponding to a key frame moment may be adjusted through dragging along a direction indicated by the first coordinate axis, and a transparency parameter value of a transparency parameter corresponding to a key frame control may be adjusted through dragging along a direction indicated by the second coordinate axis.

In some embodiments, a corresponding transparency parameter value is displayed on a transparency key frame control.

In some embodiments, the at least two transparency key frame controls include two initial transparency key frame controls, i.e., the 1^{st} transparency key frame control (also referred to as a transparency start frame control) and the last transparency key frame control (also referred to as a transparency end frame control).

In some embodiments, when the transparency key frame control is in a selected state, the transparency key frame control is highlighted.

In summary, the method provided in the embodiments of this disclosure shows a manner of setting the transparency parameter based on a transparency key frame control. At least two transparency key frame controls in this manner are located in a transparency coordinate system, and a user may change a transparency parameter value corresponding to a transparency key frame control and a specific moment corresponding to a key frame moment in a dragging manner. This manner facilitates adjustment of a change trend of a transparency parameter value by a user, so that the user can more conveniently customize the transparency level based on a change of the cycle period. In addition, the implementation is easy and convenient to operate, and improves the efficiency of human-computer interaction, thereby improving the generation efficiency of more effects of different transparency.

### 1.4 Set the Brightness Parameter Using a Key Frame Control

In some embodiments, Operation 2212 may be implemented as Operation 350, and Operation 2222 may be implemented as Operation 360.

Operation 350: Display, in response to a trigger operation on a brightness setting entry of the particle generator, a brightness coordinate system and at least two brightness key frame controls located in the brightness coordinate system on the editor interface, a first coordinate axis of the brightness coordinate system indicating the cycle period, and a second coordinate axis of the brightness coordinate system indicating the brightness parameter.

In some embodiments, each of the brightness key frame controls includes at least one of a Button control, an ImageButton control, and a User Created control. The brightness coordinate system includes at least one of an Image control, ImageView, and a User Created control. The key frame control included in the brightness setting entry is at least one of a Button control, an ImageButton control, and a User Created control.

In some embodiments, the brightness parameter indicates a brightness level of the particle generated by the particle generator in the cycle period. The value of the brightness parameter may be negative. When the brightness parameter value is a negative value having a larger absolute value, the particle is displayed darker, i.e., is closer to black. When the brightness parameter value is 0, no brightness is applied to the particle, and the color of the particles is directly displayed. When the brightness parameter is a larger positive value, the particle is displayed brighter.

In some embodiments, an upper limit of the brightness parameter is a preset value. For example, the upper limit of the brightness parameter is 10.

In some embodiments, a lower limit of the brightness parameter is a preset value. For example, the upper limit of the brightness parameter is −10.

For example, as shown in the schematic diagram (3) of FIG. 5, the brightness coordinate system 98 is a two-dimensional Cartesian coordinate system that uses the cycle period as a horizontal axis and the brightness parameter as a vertical axis, and the brightness coordinate system 98 includes the first quadrant and the fourth quadrant of the two-dimensional Cartesian coordinate system.

In some embodiments, an upper limit of the value of the horizontal coordinate of the brightness coordinate system is the end of the cycle period. Alternatively, the upper limit of the value of the horizontal coordinate of the brightness coordinate system is the cycle period.

Operation 360: Determine, in response to a drag operation on an i^{th} brightness key frame control of the at least two brightness key frame controls when the i^{th} brightness key frame control is in a selected state, that the attribute parameter of the particle at the i^{th} key frame moment is a brightness parameter corresponding to the i^{th} brightness key frame control in the brightness coordinate system, i being a positive integer.

In some embodiments, in response to the drag operation on the i^{th} key frame control, it is determined that the value of the attribute parameter (i.e., the attribute parameter value) of the particle at the i^{th} key frame moment is the value of the brightness parameter (i.e., the brightness parameter value) corresponding to the i^{th} key frame control in the brightness coordinate system.

In the brightness coordinate system, a specific moment corresponding to a key frame moment may be adjusted through dragging along a direction indicated by the first coordinate axis, and a brightness parameter value of a brightness parameter corresponding to a key frame control may be adjusted through dragging along a direction indicated by the second coordinate axis.

In some embodiments, a corresponding brightness parameter value is displayed on a brightness key frame control.

In some embodiments, the at least two brightness key frame controls include two initial brightness key frame controls, i.e., the 1^{st} brightness key frame control (also referred to as a brightness start frame control) and the last brightness key frame control (also referred to as a brightness end frame control).

In some embodiments, when the brightness key frame control is in a selected state, the brightness key frame control is highlighted.

In summary, the method provided in the embodiments of this disclosure shows a manner of setting the brightness parameter based on a brightness key frame control. At least two brightness key frame controls in this manner are located in a brightness coordinate system, and a user may change a brightness parameter value corresponding to a brightness key frame control and a specific moment corresponding to a key frame moment in a dragging manner. This manner facilitates adjustment of a change trend of a brightness parameter value by a user, so that the user can more conveniently customize the brightness level of the particle based on a change of the cycle period. In addition, the implementation is easy and convenient to operate, and improves the efficiency of human-computer interaction, thereby improving the generation efficiency of more effects of different brightness.

In some embodiments, the attribute parameter corresponds to at least two key frame controls. The at least two key frame controls are provided with two initial key frame controls, namely, the 1^{st} key frame control and the last key frame control, which may also be referred to as a start frame control and an end frame control, respectively. In addition to the two initial key frame controls, the user can further add or delete a key frame control. Next, methods for adding a key frame control and deleting a key frame control are shown.

### Add a Key Frame Control

Operation 410: When the i^{th} key frame control is in a selected state, if the attribute parameter corresponds to n key frame controls, insert a new key frame control between the i^{th} key frame control and an (i+1)^{th} key frame control in response to a key frame addition operation to obtain n+1 key frame controls corresponding to the attribute parameter, i being a positive integer, and n being a positive integer.

In some embodiments, each of the key frame controls includes at least one of a Button control, an ImageButton control, and a User Created control.

In some embodiments, n is a positive integer not less than 2.

In some embodiments, when the i^{th} key frame control is in a selected state, if the attribute parameter corresponds to n key frame controls, a new key frame control is inserted between an (i−1)^{th} key frame control and the i^{th} key frame control in response to a key frame addition operation to obtain n+1 key frame controls corresponding to the attribute parameter. The i^{th} key frame control of the n key frame controls is re-indexed as an (i+1)^{th} key frame control of the n+1 key frame controls. Alternatively, when the i^{th} key frame control is in a selected state, if the attribute parameter corresponds to n key frame controls, a new key frame control is inserted between the i^{th} key frame control and the (i+1)^{th} key frame control in response to a key frame addition operation to obtain n+1 key frame controls corresponding to the attribute parameter. The (i+1)^{th} key frame control of the n key frame controls is re-indexed as an (i+2)^{th} key frame control of the n+1 key frame controls.

In some embodiments, an attribute parameter value corresponding to the new key frame control is an average value of attribute parameter values of the i^{th} and (i+1)^{th} key frame controls of the n key frame controls. Alternatively, the attribute parameter value corresponding to the new key frame control is an average value of attribute parameter values of the (i−1)^{th} and i^{th} key frame control of the n key frame controls. Alternatively, the attribute parameter value corresponding to the new key frame control is a preset value.

In summary, the method provided in the embodiments of this disclosure allows a user to add a key frame control to an attribute parameter, enabling more precise operation of customizing the attribute parameter by the user using the key frame control, so that finally obtained particle effects are more diverse.

### Delete a Key Frame Control

Operation 420: When the i^{th} key frame control is in a selected state, delete the i^{th} key frame control in response to a key frame deletion operation, i being a positive integer.

In some embodiments, each of the key frame controls includes at least one of a Button control, an ImageButton control, and a User Created control.

In some embodiments, when the i^{th} key frame control is in a selected state, in response to a key frame deletion operation, the i^{th} key frame control is deleted when the attribute parameter corresponds to n key frames to obtain n−1 key frame controls corresponding to the attribute parameter, and an (i+1)^{th} key frame control of the n key frame controls is changed to an i^{th} key frame control of the n−1 key frame controls, n being a positive integer.

In some embodiments, the i^{th} key frame control is not the 1^{st} key frame control; and the i^{th} key frame control is not the last key frame control.

In some embodiments, when the i^{th} key frame control is the 1^{st} key frame control, the 2^{nd} key frame control of the n key frame controls is changed to the 1^{st} key frame control of the n−1 key frame controls, and a key frame moment corresponding to the 2^{nd} key frame control of the n key frame controls is changed to a key frame moment of the 1^{st} key frame control to be deleted. When the i^{th} key frame control is the n^{th} key frame control, an (n−1)^{th} key frame control of the n key frame controls is changed to an (n−1)^{th} key frame control of the n−1 key frame controls, and a key frame moment corresponding to the (n−1)^{th} key frame control of the n key frame controls is changed to a key frame moment of the deleted n^{th} key frame control, n being a positive integer.

In some embodiments, n is a positive integer not less than 2.

In summary, the method provided in the embodiments of this disclosure supports deletion of a key frame control by a user, thereby enriching operations performed by the user on the key frame control, and further facilitating flexible design of different particle effects by the user.

### Setting Manner 2 (Attribute Parameter Interval)

In the embodiment based on FIG. 3, Operation 220 may be implemented as Operation 223.

Operation 223: Determine an attribute parameter interval in response to the attribute setting operation on the particle generator, the attribute parameter interval indicating a parameter range of the attribute parameter of the particle generated by the particle generator.

In some embodiments, the attribute parameter interval indicates a parameter value range of attribute parameter value of the attribute parameter of the particle.

In some embodiments, the attribute parameter value of the particle may be generated based on a random value that may be, for example, generated using a random number generation algorithm. The generated attribute parameter value falls within the attribute parameter interval.

In some embodiments, the attribute parameter interval is determined based on the attribute setting operation on the particle generator by the user.

In some embodiments, at least one of a maximum value setting control and a minimum value setting control of the parameter range may be displayed on the editor interface. Operation 223 may be implemented as at least one of Operation 2231 and Operation 2232.

Operation 2231: Determine a maximum value of the parameter range in response to an attribute setting operation on the maximum value setting control.

In some embodiments, the maximum value setting control includes at least one of a Button control, an ImageButton control, a SeekBar control, a Progress Bar control, a Slider control, a Text Box control, a Spin Box control, and a User Created control.

In some embodiments, a maximum value of the parameter range is set by the user using the maximum value setting control. Alternatively, the maximum value of the parameter range is a preset value.

Operation 2232: Determine a minimum value of the parameter range in response to an attribute setting operation on the minimum value setting control.

In some embodiments, the minimum value setting control includes at least one of a Button control, an ImageButton control, a SeekBar control, a Progress Bar control, a Slider control, a Text Box control, a Spin Box control, and a User Created control.

In some embodiments, a minimum value of the parameter range is set by the user using the minimum value setting control. Alternatively, the minimum value of the parameter range is a preset value.

In some embodiments, the maximum value of the parameter range is greater than or equal to the minimum value of the parameter range.

In some embodiments, when the maximum value of the parameter range is equal to the minimum value of the parameter range, the attribute parameter value of the particle is constantly the maximum value or the minimum value of the parameter range.

The maximum value of the parameter range is the interval right endpoint of the attribute parameter interval, and the minimum value of the parameter range is the interval left endpoint of the attribute parameter interval. The attribute parameter value of the attribute parameter is any value (including the maximum value and the minimum value) in the parameter range.

In summary, the method provided in the embodiments of this disclosure shows a setting manner of setting, using an attribute parameter interval, the attribute parameter of the particle generated by the particle generator. The generated attribute parameter value of the particle falls within the attribute parameter interval. In this manner, the particle generated by the particle generator exhibits randomness, so that the customized effect is more randomized, thereby enriching the generated particle effect. In addition, the user does not need to precisely set the attribute parameter, thereby improving the efficiency of human-computer interaction, and also improving the generation efficiency of generating more diverse effects.

In some embodiments, the particle generated by the particle generator includes at least one attribute parameter. The attribute parameter includes at least one of a color parameter, a scale parameter, a transparency parameter, a brightness parameter, an emission velocity, an emission position, a rotation angle, a rotation speed, a cycle period, a particle texture, a generation rate, and an acceleration.

The user can set one or more of the foregoing attribute parameters in Setting Manner 2. For example, the attribute parameter set in Setting Manner 2 includes at least one of the emission velocity, the emission position, the rotation angle, and the rotation speed.

Setting manners of setting the attribute parameter using an attribute parameter interval are separately described below.

### 2.1 Set the Emission Velocity Using an Attribute Parameter Interval

In some embodiments, the emission velocity indicates the initial motion velocity of the particle generated by the particle generator, and the emission velocity includes at least one of the x-axis emission velocity, the y-axis emission velocity, and the z-axis emission velocity.

In some embodiments, when the x-axis emission velocity of the particle is positive, the particle moves in a positive x-axis direction; when the x-axis emission velocity of the particle is negative, the particle moves in a negative x-axis direction; when the y-axis emission velocity of the particle is positive, the particle moves in a positive y-axis direction; when the y-axis emission velocity of the particle is negative, the particle moves in a negative y-axis direction; when the z-axis emission velocity of the particle is positive, the particle moves in a positive z-axis direction; and when the z-axis emission velocity of the particle is negative, the particle moves in a negative z-axis direction.

In some embodiments, at least one of an x-axis emission velocity maximum value setting control, a y-axis emission velocity maximum value setting control, a z-axis emission velocity maximum value setting control, an x-axis emission velocity minimum value setting control, a y-axis emission velocity minimum value setting control, and a z-axis emission velocity minimum value setting control is displayed on the editor interface.

In some embodiments, the x-axis emission velocity maximum value setting control includes at least one of a Button control, an ImageButton control, a SeekBar control, a Progress Bar control, a Slider control, a Text Box control, a Spin Box control, and a User Created control.

In some embodiments, the y-axis emission velocity maximum value setting control includes at least one of a Button control, an ImageButton control, a SeekBar control, a Progress Bar control, a Slider control, a Text Box control, a Spin Box control, and a User Created control.

In some embodiments, the z-axis emission velocity maximum value setting control includes at least one of a Button control, an ImageButton control, a SeekBar control, a Progress Bar control, a Slider control, a Text Box control, a Spin Box control, and a User Created control.

In some embodiments, the x-axis emission velocity minimum value setting control includes at least one of a Button control, an ImageButton control, a SeekBar control, a Progress Bar control, a Slider control, a Text Box control, a Spin Box control, and a User Created control.

In some embodiments, the y-axis emission velocity minimum value setting control includes at least one of a Button control, an ImageButton control, a SeekBar control, a Progress Bar control, a Slider control, a Text Box control, a Spin Box control, and a User Created control.

In some embodiments, the z-axis emission velocity minimum value setting control includes at least one of a Button control, an ImageButton control, a SeekBar control, a Progress Bar control, a Slider control, a Text Box control, a Spin Box control, and a User Created control.

In some embodiments, Operation 2231 may be implemented as at least one of Operation 510 to Operation 530, and Operation 2232 may be implemented as at least one of Operation 540 to Operation 560.

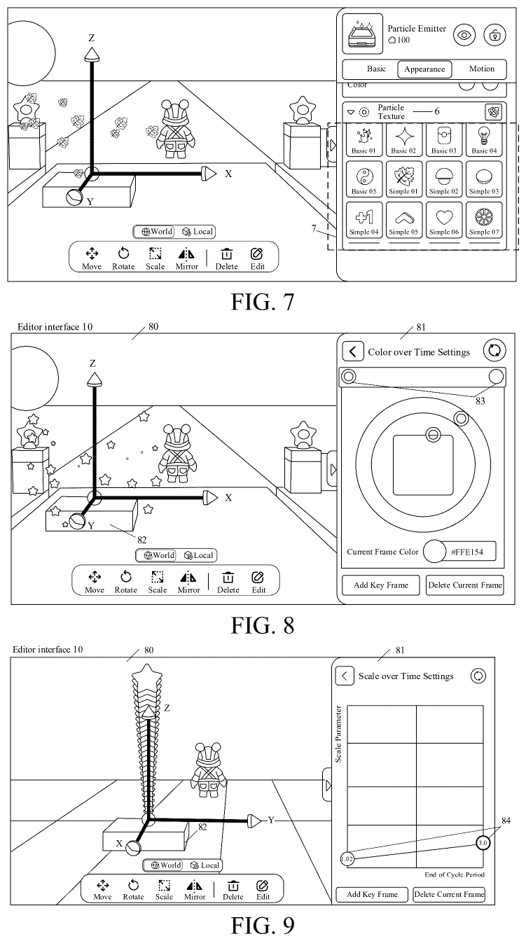

In some embodiments, as shown in FIG. 6, an x-axis emission velocity maximum value setting control 1, a y-axis emission velocity maximum value setting control 3, a z-axis emission velocity maximum value setting control 5, an x-axis emission velocity minimum value setting control 2, and a y-axis emission velocity minimum value setting control 4 are displayed on the editor interface. Each control corresponds to two operation manners: an input box and a slider. For example, the x-axis emission velocity maximum value setting control 1 includes an x-axis emission velocity maximum value slider 1a and an x-axis emission velocity maximum value slider 1b. A digit input box is displayed in response to a trigger operation on the input box to determine the parameter range. The parameter range is determined in response to a drag operation on the slider. For example, attribute parameter values corresponding to the input box and the slider are consistent. To be specific, when the slider is adjusted, the digit displayed in the input box changes. When digits are entered in the input box, the progress of the slider changes.

Operation 510: Determine a maximum value of an x-axis emission velocity range of the particle in response to an attribute setting operation on the x-axis emission velocity maximum value setting control.

In some embodiments, a maximum value of the x-axis emission velocity range is set by the user using the x-axis emission velocity maximum value setting control. Alternatively, the maximum value of the x-axis emission velocity range is a preset value. For example, the maximum value of the x-axis emission velocity range is a preset value of 0.

Operation 520: Determine a maximum value of a y-axis emission velocity range of the particle in response to an attribute setting operation on the y-axis emission velocity maximum value setting control.

In some embodiments, a maximum value of the y-axis emission velocity range is set by the user using the y-axis emission velocity maximum value setting control. Alternatively, the maximum value of the y-axis emission velocity range is a preset value. For example, the maximum value of the y-axis emission velocity range is a preset value of 0.

Operation 530: Determine a maximum value of a z-axis emission velocity range of the particle in response to an attribute setting operation on the z-axis emission velocity maximum value setting control.

In some embodiments, a maximum value of the z-axis emission velocity range is set by the user using the z-axis emission velocity maximum value setting control. Alternatively, the maximum value of the z-axis emission velocity range is a preset value. For example, the maximum value of the z-axis emission velocity range is a preset value of 0.

Operation 540: Determine a minimum value of an x-axis emission velocity range of the particle in response to an attribute setting operation on the x-axis emission velocity minimum value setting control.

In some embodiments, a minimum value of the x-axis emission velocity range is set by the user using the x-axis emission velocity minimum value setting control. Alternatively, the minimum value of the x-axis emission velocity range is a preset value.

In some embodiments, the maximum value of the x-axis emission velocity range is greater than or equal to the minimum value of the x-axis emission velocity range.

In some embodiments, when the maximum value of the x-axis emission velocity range is equal to the minimum value of the x-axis emission velocity range, the generated x-axis emission velocity value of the particle is constantly the maximum value or the minimum value of the x-axis emission velocity range.

Operation 550: Determine a minimum value of a y-axis emission velocity range of the particle in response to an attribute setting operation on the y-axis emission velocity minimum value setting control.

In some embodiments, a minimum value of the y-axis emission velocity range is set by the user using the y-axis emission velocity minimum value setting control. Alternatively, the minimum value of the y-axis emission velocity range is a preset value.

In some embodiments, the maximum value of the y-axis emission velocity range is greater than or equal to the minimum value of the y-axis emission velocity range.

In some embodiments, when the maximum value of the y-axis emission velocity range is equal to the minimum value of the y-axis emission velocity range, the generated y-axis emission velocity value of the particle is constantly the maximum value or the minimum value of the y-axis emission velocity range.

Operation 560: Determine a minimum value of a z-axis emission velocity range of the particle in response to an attribute setting operation on the z-axis emission velocity minimum value setting control.

In some embodiments, a minimum value of the z-axis emission velocity range is set by the user using the z-axis emission velocity minimum value setting control. Alternatively, the minimum value of the z-axis emission velocity range is a preset value.

In some embodiments, the maximum value of the z-axis emission velocity range is greater than or equal to the minimum value of the z-axis emission velocity range.

In some embodiments, when the maximum value of the z-axis emission velocity range is equal to the minimum value of the z-axis emission velocity range, the generated z-axis emission velocity value of the particle is constantly the maximum value or the minimum value of the z-axis emission velocity range.

In summary, in the method provided in the embodiments of this disclosure, the value range of the generated emission velocity value of the particle is determined by setting at least one of the maximum value and the minimum value of the emission velocity range. After the user uses the foregoing method, the particle generated by the particle generator can have a random initial emission velocity. The emission velocity includes at least one of an x-axis emission velocity, a y-axis emission velocity, and a z-axis emission velocity. In this way, the particle effect can include the moving particle, and the particle effect customized by the user is more diverse, which can be implemented using corresponding controls, so that the operations are simple, the efficiency of human-computer interaction is improved, and the generation efficiency of more diverse effects is also improved.

### 2.2 Set the Emission Position Using an Attribute Parameter Interval

In some embodiments, the emission position indicates the initial position of the particle generated by the particle generator.

In some embodiments, the emission position of the particle is represented in a coordinate form. For example, the emission position of the particle is (12, 31, 13). Alternatively, the emission position of the particle is (−12, 11, 0). For example, the coordinates are coordinates in a world coordinate system. Alternatively, the coordinates are coordinates in a local coordinate system. The world coordinate system is a three-dimensional Cartesian coordinate system formed based on an origin in a virtual environment. The local coordinate system is a three-dimensional Cartesian coordinate system relative to the particle generator. For example, the local coordinate system is a three-dimensional Cartesian coordinate system with the center of the particle generator as the origin.

In some embodiments, Operation 610 may be further included, and Operation 223 may be implemented as Operation 620.

Operation 610: Display an emission position control on the editor interface in response to a trigger operation on an emission position setting entry of the particle generator, the emission position control including at least one of a spherical parameter control, a triangular parameter control, a cylindrical parameter control, and a user-defined parameter control.

In some embodiments, the emission position control including at least one of a spherical parameter control, a triangular parameter control, a cylindrical parameter control, and a user-defined parameter control. For example, the emission position control further includes at least one of a pentagram parameter control, a cone parameter control, and a triangular pyramid parameter control.

In some embodiments, the emission position control includes at least one of a Button control, an ImageButton control, and a Combo Box control. The emission position setting entry includes at least one of a Button control, an ImageButton control, and a Combo Box control.

In some embodiments, the emission position indicates the initial position of the particle. The developer of the UGC editor may set at least one preset shape, for example, at least one of the foregoing sphere, triangle, cylinder, pentagram, cone, and triangular pyramid. For example, attributes of the preset shape are fixed. Alternatively, the user can adjust the preset shape using an attribute setting interface opened by the developer.

In summary, in the method provided in the embodiments of this disclosure, when a plurality of emission position controls are provided, an emission position control is selected first, and then some parameter setting controls corresponding to the emission position control are displayed, so that the entire editor interface is simpler and friendlier to users, thereby improving the utilization of display resources.

Operation 620: Determine an emission position interval of the particle in response to a trigger operation on an emission position control, the emission position interval indicating a parameter range of the emission position of the particle generated by the particle generator, and the emission position control indicating determining of the emission position interval.

In some embodiments, in response to the trigger operation on the emission position control, the emission position interval of the particle is determined. To be specific, a coordinate range of the initial position of the particle generated by the particle generator is determined. The initial position may be generated based on a random value.

In summary, the method provided in the embodiments of this disclosure can provide setting of an emission position interval of a particle for a user, so that the user can customize an initial position of the particle by setting the emission position interval of the particle, so that particle effects of various graphics can be obtained, thereby improving the diversity of effect generation.

In some embodiments, the emission position control includes a spherical parameter control. The spherical parameter control includes a radius setting control. Operation 620 may be implemented as Operation 621 and Operation 622.

In some embodiments, the spherical parameter control includes at least one of a Button control, an ImageButton control, a SeekBar control, a Progress Bar control, a Slider control, a Text Box control, a Spin Box control, and a User Created control.

Operation 621: Determine a target radius in response to a setting operation on the radius setting control.

In some embodiments, the radius setting control is displayed in response to a selection operation on the spherical parameter control. The radius setting control is configured to set the spherical radius of a sphere. The sphere is associated with the particle generator. For example, the spherical center of the sphere may be the center of the particle generator.

In some embodiments, the radius setting control includes at least one of a Button control, an ImageButton control, a SeekBar control, a Progress Bar control, a Slider control, a Text Box control, a Spin Box control, and a User Created control.

Operation 622: Determine the emission position interval of the particle as a first spatial range based on the target radius, the first spatial range including a spherical surface of a sphere and a spatial coordinate interval inside the sphere, and the sphere with the target radius as a spherical radius.

In some embodiments, the spherical center of the sphere corresponding to the first spatial range is the center of the particle generator. Alternatively, the spherical center of the sphere is the origin of a local coordinate system in which the particle generator is located. Alternatively, a difference between the coordinates of the spherical center of the sphere and the coordinates of the center of the particle generator is a first difference. Alternatively, a difference between the coordinates of the spherical center of the sphere and the coordinates of the origin of the local coordinate system is a second difference.

For example, the coordinates of the spherical center is (0, 0, 0), and the spherical radius is r. The first spatial range includes a spatial coordinate interval satisfying the first condition, and the first condition is x²+y²+z²≤r².

In summary, the method provided in the embodiments of this disclosure shows a manner of setting a spherical emission position interval. A user only needs to correspondingly set a radius to obtain a particle effect with an emission position interval inside a sphere, so that simpler setting of the particle effect makes it easier for the user to use, thereby reducing human-computer interaction operations and improving the efficiency of human-computer interaction.

In some embodiments, the emission position control includes the triangular parameter control, and the triangular parameter control includes at least one of a side length setting control and a triangular prism height setting control. Operation 620 may be implemented as Operation 623 to Operation 625.

In some embodiments, the triangular parameter control includes at least one of a Button control, an ImageButton control, a SeekBar control, a Progress Bar control, a Slider control, a Text Box control, a Spin Box control, and a User Created control.

Operation 623: Determine a first side length in response to a setting operation on the side length setting control.

In some embodiments, the side length setting control includes at least one of a Button control, an ImageButton control, a SeekBar control, a Progress Bar control, a Slider control, a Text Box control, a Spin Box control, and a User Created control.

Operation 624: Determine a first prism height in response to a setting operation on the triangular prism height setting control.

In some embodiments, in response to a selection operation on the triangular parameter control, at least one of the side length setting control and the triangular prism height setting control is displayed.

In some embodiments, the triangular prism height setting control includes at least one of a Button control, an ImageButton control, a SeekBar control, a Progress Bar control, a Slider control, a Text Box control, a Spin Box control, and a User Created control.

Operation 625: Determine the emission position interval of the particle as a second spatial range based on at least one of the first side length and the first prism height, the second spatial range including a triangular prism surface of a triangular prism and a spatial coordinate interval inside the triangular prism, and the triangular prism being determined based on at least one of the first side length and the first prism height.

In some embodiments, the emission position interval of the particle is determined as the second spatial range based on the first side length, the second spatial range including the triangular prism surface of the triangular prism and the spatial coordinate interval inside the triangular prism, and the triangular prism being determined based on at least one of the first side length and the first prism height. For example, the triangular prism is a triangular prism with the first side length as the side length of an equilateral triangle and the preset prism height as the height. Alternatively, the emission position interval of the particle is determined as the second spatial range based on the first prism height, the second spatial range including a surface of a triangular prism and a spatial coordinate interval inside the triangular prism, and the triangular prism being a triangular prism with a preset side length as the side length of an equilateral triangle and the first prism height as the height. Alternatively, the emission position interval of the particle is determined as the second spatial range based on the first side length and the first prism height, the second spatial range including a surface of a triangular prism and a spatial coordinate interval inside the triangular prism, and the triangular prism being a triangular prism with the first side length as the side length of an equilateral triangle and the first prism height as the height. The preset side length is a preset value, and the preset prism height is a preset value.

In some embodiments, the center of the triangular prism corresponding to the second spatial range is the center of the particle generator. Alternatively, the center of the triangular prism is the origin of a local coordinate system in which the particle generator is located. Alternatively, a difference between the coordinates of the center of the triangular prism and the coordinates of the center of the particle generator is a first difference. Alternatively, a difference between the coordinates of the center of the triangular prism and the coordinates of the origin of the local coordinate system is a second difference.

In some embodiments, Operation 623 and Operation 624 may be performed in any order or simultaneously, Operation 623 and Operation 625 may be implemented as independent embodiments, and Operation 624 and Operation 625 may be implemented as independent embodiments.

In summary, the method provided in the embodiments of this disclosure provides users with a setting manner of setting a corresponding emission position interval when an emission shape is a triangle. A user only needs to correspondingly set at least one of a side length and a prism height to obtain a particle effect with an emission position interval inside a triangular prism, so that simpler setting of the particle effect makes it easier for the user to use, thereby reducing human-computer interaction operations and improving the efficiency of human-computer interaction.

In some embodiments, the emission position control includes the cylindrical parameter control, and the cylindrical parameter control includes at least one of a cylinder radius setting control and a cylinder height setting control. Operation 620 may be implemented as Operation 626 to Operation 628.

In some embodiments, the cylindrical parameter control includes at least one of a Button control, an ImageButton control, a SeekBar control, a Progress Bar control, a Slider control, a Text Box control, a Spin Box control, and a User Created control.

Operation 626: Determine a cylinder radius in response to a setting operation on the cylinder radius setting control.

In some embodiments, the cylinder radius setting control includes at least one of a Button control, an ImageButton control, a SeekBar control, a Progress Bar control, a Slider control, a Text Box control, a Spin Box control, and a User Created control.

Operation 627: Determine a cylinder height in response to a setting operation on the cylinder height setting control.

In some embodiments, in response to a selection operation on the cylindrical parameter control, at least one of the cylinder radius setting control and the cylinder height setting control is displayed.

In some embodiments, the cylinder height setting control includes at least one of a Button control, an ImageButton control, a SeekBar control, a Progress Bar control, a Slider control, a Text Box control, a Spin Box control, and a User Created control.

Operation 628: Determine the emission position interval of the particle as a third spatial range based on at least one of the cylinder radius and the cylinder height, the third spatial range including a cylindrical surface of a cylinder and a spatial coordinate interval inside the cylinder, and the cylinder being determined based on at least one of the cylinder radius and the cylinder height.

In some embodiments, the emission position interval of the particle is determined as the third spatial range based on the cylinder radius, the third spatial range including a cylindrical surface of a cylinder and a spatial coordinate interval inside the cylinder, and the cylinder being determined based on at least one of the cylinder radius and the cylinder height. For example, the cylinder is a cylinder with the cylinder radius as the bottom circle radius and the preset prism height as the height. Alternatively, the emission position interval of the particle is determined as the third spatial range based on the cylinder height, the third spatial range including a surface of a cylinder and a spatial coordinate interval inside the cylinder, and the cylinder being a cylinder with a preset radius as the bottom circle radius and the cylinder height as the height. Alternatively, the emission position interval of the particle is determined as the third spatial range based on the cylinder radius and the cylinder height, the third spatial range including a surface of a cylinder and a spatial coordinate interval inside the cylinder, and the cylinder being a cylinder with the cylinder radius as the bottom circle radius and the cylinder height as the height. The preset radius is a preset value, and the preset prism height is a preset value.

In some embodiments, the center of the cylinder corresponding to the third spatial range is the center of the particle generator. Alternatively, the center of the cylinder is the origin of a local coordinate system in which the particle generator is located. Alternatively, a difference between the coordinates of the center of the cylinder and the coordinates of the center of the particle generator is a first difference. Alternatively, a difference between the coordinates of the center of the cylinder and the coordinates of the origin of the local coordinate system is a second difference.

In some embodiments, Operation 626 and Operation 627 may be performed in any order or simultaneously, Operation 626 and Operation 628 may be implemented as independent embodiments, and Operation 627 and Operation 628 may be implemented as independent embodiments.

In summary, the method provided in the embodiments of this disclosure shows a manner of setting a cylindrical emission position interval. A user only needs to correspondingly set at least one of a radius and a cylinder height to obtain a particle effect with an emission position interval inside a cylinder, so that simpler setting of the particle effect makes it easier for the user to use, thereby reducing human-computer interaction operations and improving the efficiency of human-computer interaction.

In some embodiments, the emission position control includes the user-defined parameter control, and the user-defined parameter control includes at least one of an x-axis maximum value setting control, an x-axis minimum value setting control, a y-axis maximum value setting control, a y-axis minimum value setting control, a z-axis maximum value setting control, and a z-axis minimum value setting control. Operation 620 may be implemented as at least one of Operation 710 to Operation 760.

In some embodiments, the user-defined parameter control includes at least one of a Button control, an ImageButton control, a SeekBar control, a Progress Bar control, a Slider control, a Text Box control, a Spin Box control, and a User Created control.

In some embodiments, in response to a selection operation on the user-defined parameter control, at least one of the x-axis maximum value setting control, the x-axis minimum value setting control, the y-axis maximum value setting control, the y-axis minimum value setting control, the z-axis maximum value setting control, and the z-axis minimum value setting control is displayed on the editor interface.

In some embodiments, the x-axis maximum value setting control includes at least one of a Button control, an ImageButton control, a SeekBar control, a Progress Bar control, a Slider control, a Text Box control, a Spin Box control, and a User Created control.

In some embodiments, the x-axis minimum value setting control includes at least one of a Button control, an ImageButton control, a SeekBar control, a Progress Bar control, a Slider control, a Text Box control, a Spin Box control, and a User Created control.

In some embodiments, the y-axis maximum value setting control includes at least one of a Button control, an ImageButton control, a SeekBar control, a Progress Bar control, a Slider control, a Text Box control, a Spin Box control, and a User Created control.

In some embodiments, the y-axis minimum value setting control includes at least one of a Button control, an ImageButton control, a SeekBar control, a Progress Bar control, a Slider control, a Text Box control, a Spin Box control, and a User Created control.

In some embodiments, the z-axis maximum value setting control includes at least one of a Button control, an ImageButton control, a SeekBar control, a Progress Bar control, a Slider control, a Text Box control, a Spin Box control, and a User Created control.

In some embodiments, the z-axis minimum value setting control includes at least one of a Button control, an ImageButton control, a SeekBar control, a Progress Bar control, a Slider control, a Text Box control, a Spin Box control, and a User Created control.

Operation 710: Determine a maximum value of the particle in an x-axis position range in response to an attribute setting operation on the x-axis maximum value setting control.

In some embodiments, the emission position of the particle is represented as (x, y, z). In response to the attribute setting operation on the x-axis maximum value setting control, it is determined that the maximum value of the position range of the particle on the x-axis is x1. In some examples, the generated x of the particle is less than or equal to x1.

Operation 720: Determine a minimum value of the particle in an x-axis position range in response to an attribute setting operation on the x-axis minimum value setting control.

In some embodiments, the emission position of the particle is represented as (x, y, z). In response to the attribute setting operation on the x-axis minimum value setting control, it is determined that the minimum value of the position range of the particle on the x-axis is x2. In some examples, the generated x of the particle is greater than or equal to x2.

Operation 730: Determine a maximum value of the particle in a y-axis position range in response to an attribute setting operation on the y-axis maximum value setting control.

In some embodiments, the emission position of the particle is represented as (x, y, z). In response to the attribute setting operation on the y-axis maximum value setting control, it is determined that the maximum value of the position range of the particle on the y-axis is y1. In some examples, the generated y of the particle is less than or equal to y1.

Operation 740: Determine a minimum value of the particle in a y-axis position range in response to an attribute setting operation on the y-axis minimum value setting control.

In some embodiments, the emission position of the particle is represented as (x, y, z). In response to the attribute setting operation on the y-axis minimum value setting control, it is determined that the minimum value of the position range of the particle on the y-axis is y2. In some examples, the generated y of the particle is greater than or equal to y2.

Operation 750: Determine a maximum value of the particle in a z-axis position range in response to an attribute setting operation on the z-axis maximum value setting control.

In some embodiments, the emission position of the particle is represented as (x, y, z). In response to the attribute setting operation on the z-axis maximum value setting control, it is determined that the maximum value of the position range of the particle on the z-axis is z1. In some examples, the generated z of the particle is less than or equal to z1.

Operation 760: Determine a minimum value of the particle in a z-axis position range in response to an attribute setting operation on the z-axis minimum value setting control.

In some embodiments, the emission position of the particle is represented as (x, y, z). In response to the attribute setting operation on the z-axis minimum value setting control, it is determined that the minimum value of the position range of the particle on the z-axis is z2. In some examples, the generated z of the particle is greater than or equal to z2.

In summary, the method provided in the embodiments of this disclosure shows a manner of setting a user-defined emission position interval. A user may customize a range of a random emission position value of a particle. Through settings of x, y, and z coordinates, an emission position of the particle satisfies at least one of a point, a line, a plane, or a quadrangular prism. This brings more possibilities for the user to set a particle effect, thereby enriching generated particle effects, and can be implemented using corresponding controls, so that operations are simple, thereby improving the efficiency of human-computer interaction, and also improving the generation efficiency of more diverse effects.

### 2.3 Set the Rotation Angle Using a Parameter Range Interval

In some embodiments, the rotation angle indicates the initial rotation angle of the particle generated by the particle generator.

In some embodiments, the rotation angle is a rotation angle relative to a preset orientation of the particle. A value range of the rotation angle is [0, 360]. Alternatively, the value range of the rotation angle is [−180, 180]. For example, the value range of the rotation angle is [0, 360]. When the rotation angle of the particle is 120 degrees, the particle rotates by 120 degrees clockwise or anticlockwise relative to the preset orientation of the particle. Alternatively, the value range of the rotation angle is [−180, 180]. When the rotation angle of the particle is 120 degrees, the particle rotates by 120 degrees clockwise or anticlockwise relative to the preset orientation of the particle. When the rotation angle of the particles is −60 degrees, the particle rotates by 60 degrees anticlockwise or clockwise relative to the preset orientation of the particle.

In some embodiments, at least one of a rotation angle maximum value setting control and a rotation angle minimum value setting control is displayed on the editor interface.

In some embodiments, the rotation angle maximum value setting control includes at least one of a Button control, an ImageButton control, a SeekBar control, a Progress Bar control, a Slider control, a Text Box control, a Spin Box control, and a User Created control.

In some embodiments, the rotation angle minimum value setting control includes at least one of a Button control, an ImageButton control, a SeekBar control, a Progress Bar control, a Slider control, a Text Box control, a Spin Box control, and a User Created control.

In some embodiments, Operation 2231 may be implemented as Operation 810, and Operation 2232 may be implemented as Operation 820.

Operation 810: Determine a maximum value of a rotation angle range of the particle in response to an attribute setting operation on the rotation angle maximum value setting control.

In some embodiments, a minimum value of the rotation angle range is set by the user using the rotation angle minimum value setting control. Alternatively, the minimum value of the rotation angle range is a preset value. For example, the minimum value of the rotation angle range is a preset value of 0.

Operation 820: Determine a minimum value of the rotation angle range of the particle in response to an attribute setting operation on the rotation angle minimum value setting control.

In some embodiments, a maximum value of the rotation angle range is set by the user using the rotation angle maximum value setting control. Alternatively, the maximum value of the rotation angle range is a preset value. For example, the maximum value of the rotation angle range is a preset value of 0.

In some embodiments, the maximum value of the rotation angle range is greater than or equal to the minimum value of the rotation angle range.

In some embodiments, when the maximum value of the rotation angle range is equal to the minimum value of the rotation angle range, the generated rotation angle value of the particle is constantly the maximum value or the minimum value of the rotation angle range.

In summary, in the method provided in the embodiments of this disclosure, the value range of the generated rotation angle value of the particle is determined by setting at least one of the maximum value and the minimum value of the rotation angle range. After the user uses the foregoing method, the particle generated by the particle generator can have a random initial rotation angle. In this way, the particle effect can include particles having different angles, and the particle effect customized by the user is more diverse, which can be implemented using corresponding controls, so that the operations are simple, the efficiency of human-computer interaction is improved, and the generation efficiency of more diverse effects is also improved.

### 2.4 Set the Rotation Speed Using a Parameter Range Interval

In some embodiments, the rotation speed indicates the rotation speed of the particle generated by the particle generator. For example, the rotation speed indicates an angular velocity of the particle generated by the particle generator. Alternatively, the rotation speed indicates a linear velocity of the particle generated by the particle generator.

In some embodiments, at least one of a rotation speed maximum value setting control and a rotation speed minimum value setting control is displayed on the editor interface.

In some embodiments, the rotation speed maximum value setting control includes at least one of a Button control, an ImageButton control, a SeekBar control, a Progress Bar control, a Slider control, a Text Box control, a Spin Box control, and a User Created control.

In some embodiments, the rotation speed minimum value setting control includes at least one of a Button control, an ImageButton control, a SeekBar control, a Progress Bar control, a Slider control, a Text Box control, a Spin Box control, and a User Created control.

In some embodiments, Operation 2231 may be implemented as Operation 910, and Operation 2232 may be implemented as Operation 920.

Operation 910: Determine a maximum value of a rotation speed range of the particle in response to an attribute setting operation on the rotation speed maximum value setting control.

In some embodiments, a minimum value of the rotation speed range is set by the user using the rotation speed minimum value setting control. Alternatively, the minimum value of the rotation speed range is a preset value. For example, the minimum value of the rotation speed range is a preset value of 0.

Operation 920: Determine a minimum value of the rotation speed range of the particle in response to an attribute setting operation on the rotation speed minimum value setting control.

In some embodiments, a maximum value of the rotation speed range is set by the user using the rotation speed maximum value setting control. Alternatively, the maximum value of the rotation speed range is a preset value. For example, the maximum value of the rotation speed range is a preset value of 0.

In some embodiments, the maximum value of the rotation speed range is greater than or equal to the minimum value of the rotation speed range.

In some embodiments, when the maximum value of the rotation speed range is equal to the minimum value of the rotation speed range, the generated rotation speed value of the particle is constantly the maximum value or the minimum value of the rotation speed range.

In summary, in the method provided in the embodiments of this disclosure, the value range of the generated rotation speed value of the particle is determined by setting at least one of the maximum value and the minimum value of the rotation speed range. After the user uses the foregoing method, the particle generated by the particle generator can have a random rotation speed. In this way, the particle effect can include a rotating particle, and the particle effect customized by the user is more diverse, which can be implemented using corresponding controls, so that the operations are simple, the efficiency of human-computer interaction is improved, and the generation efficiency of more diverse effects is also improved.

### Setting Manner 3 (Set the Attribute Parameter Value Directly.)

In the embodiment based on FIG. 3, Operation 220 may be implemented as Operation 224.

Operation 224: Determine an attribute parameter value of the particle in response to the attribute setting operation on the particle generator.

In some embodiments, the user directly determines the attribute parameter value of the particle using the attribute setting operation. Attribute parameters corresponding to all particles generated by the particle generator have the attribute parameter value.

In summary, the method provided in the embodiments of this disclosure shows a method for setting an attribute parameter, using the simplest manner of setting a value, which is simple and easy to use, so that a user can quickly customize a particle effect by based on an attribute setting operation interface provided by the developer, thereby reducing human-computer interaction operations and improving the efficiency of human-computer interaction.

In some embodiments, the particle generated by the particle generator includes at least one attribute parameter. The attribute parameter includes at least one of a color parameter, a scale parameter, a transparency parameter, a brightness parameter, an emission velocity, an emission position, a rotation angle, a rotation speed, a cycle period, a particle texture, a generation rate, and an acceleration.

The user can set one or more of the foregoing attribute parameters in Setting Manner 3. For example, the attribute parameter set in Setting Manner 2 includes at least one of the cycle period, the emission position, a particle texture, a generation rate, and an acceleration.

Setting manners of setting the attribute parameter using an attribute parameter interval are separately described below.

### 3.1 Set the Cycle Period Directly

In some embodiments, the cycle period indicates duration of existence of the particle generated by the particle generator, i.e., duration from generation to disappearance of the particle.

In some embodiments, a cycle period setting control is displayed on the editor interface.

In some embodiments, the cycle period setting control includes at least one of a Button control, an ImageButton control, a SeekBar control, a Progress Bar control, a Slider control, a Text Box control, a Spin Box control, and a User Created control.

In some embodiments, Operation 224 may be implemented as Operation 2241.

Operation 2241: Determine a cycle period value of the particle in response to an attribute setting operation on the cycle period setting control.

In some embodiments, the cycle period value of the particle is a cycle period value of all particles generated by the particle generator. For example, if a cycle period value of a particle generator a is 5 and a cycle period value of a particle generator b is 2, cycle period values of particles generated by the particle generator a are all 5, and cycle period values of particles generated by the particle generator b are all 2. Alternatively, the cycle period value of the particle is a maximum cycle period value of the particle. For example, the cycle period value of the particle generator a is 5, and a cycle period range of the particle generator a is (0, 5]. Cycle period values of particles a1 to a5 generated by the particle generator are 2, 4, 3, 2, and 5, respectively.

In summary, in the method provided in the embodiments of this disclosure, the cycle period of the particle generated by the particle generator is set in a manner of setting a cycle period value. This is simple and easy to use, so that a user can quickly design a particle with an animation from generation to disappearance, thereby improving the efficiency of human-computer interaction and the utilization of device resources.

### 3.2 Set the Emission Position Directly

In some embodiments, the emission position control is displayed on the editor interface in response to the trigger operation on the emission position setting entry of the particle generator, the emission position control including at least one of the spherical parameter control, the triangular parameter control, and the cylindrical parameter control. For example, the emission position control further includes at least one of a pentagram parameter control, a cone parameter control, and a triangular pyramid parameter control.

In some embodiments, the emission position setting entry includes at least one of a Button control, an ImageButton control, a Combo Box control, and a User Created control. The emission position control includes at least one of a Button control, an ImageButton control, a Text control, and a User Created control.

In some embodiments, the developer of the UGC editor may set at least one preset shape, for example, at least one of the foregoing sphere, triangle, cylinder, pentagram, cone, and triangular pyramid. For example, attributes of the preset shape are fixed. Alternatively, the user can adjust the preset shape using an attribute setting interface opened by the developer.

In some embodiments, Operation 224 may be implemented as at least one of Operation 2242 to Operation 2244.

Operation 2242: Determine, in response to a selection operation on the spherical parameter control if the emission position control includes the spherical parameter control, that the emission position interval of the particle is a fourth spatial range, the fourth spatial range including a spherical surface of a sphere and a spatial coordinate interval inside the sphere, and the sphere with a first radius as a spherical radius.

In some embodiments, the spherical parameter control includes at least one of a Button control, an ImageButton control, a Text control, and a User Created control.

In some embodiments, the spherical center of the sphere corresponding to the fourth spatial range is the center of the particle generator. Alternatively, the spherical center of the sphere is the origin of a local coordinate system in which the particle generator is located. Alternatively, a difference between the coordinates of the spherical center of the sphere and the coordinates of the center of the particle generator is a first difference. Alternatively, a difference between the coordinates of the spherical center of the sphere and the coordinates of the origin of the local coordinate system is a second difference.

In some embodiments, the first radius is a preset value. For example, the first radius is 2, and the coordinates of the spherical center is (0, 0, 0). The fourth spatial range includes a spatial coordinate interval satisfying the second condition, and the second condition is x²+y²+z²≤2².

Operation 2243: Determine, in response to a selection operation on the triangular parameter control if the emission position control includes the triangular parameter control, that the emission position interval of the particle is a fifth spatial range, the fifth spatial range including a triangular prism surface of a triangular prism and a spatial coordinate interval inside the triangular prism, the triangular prism being a triangular prism with a second side length as a side length of an equilateral triangle and a second prism height as a height.

In some embodiments, the triangular parameter control includes at least one of a Button control, an ImageButton control, a Text control, and a User Created control.

In some embodiments, the center of the triangular prism corresponding to the fifth spatial range is the center of the particle generator. Alternatively, the center of the triangular prism is the origin of a local coordinate system in which the particle generator is located. Alternatively, a difference between the coordinates of the center of the triangular prism and the coordinates of the center of the particle generator is a first difference. Alternatively, a difference between the coordinates of the center of the triangular prism and the coordinates of the origin of the local coordinate system is a second difference.

In some embodiments, the second side length is a preset value, and the second prism height is a preset value.

Operation 2244: Determine, in response to a selection operation on the cylindrical parameter control if the emission position control includes the cylindrical parameter control, that the emission position interval of the particle is a sixth spatial range, the sixth spatial range including a cylindrical surface of a cylinder and a spatial coordinate interval inside the cylinder, and the cylinder being a cylinder with a second radius as a bottom radius and a third prism height as a height.

In some embodiments, the cylindrical parameter control includes at least one of a Button control, an ImageButton control, a Text control, and a User Created control.

In some embodiments, the center of the cylinder corresponding to the sixth spatial range is the center of the particle generator. Alternatively, the center of the cylinder is the origin of a local coordinate system in which the particle generator is located. Alternatively, a difference between the coordinates of the center of the cylinder and the coordinates of the center of the particle generator is a first difference. Alternatively, a difference between the coordinates of the center of the cylinder and the coordinates of the origin of the local coordinate system is a second difference.

In some embodiments, the third side length is a preset value, and the third prism height is a preset value.

In summary, the method provided in the embodiments of this disclosure shows a manner of setting an emission position. Graphics corresponding to the emission position are all preset graphics, and parameters of the preset graphics are all designed by the developer of the UGC editor. A user only needs to select a graphic that the user wants to use, so that simpler setting of the particle effect makes it easier for the user to use, thereby reducing human-computer interaction operations and improving the efficiency of human-computer interaction.

### 3.3 Set the Particle Texture Directly

In some embodiments, the particle texture indicates a texture of the particle generated by the particle generator. The texture may be understood as a display effect of the particle in a virtual environment. For example, if the texture is a pentagram image, the particle generated by the particle generator is a pentagram. If the texture is a tree leaf image, the particle generated by the particle generator is a tree leaf.

In some embodiments, a particle texture selection area is displayed on the editor interface, the particle texture selection area including at least one particle texture control, and different particle texture controls corresponding to different particle textures.

In some embodiments, the particle texture control includes at least one of a Button control, an ImageButton control, a Text control, and a User Created control.

In some embodiments, Operation 224 may be implemented as Operation 2245.

Operation 2245: Determine the particle texture of the particle in response to a selection operation on the particle texture control.

In some embodiments, as shown in FIG. 7, the particle texture area 6 displays at least one particle texture control 7. Different particle texture controls correspond to different particle textures. A user may trigger the particle texture control to change a particle texture of a particle to a particle texture corresponding to the particle texture control.

In some embodiments, the at least one particle texture control displayed in the particle texture selection area is changed in response to a trigger operation on the particle texture selection area. For example, the at least one particle texture control displayed in the particle texture selection area is changed in response to a slide operation on the particle texture selection area.

In some embodiments, the particle texture is a preset texture. Alternatively, the particle texture is a texture added by the user.

In summary, in the method provided in the embodiments of this disclosure, a particle texture of a particle is set by triggering a particle texture control, which is easy to use, so that a user can quickly design particles having different particle textures, thereby reducing human-computer interaction operations and improving the efficiency of human-computer interaction.

### 3.4 Set the Generation Rate Directly

In some embodiments, the generation rate indicates the quantity of particles generated by the particle generator in the first unit time.

In some embodiments, a generation rate setting control is displayed on the editor interface.

In some embodiments, the generation rate setting control includes at least one of a Button control, an ImageButton control, a SeekBar control, a Progress Bar control, a Slider control, a Text Box control, a Spin Box control, and a User Created control.

In some embodiments, Operation 224 may be implemented as Operation 2246.

Operation 2246: Determine the generation rate of the particle in response to an attribute setting operation on the generation rate setting control.

In some embodiments, the generation rate indicates the quantity of particles generated by the particle generator in the first unit time. The first unit time is a preset value. Alternatively, the first unit time is a value set by the user.

For example, the first unit time is 1 second, and the generation rate indicates a quantity of particles generated by the particle generator in 1 second. Alternatively, the first unit time is a value of 20 seconds set by the user, and the generation rate indicates a quantity of particles generated by the particle generator in 20 seconds.

In summary, according to the method provided in the embodiments of this disclosure, the generation rate of the particle is set, and the generation rate indicates the quantity of particles generated in the first unit time. This setting manner is simple and easy to use, so that a user can quickly design a rate of generating particles by the particle generator, and obtain varied particle effects through design, thereby reducing human-computer interaction operations and improving the efficiency of human-computer interaction and the generation efficiency of particle effects.

### 3.5 Set the Acceleration Directly

In some embodiments, the acceleration indicates the acceleration of the particle of the particle generator. The acceleration includes at least one of the x-axis acceleration, the y-axis acceleration, and the z-axis acceleration.

In some embodiments, when the x-axis acceleration of the particle is positive, the direction of the acceleration is a positive x-axis direction; when the x-axis acceleration of the particle is negative, the direction of the acceleration is a negative x-axis direction; when the y-axis acceleration of the particle is positive, the direction of the acceleration is a positive y-axis direction; when the y-axis acceleration of the particle is negative, the direction of the acceleration is a negative y-axis direction; when the z-axis acceleration of the particle is positive, the direction of the acceleration is a positive z-axis direction; and when the z-axis acceleration of the particle is negative, the direction of the acceleration is a negative z-axis direction.

In some embodiments, Operation 224 may be implemented as at least one of Operation 2247 to Operation 2249.

Operation 2247: Determine an x-axis acceleration value of the particle in response to an attribute setting operation on the x-axis acceleration setting control.

In some embodiments, the x-axis acceleration setting control includes at least one of a Button control, an ImageButton control, a SeekBar control, a Progress Bar control, a Slider control, a Text Box control, a Spin Box control, and a User Created control. For example, when the x-axis emission velocity of the particle is positive and the x-axis acceleration is positive, the particle accelerates in the positive x-axis direction. When the x-axis emission velocity of the particle is positive and the x-axis acceleration is negative, the particle decelerates in the positive x-axis direction. When the velocity decreases to 0, the particle stops moving, or the velocity of the particle continues to be calculated to obtain a negative velocity of the particle, and the particle accelerates in the negative x-axis direction. When the x-axis emission velocity of the particle is negative and the x-axis acceleration is negative, the particle accelerates in the negative x-axis direction. When the x-axis emission velocity of the particle is negative and the x-axis acceleration is positive, the particle decelerates in the negative x-axis direction. When the velocity decreases to 0, the particle stops moving, or the velocity of the particle continues to be calculated to obtain a positive velocity of the particle, and the particle accelerates in the positive x-axis direction.

Operation 2248: Determine a y-axis acceleration value of the particle in response to an attribute setting operation on the y-axis acceleration setting control.

In some embodiments, the y-axis acceleration setting control includes at least one of a Button control, an ImageButton control, a SeekBar control, a Progress Bar control, a Slider control, a Text Box control, a Spin Box control, and a User Created control.

For example, when the y-axis emission velocity of the particle is positive and the y-axis acceleration is positive, the particle accelerates in the positive y-axis direction. When the y-axis emission velocity of the particle is positive and the y-axis acceleration is negative, the particle decelerates in the positive y-axis direction. When the velocity decreases to 0, the particle stops moving, or the velocity of the particle continues to be calculated to obtain a negative velocity of the particle, and the particle accelerates in the negative y-axis direction. When the y-axis emission velocity of the particle is negative and the y-axis acceleration is negative, the particle accelerates in the negative y-axis direction. When the y-axis emission velocity of the particle is negative and the y-axis acceleration is positive, the particle decelerates in the negative y-axis direction. When the velocity decreases to 0, the particle stops moving, or the velocity of the particle continues to be calculated to obtain a positive velocity of the particle, and the particle accelerates in the positive y-axis direction.

Operation 2249: Determine a z-axis acceleration value of the particle in response to an attribute setting operation on the z-axis acceleration setting control.

In some embodiments, the z-axis acceleration setting control includes at least one of a Button control, an ImageButton control, a SeekBar control, a Progress Bar control, a Slider control, a Text Box control, a Spin Box control, and a User Created control.

For example, when the z-axis emission velocity of the particle is positive and the z-axis acceleration is positive, the particle accelerates in the positive z-axis direction. When the z-axis emission velocity of the particle is positive and the z-axis acceleration is negative, the particle decelerates in the positive z-axis direction. When the velocity decreases to 0, the particle stops moving, or the velocity of the particle continues to be calculated to obtain a negative velocity of the particle, and the particle accelerates in the negative z-axis direction. When the z-axis emission velocity of the particle is negative and the z-axis acceleration is negative, the particle accelerates in the negative z-axis direction. When the z-axis emission velocity of the particle is negative and the z-axis acceleration is positive, the particle decelerates in the negative z-axis direction. When the velocity decreases to 0, the particle stops moving, or the velocity of the particle continues to be calculated to obtain a positive velocity of the particle, and the particle accelerates in the positive z-axis direction.

In summary, the method provided in the embodiments of this disclosure shows a method for setting an acceleration of a particle. The method is simple and easy to use. In addition, after the acceleration is set, a user may customize particle effects having various motion trajectories and motion velocities, so that particle effects that the user can design are more diverse.

In some embodiments, the editor interface includes a preview area and an editing area, the preview area is configured for previewing the particle generated by the particle generator, and the editing area is configured to set the attribute parameter of the particle generator.

In some embodiments, Operation 230 may be implemented as Operation 231.

Operation 231: Display, in the preview area in response to an attribute confirmation operation on the particle generator in the editing area, the particle effect generated by the particle generator based on the attribute parameter.

In some embodiments, the preview area is configured for previewing a virtual environment picture in which the particle generator generates a particle in a virtual environment. The virtual environment picture is a picture obtained by capturing a three-dimensional virtual environment using a camera model. A user may control the camera model through human-computer interaction operations to change the display effect of the virtual environment picture. Alternatively, the preview area is configured for previewing a virtual picture in which the particle generator generates the particle. The virtual picture is a picture obtained by capturing a three-dimensional virtual environment using the camera model. The three-dimensional virtual environment includes the particle generator. The user may control the camera model through human-computer interaction operations to change the display effect of the virtual picture.

In some embodiments, the particle generated by the particle generator includes at least one attribute parameter. The attribute parameter includes at least one of a color parameter, a scale parameter, a transparency parameter, a brightness parameter, an emission velocity, an emission position, a rotation angle, a rotation speed, a cycle period, a particle texture, a generation rate, and an acceleration.

In summary, in the method provided in the embodiments of this disclosure, the attribute parameter may be set and confirmed in an editing area, so that a user may view in real time a particle effect generated based on the set attribute parameter, and then the user may further edit the attribute parameter based on a real-time result seen in the preview area, thereby improving the efficiency of setting the attribute parameter of the particle effect, reducing human-computer interaction operations required for the user to obtain an expected particle effect, and improving the efficiency of human-computer interaction.

The following separately describes that after the user performs attribute setting operations in the editing area for different attribute parameters, the information about the particle effects generated by the particle generator based on the attribute parameters is displayed in the preview area.

### 4.1 Generate the Particle Effect Based on a Color Parameter

In some embodiments, the particle effect generated by the particle generator based on the color parameter is displayed in the preview area in response to a color parameter confirmation operation on the particle generator in the editing area, the color parameter including at least two color key frame controls, different color key frame controls corresponding to the same or different color values, and the particle effect including an animation in which the color of the particle changes gradually or abruptly between color values corresponding to the at least two color key frame controls.

In some embodiments, as shown in FIG. 8, the editor interface 10 includes a preview area 80 and an editing area 81. The preview area 80 includes a particle generator 82. The editing area 81 includes at least two color key frame controls 83. An animation of the particle effect generated by the particle generator is displayed in the preview area 80 in response to a parameter setting operation on the particle generator for setting the color parameter based on the color key frame control, the particle effect including an animation in which the color of the particle changes gradually or abruptly between color values corresponding to the at least two color key frame controls 83 in the cycle period.

In summary, in the method provided in the embodiments of this disclosure, the color parameter may be set and confirmed in an editing area, so that a user may view in real time a particle effect generated based on the set color parameter, and then the user may further edit the color parameter based on a real-time result seen in the preview area, thereby improving the efficiency of setting the color parameter of the particle effect, reducing human-computer interaction operations required for the user to obtain an expected particle effect, and improving the efficiency of human-computer interaction.

### 4.2 Generate the Particle Effect Based on a Scale Parameter

In some embodiments, the particle effect generated by the particle generator based on the scale parameter is displayed in the preview area in response to a scale parameter confirmation operation on the particle generator in the editing area, the scale parameter including at least two scale key frame controls, different scale key frame controls corresponding to the same or different scale parameter values, and the particle effect including an animation in which the scaling factor of the particle changes gradually or abruptly between scale parameter values corresponding to the at least two scale key frame controls.

In some embodiments, as shown in FIG. 9, the editor interface 10 includes a preview area 80 and an editing area 81. The preview area 80 includes a particle generator 82. The editing area 81 includes at least two scale key frame controls 84. The particle effect generated by the particle generator is displayed in the preview area in response to a parameter setting operation on the particle generator for setting the scale parameter based on the scale key frame control, the particle effect including an animation in which the size of the particle changes gradually or abruptly between scale parameter values corresponding to the at least two color key frame controls 83 in the cycle period.

In summary, in the method provided in the embodiments of this disclosure, the scale parameter may be set and confirmed in an editing area, so that a user may view in real time a particle effect generated based on the set scale parameter, and then the user may further edit the scale parameter based on a real-time result seen in the preview area, thereby improving the efficiency of setting the scale parameter of the particle effect, reducing human-computer interaction operations required for the user to obtain an expected particle effect, and improving the efficiency of human-computer interaction.

### 4.3 Generate the Particle Effect Based on a Transparency Parameter

In some embodiments, the particle effect generated by the particle generator based on the transparency parameter is displayed in the preview area in response to a transparency parameter confirmation operation on the particle generator in the editing area, the transparency parameter including at least two transparency key frame controls, different transparency key frame controls corresponding to the same or different transparency parameter values, and the particle effect including an animation in which the transparency level of the particle changes gradually or abruptly between transparency parameter values corresponding to the at least two transparency key frame controls.

In some embodiments, the transparency parameter indicates a transparency level of the particle generated by the particle generator in the cycle period. A value range of the transparency parameter is 0 to 1. When the transparency parameter is 0, the particle is displayed as completely opaque. When the transparency parameter is 1, the particle is displayed as completely transparent.

In summary, in the method provided in the embodiments of this disclosure, the transparency parameter may be set and confirmed in an editing area, so that a user may view in real time a particle effect generated based on the set transparency parameter, and then the user may further edit the transparency parameter based on a real-time result seen in the preview area, thereby improving the efficiency of setting the transparency parameter of the particle effect, reducing human-computer interaction operations required for the user to obtain an expected particle effect, and improving the efficiency of human-computer interaction.

### 4.4 Generate the Particle Effect Based on a Brightness Parameter

In some embodiments, the particle effect generated by the particle generator based on the brightness parameter is displayed in the preview area in response to a brightness parameter confirmation operation on the particle generator in the editing area, the brightness parameter including at least two brightness key frame controls, different brightness key frame controls corresponding to the same or different brightness parameter values, and the particle effect including an animation in which the brightness level of the particle changes gradually or abruptly between brightness parameter values corresponding to the at least two brightness key frame controls.

In some embodiments, the brightness parameter indicates a brightness level of the particle generated by the particle generator in the cycle period. The value of the brightness parameter may be negative. When the brightness parameter value is a negative value having a larger absolute value, the particle is displayed darker, i.e., is closer to black. When the brightness parameter value is 0, no brightness is applied to the particle, and the color of the particles is directly displayed. When the brightness parameter is a larger positive value, the particle is displayed brighter.

In some embodiments, an upper limit of the brightness parameter is a preset value. For example, the upper limit of the brightness parameter is 10.

In some embodiments, a lower limit of the brightness parameter is a preset value. For example, the upper limit of the brightness parameter is −10.

In summary, in the method provided in the embodiments of this disclosure, the brightness parameter may be set and confirmed in an editing area, so that a user may view in real time a particle effect generated based on the set brightness parameter, and then the user may further edit the brightness parameter based on a real-time result seen in the preview area, thereby improving the efficiency of setting the brightness parameter of the particle effect, reducing human-computer interaction operations required for the user to obtain an expected particle effect, and improving the efficiency of human-computer interaction.

### 4.5 Generate the Particle Effect Based on an Emission Velocity

In some embodiments, the emission velocity indicates the initial motion velocity of the particle generated by the particle generator, and the emission velocity includes at least one of the x-axis emission velocity, the y-axis emission velocity, and the z-axis emission velocity.

In some embodiments, at least one of an x-axis emission velocity maximum value setting control, a y-axis emission velocity maximum value setting control, a z-axis emission velocity maximum value setting control, an x-axis emission velocity minimum value setting control, a y-axis emission velocity minimum value setting control, and a z-axis emission velocity minimum value setting control is displayed on the editing area.

In some embodiments, as shown in FIG. 6, the x-axis emission velocity maximum value setting control, the y-axis emission velocity maximum value setting control, the z-axis emission velocity maximum value setting control, the x-axis emission velocity minimum value setting control, the y-axis emission velocity minimum value setting control is displayed in the editing area. Each control corresponds to two operation manners: an input box and a slider. A digit input box is displayed in response to a trigger operation on the input box to determine the parameter range. The parameter range is determined in response to a drag operation on the slider. For example, attribute parameter values corresponding to the input box and the slider are consistent. To be specific, when the slider is adjusted, the digit displayed in the input box changes. When digits are entered in the input box, the progress of the slider changes.

In some embodiments, the particle effect generated by the particle generator based on the x-axis emission velocity is displayed in the preview area in response to an x-axis emission velocity confirmation operation on the particle generator in the editing area, the x-axis emission velocity including at least one of an x-axis emission velocity maximum value and an x-axis emission velocity minimum value, the particle effect including that an initial emission velocity of the particle in an x-axis direction is a random value within an x-axis emission velocity interval, and the x-axis emission velocity interval being determined based on at least one of the x-axis emission velocity minimum value and the x-axis emission velocity maximum value;

In some embodiments, the particle effect generated by the particle generator based on the y-axis emission velocity is displayed in the preview area in response to a y-axis emission velocity confirmation operation on the particle generator in the editing area, the y-axis emission velocity including at least one of a y-axis emission velocity maximum value and a y-axis emission velocity minimum value, the particle effect including that an initial emission velocity of the particle in a y-axis direction is a random value within a y-axis emission velocity interval, and the y-axis emission velocity interval being determined based on at least one of the y-axis emission velocity minimum value and the y-axis emission velocity maximum value.

In some embodiments, the particle effect generated by the particle generator based on the z-axis emission velocity is displayed in the preview area in response to a z-axis emission velocity confirmation operation on the particle generator in the editing area, the z-axis emission velocity including at least one of a z-axis emission velocity maximum value and a z-axis emission velocity minimum value, the particle effect including that an initial emission velocity of the particle in a z-axis direction is a random value within a z-axis emission velocity interval, and the z-axis emission velocity interval being determined based on at least one of the z-axis emission velocity minimum value and the z-axis emission velocity maximum value.

In some embodiments, when the x-axis emission velocity of the particle is positive, the particle moves in a positive x-axis direction; when the x-axis emission velocity of the particle is negative, the particle moves in a negative x-axis direction; when the y-axis emission velocity of the particle is positive, the particle moves in a positive y-axis direction; when the y-axis emission velocity of the particle is negative, the particle moves in a negative y-axis direction; when the z-axis emission velocity of the particle is positive, the particle moves in a positive z-axis direction; and when the z-axis emission velocity of the particle is negative, the particle moves in a negative z-axis direction.

In summary, in the method provided in the embodiments of this disclosure, the emission velocity may be set and confirmed in an editing area, so that a user may view in real time a particle effect generated based on the set emission velocity, and then the user may further edit the emission velocity based on a real-time result seen in the preview area, thereby improving the efficiency of setting the emission velocity of the particle effect, reducing human-computer interaction operations required for the user to obtain an expected particle effect, and improving the efficiency of human-computer interaction.

### 4.6 Generate the Particle Effect Based on an Emission Position

In some embodiments, the emission position indicates the initial position of the particle generated by the particle generator.

In some embodiments, the emission position of the particle is represented in a coordinate form. For example, the emission position of the particle is (12, 31, 13). Alternatively, the emission position of the particle is (−12, 11, 0). For example, the coordinates are coordinates in a world coordinate system. Alternatively, the coordinates are coordinates in a local coordinate system. The world coordinate system is a three-dimensional Cartesian coordinate system formed based on an origin in a virtual environment. The local coordinate system is a three-dimensional Cartesian coordinate system relative to the particle generator. For example, the local coordinate system is a three-dimensional Cartesian coordinate system with the center of the particle generator as the origin.

In some embodiments, the particle effect generated by the particle generator based on the emission position is displayed in the preview area in response to an emission position confirmation operation on the particle generator in the editing area, the emission position including at least one of a spherical emission position, a triangular emission position, a cylindrical emission position, and a user-defined emission position, different emission positions corresponding to different emission position intervals, and the particle effect including that the particle is located in the emission position interval.

In summary, in the method provided in the embodiments of this disclosure, the emission position may be set and confirmed in an editing area, so that a user may view in real time a particle effect generated based on the set emission position, and then the user may further edit the emission position based on a real-time result seen in the preview area, thereby improving the efficiency of setting the emission position of the particle effect, reducing human-computer interaction operations required for the user to obtain an expected particle effect, and improving the efficiency of human-computer interaction.

### 4.7 Generate the Particle Effect Based on a Rotation Angle

In some embodiments, the rotation angle indicates the initial rotation angle of the particle generated by the particle generator.

In some embodiments, the rotation angle is a rotation angle relative to a preset orientation of the particle. A value range of the rotation angle is [0, 360]. Alternatively, the value range of the rotation angle is [−180, 180]. For example, the value range of the rotation angle is [0, 360]. When the rotation angle of the particle is 120 degrees, the particle rotates by 120 degrees clockwise or anticlockwise relative to the preset orientation of the particle. Alternatively, the value range of the rotation angle is [−180, 180]. When the rotation angle of the particle is 120 degrees, the particle rotates by 120 degrees clockwise or anticlockwise relative to the preset orientation of the particle. When the rotation angle of the particles is −60 degrees, the particle rotates by 60 degrees anticlockwise or clockwise relative to the preset orientation of the particle.

In some embodiments, at least one of a rotation angle maximum value setting control and a rotation angle minimum value setting control is displayed on the editing area.

In some embodiments, the particle effect generated by the particle generator based on the rotation angle is displayed in the preview area in response to a rotation angle confirmation operation on the particle generator in the editing area, the rotation angle including at least one of a rotation angle maximum value and a rotation angle minimum value.

The particle effect includes that the rotation angle of the particle is a random value within a rotation angle interval, and the rotation angle interval is determined based on at least one of the rotation angle minimum value and the rotation angle maximum value.

In summary, in the method provided in the embodiments of this disclosure, the rotation angle may be set and confirmed in an editing area, so that a user may view in real time a particle effect generated based on the set rotation angle, and then the user may further edit the rotation angle based on a real-time result seen in the preview area, thereby improving the efficiency of setting the rotation angle of the particle effect, reducing human-computer interaction operations required for the user to obtain an expected particle effect, and improving the efficiency of human-computer interaction.

### 4.8 Generate the Particle Effect Based on a Rotation Speed

In some embodiments, the rotation speed indicates the rotation speed of the particle generated by the particle generator. The rotation speed indicates an angular velocity of the particle generated by the particle generator. Alternatively, the rotation speed indicates a linear velocity of the particle generated by the particle generator.

In some embodiments, at least one of a rotation speed maximum value setting control and a rotation speed minimum value setting control is displayed on the editing area.

In some embodiments, the particle effect generated by the particle generator based on the rotation speed is displayed in the preview area in response to a rotation speed confirmation operation on the particle generator in the editing area, the rotation speed including at least one of a rotation speed maximum value and a rotation speed minimum value.

The particle effect includes that the rotation speed of the particle is a random value within a rotation speed interval, and the rotation speed interval is determined based on at least one of the rotation speed minimum value and the rotation speed maximum value.

In summary, in the method provided in the embodiments of this disclosure, the rotation speed may be set and confirmed in an editing area, so that a user may view in real time a particle effect generated based on the set rotation speed, and then the user may further edit the rotation speed based on a real-time result seen in the preview area, thereby improving the efficiency of setting the rotation speed of the particle effect, reducing human-computer interaction operations required for the user to obtain an expected particle effect, and improving the efficiency of human-computer interaction.

### 4.9 Generate the Particle Effect Based on a Cycle Period

In some embodiments, the cycle period indicates duration of existence of the particle generated by the particle generator, i.e., duration from generation to disappearance of the particle.

In some embodiments, the particle effect generated by the particle generator based on the cycle period is displayed in the preview area in response to a cycle period confirmation operation on the particle generator in the editing area.

In some embodiments, the cycle period value of the particle is a cycle period value of all particles generated by the particle generator. For example, if a cycle period value of a particle generator a is 5 and a cycle period value of a particle generator b is 2, cycle period values of particles generated by the particle generator a are all 5, and cycle period values of particles generated by the particle generator b are all 2. Alternatively, the cycle period value of the particle is a maximum cycle period value of the particle. For example, the cycle period value of the particle generator a is 5, and a cycle period range of the particle generator a is (0, 5]. Cycle period values of particles a1 to a5 generated by the particle generator are 2, 4, 3, 2, and 5, respectively.

In summary, in the method provided in the embodiments of this disclosure, the cycle period may be set and confirmed in an editing area, so that a user may view in real time a particle effect generated based on the set cycle period, and then the user may further edit the cycle period based on a real-time result seen in the preview area, thereby improving the efficiency of setting the cycle period of the particle effect, reducing human-computer interaction operations required for the user to obtain an expected particle effect, and improving the efficiency of human-computer interaction.

### 4.10 Generate the Particle Effect Based on a Particle Texture

In some embodiments, the particle effect generated by the particle generator based on the particle texture is displayed in the preview area in response to a particle texture confirmation operation on the particle generator in the editing area.

In some embodiments, the texture may be understood as a display effect of the particle in a virtual environment. For example, if the texture is a pentagram image, the particle generated by the particle generator is a pentagram. If the texture is a tree leaf image, the particle generated by the particle generator is a tree leaf.

In some embodiments, a particle texture selection area is displayed on the editing area, the particle texture selection area including at least one particle texture control, and different particle texture controls corresponding to different particle textures.

In summary, in the method provided in the embodiments of this disclosure, the particle texture may be set and confirmed in an editing area, so that a user may view in real time a particle effect generated based on the set particle texture, and then the user may further edit the particle texture based on a real-time result seen in the preview area, thereby improving the efficiency of setting the particle texture of the particle effect, reducing human-computer interaction operations required for the user to obtain an expected particle effect, and improving the efficiency of human-computer interaction.

### 4.11 Generate the Particle Effect Based on a Generation Rate

In some embodiments, the particle effect generated by the particle generator based on the generation rate is displayed in the preview area in response to a generation rate confirmation operation on the particle generator in the editing area, the particle effect including a first quantity of particles generated by the particle generator in the second unit time, and the generation rate being positively correlated to the first quantity.

In some embodiments, the generation rate is positively correlated to the first quantity. For example, one particle is generated on the first frame of particle generation by the particle generator, and on an n^{th} frame of particle generation by the particle generator, the first quantity of particles are generated in the second unit time based on the generation rate.

In summary, in the method provided in the embodiments of this disclosure, the generation rate may be set and confirmed in an editing area, so that a user may view in real time a particle effect generated based on the set generation rate, and then the user may further edit the generation rate based on a real-time result seen in the preview area, thereby improving the efficiency of setting the generation rate of the particle effect, reducing human-computer interaction operations required for the user to obtain an expected particle effect, and improving the efficiency of human-computer interaction.

### 4.12 Generate the Particle Effect Based on an Acceleration

In some embodiments, the acceleration indicates the acceleration of the particle of the particle generator. The acceleration includes at least one of the x-axis acceleration, the y-axis acceleration, and the z-axis acceleration.

In some embodiments, when the x-axis acceleration of the particle is positive, the direction of the acceleration is a positive x-axis direction; when the x-axis acceleration of the particle is negative, the direction of the acceleration is a negative x-axis direction; when the y-axis acceleration of the particle is positive, the direction of the acceleration is a positive y-axis direction; when the y-axis acceleration of the particle is negative, the direction of the acceleration is a negative y-axis direction; when the z-axis acceleration of the particle is positive, the direction of the acceleration is a positive z-axis direction; and when the z-axis acceleration of the particle is negative, the direction of the acceleration is a negative z-axis direction.

In some embodiments, the particle effect generated by the particle generator based on the x-axis acceleration is displayed in the preview area in response to an x-axis acceleration confirmation operation on the particle generator in the editing area.

In some embodiments, the particle effect generated by the particle generator based on the y-axis acceleration is displayed in the preview area in response to a y-axis acceleration confirmation operation on the particle generator in the editing area.

In some embodiments, the particle effect generated by the particle generator based on the z-axis acceleration is displayed in the preview area in response to a z-axis acceleration confirmation operation on the particle generator in the editing area.

For example, when the x-axis emission velocity of the particle is positive and the x-axis acceleration is positive, the particle accelerates in the positive x-axis direction. When the x-axis emission velocity of the particle is positive and the x-axis acceleration is negative, the particle decelerates in the positive x-axis direction. When the velocity decreases to 0, the particle stops moving, or the velocity of the particle continues to be calculated to obtain a negative velocity of the particle, and the particle accelerates in the negative x-axis direction. When the x-axis emission velocity of the particle is negative and the x-axis acceleration is negative, the particle accelerates in the negative x-axis direction. When the x-axis emission velocity of the particle is negative and the x-axis acceleration is positive, the particle decelerates in the negative x-axis direction. When the velocity decreases to 0, the particle stops moving, or the velocity of the particle continues to be calculated to obtain a positive velocity of the particle, and the particle accelerates in the positive x-axis direction.

For example, when the x-axis emission velocity of the particle is positive, the y-axis emission velocity and the z-axis emission velocity are both 0, the y-axis acceleration is positive, and the x-axis acceleration and the z-axis acceleration are 0, the final motion trajectory of the particle moves along a curve in the positive x-axis direction, and the curvature of the curve is positively correlated to the magnitude of the acceleration.

In summary, in the method provided in the embodiments of this disclosure, the acceleration may be set and confirmed in an editing area, so that a user may view in real time a particle effect generated based on the set acceleration, and then the user may further edit the acceleration based on a real-time result seen in the preview area, thereby improving the acceleration of the generation rate of the particle effect, reducing human-computer interaction operations required for the user to obtain an expected particle effect, and improving the efficiency of human-computer interaction.

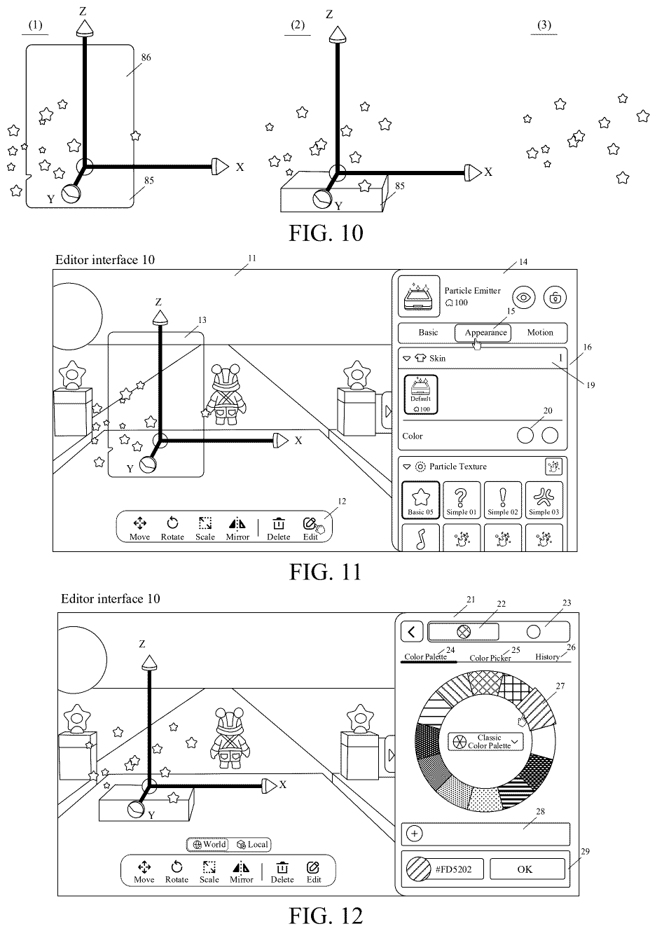

In some embodiments, the particle generator includes a base, and the base is configured for identifying the particle generator. As shown in the schematic diagram (3) of FIG. 10, a base 85 of the particle generator is hidden on a play mode interface of the UGC editor. As shown in the schematic diagrams (1) and (2) of FIG. 10, the base 85 is visible on the editor interface of the UGC editor.

In the UGC editor, the user usually adds at least one particle generator. To identify different particle generators, different particle generators may be distinguished by setting base colors.

In some embodiments, the method further includes Operation 240.

Operation 240: Receive, in response to a base color confirmation operation on the particle generator, a base color set for the particle generator, a base of the particle generator indicating at least one of a position and an angle of the particle generator in a virtual environment on the editor interface. For example, at least one base color for the base of the particle generator is received based on a base color setting operation on the editor interface.

In some embodiments, the base of the particle generator is a simple graphic. Alternatively, the base is a graphic set by the user. For example, the base is a cuboid.

In some embodiments, the center of the base coincides with the center of the particle generator, and the position, orientation, and size of the base change along with the movement, rotation, and scaling of the particle generator, respectively.

In some embodiments, the base color includes a base bottom color and a base top color. Operation 240 may be implemented as Operation 241 or Operation 242.

In some embodiments, at least one of a base bottom color control, a base top color control, a base color selection tab, and a base color selection operation control is displayed on the editor interface in response to a trigger operation on a base color setting entry of the particle generator.

In some embodiments, the base color setting entry includes at least one of a Button control, an ImageButton control, a Combo Box control, and a User Created control; the base bottom color control includes at least one of a Button control, an ImageButton control, and a User Created control; the base top color control includes at least one of a Button control, an ImageButton control, and a User Created control; the base color selection tab includes at least one of a TabLayout control and a User Created control; and the base color selection operation control includes at least one of a Button control, an ImageButton control, an Image control, and ImageView.

Operation 241: Determine, in response to a trigger operation on the base color selection operation control when the base bottom color control is in a selected state, that a base bottom color of the particle generator is a color value selected from the base color selection operation control. For example, based on a trigger operation on a first base color selection operation control element displayed on the editor interface when a base bottom color control element displayed on the editor interface is in a selected state, a color value selected from the first base color selection operation control element is determined as a base bottom color of the base of the particle generator.

The base color selection tab indicates a color selection mode; the base color selection tab includes at least one of a color palette tab, a color picker tab, and a history tab; different base color selection tabs correspond to different base color selection operation controls; the color palette tab corresponds to a color palette color selection control; the color picker tab corresponds to a color picker color selection control; the history tab corresponds to a history color selection control; and the base color selection operation control is configured to select a color from the at least one candidate color.

Operation 242: Determine, in response to a trigger operation on a second color selection operation control when the base top color control is in a selected state, that a base top color of the particle generator is a color value selected from the base color selection operation control. For example, based on a trigger operation on a second color selection operation control element displayed on the editor interface when a base top color control element displayed on the editor interface is in a selected state, a color value selected from the second base color selection operation control element is determined a base top color of the base of the particle generator.

In some embodiments, a manner of setting the base bottom color and the base top color is similar to that of setting the particle color using the key frame control in the foregoing 1.1. Details are not described herein again.

In some embodiments, the editor interface includes a preview area and an editing area, the preview area is configured for previewing the particle generated by the particle generator, and the editing area is configured to set the attribute parameter of the particle generator.

In some embodiments, the set base color of the particle generator is displayed in the preview area in response to a base color confirmation operation on the particle editor in the editing area, the base color including a gradient that transitions from the base bottom color to the base top color from bottom to top, or a gradient that transitions from the base top color to the base bottom color from top to bottom.

In summary, in the method provided in the embodiments of this disclosure, colors are set for the base of the particle generator, so that a plurality of particle generators located in a virtual environment can be identified on the editor interface, facilitating selection operations of different particle generators by a user, thereby reducing human-computer interaction operations and improving the efficiency of human-computer interaction.

In some embodiments, the method further includes Operation 250 or Operation 260.

Operation 250: Set the particle generator to a selected state in response to a selection operation on the particle generator, and add an indicator box to the particle generator, the indicator box indicating the selected state.

In some embodiments, as shown in the schematic diagram (1) of FIG. 10, the particle generator is set to a selected state in response to a selection operation on the particle generator, and an indicator box 86 is added to the particle generator, the indicator box 86 indicating that the particle generator is in the selected state.

Operation 260: Keep the particle generator in the selected state and hide the indicator box in response to an editing operation on the particle generator.

In some embodiments, as shown in the schematic diagram (2) of FIG. 10, the particle generator is kept in the selected state and the indicator box 86 is hidden in response to the editing operation on the particle generator.

In summary, in the method provided in the embodiments of this disclosure, an indicator box can be displayed when a user selects a particle generator to indicate that the user has selected the particle generator. When the user edits the particle generator, the indicator box is hidden, so that the user can more conveniently observe the impact of an editing operation on the generation of the particle generator, making it more convenient to finely edit a particle, thereby improving the generation effect of a particle effect and improving the effect of human-computer interaction.

In some embodiments, the method further includes Operation 270.

Operation 270: Receive, in response to a setting operation on a trigger signal of the particle generator, a trigger signal set for the particle generator. For example, the particle generator is configured to perform one or more operations based on receiving one or more corresponding trigger signals.

The trigger signal includes at least one of an automatic generation signal, a start signal, and a stop signal; the automatic generation signal indicates the particle generator to automatically generate the particle; and the start signal indicates the particle generator to start generating the particle based on the start signal; and the stop signal indicates the particle generator to stop generating the particle based on the stop signal. In some examples, the one or more trigger signals include at least one of an automatic generation signal triggering the particle generator to automatically generate the at least one particle, a start signal triggering the particle generator to start generating the at least one particle, and a stop signal triggering the particle generator to stop generating the at least one particle.

In some embodiments, autoplay is disabled for the particle generator, i.e., an automatic generation signal is not set, and a start signal is set for the particle generator, so that the particle generator generates a particle only when the start signal is triggered. Alternatively, autoplay is disabled for the particle generator, i.e., an automatic generation signal is not set, and a start signal and a stop signal are set for the particle generator, so that whether to generate a particle may be controlled by triggering the start signal and the stop signal of the particle generator. Alternatively, autoplay is disabled for the particle generator, i.e., an automatic generation signal is set for the particle generator, and the stop signal is set for the particle generator, so that when the stop signal is triggered, particle generation is stopped.

In some embodiments, the trigger signal of the particle generator is bound to a signal trigger or a signal trigger control.

In some embodiments, the signal trigger is displayed in the virtual environment, or the signal trigger control is displayed on the editor interface.

In some embodiments, the signal trigger control includes at least one of a Button control, an ImageButton control, and a User Created control.

In some embodiments, a signal trigger is set for the particle generator in the virtual environment, and the particle generator is controlled in response to the signal trigger receiving a first trigger signal to generate the particle. For example, the first trigger signal corresponds to the start signal of the particle generator, and the particle generator is controlled to start generating the particle. Alternatively, the first trigger signal corresponds to the stop signal of the particle generator, and the particle generator is controlled to stop generating the particle.

In some embodiments, a signal trigger control is displayed on the editor interface, and the particle generator is controlled in response to the signal trigger control receiving a second trigger signal to generate the particle. For example, the second trigger signal corresponds to the start signal of the particle generator, and the particle generator is controlled to start generating the particle. Alternatively, the second trigger signal corresponds to the stop signal of the particle generator, and the particle generator is controlled to stop generating the particle.

In some embodiments, the signal trigger and the signal trigger control may be used at the same time. For example, the first trigger signal corresponds to the start signal of the particle generator, and the particle generator is controlled to start generating the particle. The second trigger signal corresponds to the stop signal of the particle generator, and the particle generator is controlled to stop generating the particle.

In summary, in the method provided in the embodiments of this disclosure, a trigger signal may be set for the particle generator to control whether the particle generator generates a particle, and particle generation is started or stopped only when the trigger signal is met, so that a user autonomously controls whether to generate a particle effect, thereby increasing the degree of freedom for generating the particle effect. In addition, operations of the user are facilitated, thereby reducing human-computer interaction operations and improving the efficiency of human-computer interaction.

In some embodiments, the method further includes Operation 280.

Operation 280: Receive, in response to a motion control operation on the particle generator, a motion mode set for the particle generator.

The motion mode of the particle generator includes one of a full-range motion mode, a one-way displacement mode, a reciprocating displacement mode, a unidirectional rotation mode, an oscillatory motion mode, and a waypoint motion mode.

Different motion modes correspond to different motion attributes. For example, each of the motion attribute includes at least one of a motion start signal, a motion stop signal, a motion return signal, and a motion cycle form. After the motion start signal is received, a motion unit is switched to an active state. If an activation signal is null, the motion unit is in the active state by default after the game starts, or otherwise is in a paused state. After receiving the motion stop signal, the motion unit is switched to the paused state. The time in the paused state is not calculated for the lifetime. The motion return signal is allowed to be configured only in a one-way motion mode, and a reverse motion is activated after the signal is received.

The waypoint motion mode indicates that a virtual object moves along a motion path formed by at least two waypoints. The positions, rotations, and scales of the at least two waypoints are the same or different, and each of the waypoints indicates at least one of a position, a rotation, and a scale of the virtual object when the virtual object moves to the waypoint. The one-way displacement mode indicates a single constant-speed motion on a straight line, and the mode stops after the motion ends. The user can set motion duration or the like of the single motion to control the single motion. The reciprocating displacement mode indicates a constant-speed reciprocating motion on the same straight line. The unidirectional rotation mode indicates that the virtual object performs a constant-speed rotation with the axis unchanged. The axis is the center of the virtual object. The oscillatory motion mode indicates rotational oscillation with the axis unchanged, for example, a pendulum. The full-range motion mode indicates a motion according to a motion logic. In the full-range motion mode, all motion behaviors can be implemented through setting, for example, at least one of the one-way displacement mode, reciprocating displacement mode, unidirectional rotation mode, and oscillatory motion mode. A variable motion may alternatively be set in the full-range motion mode.

In summary, in the method provided in the embodiments of this disclosure, motion control can be added to the particle generator, and only a simple graphic operation needs to be performed to add the motion control, so that the particle generator can implement motion in the virtual environment, thereby finally obtaining more diverse particle effects and improving the generation effect of the particle effect.

To understand various display manners and operation manners in the embodiments of this disclosure, detailed descriptions are made below with reference to schematic diagrams.

### Particle Generator in the Virtual Environment Displayed on the Editor Interface of the UGC Editor

The particle generator is a component of the UGC editor. The particle generator can generate particles in a virtual environment, and can simulate effects such as dust, sparks, smoke, and raindrops using particles. A special effect can be added to a virtual environment using the particle generator.

FIG. 11 is a schematic diagram of a UGC effect generation method in a game program according to an embodiment of this disclosure.

The UGC editor includes an editor interface 10 and a play mode interface. The editor interface 10 includes at least one of a virtual environment picture 11 and a control display area 12. The virtual environment picture 11 displays a particle generator 13 located in a virtual environment.

The virtual environment picture 11 is a picture obtained by capturing a three-dimensional virtual environment using a camera model. A user may control the camera model using interaction operations on a touchscreen to change the display effect of the virtual environment picture 11. The control display area 12 is configured to display controls for editing the particle generator, including at least one of a movement control, a rotation control, a scale control, a mirror control, a deletion control, and an editing control.

When the user selects the particle generator 13 through the editor interface 10, a details area 14 is displayed in an area on the right side of the editor interface 10. Alternatively, after the user selects the particle generator 13 and performs a click operation on the editing control in the control display area 12, the details area 14 is displayed in an area on the right side of the editor interface 10. The user performs a click operation on an appearance editing control 15 in the details area 14, so that the details area 14 displays an appearance area 16.

The editor interface 10 further includes a details collapse control. Based on a click operation performed by the user on the details collapse control, the details area 14 may be hidden from the editor interface 10.

When the user selects the particle generator 13, as shown in the schematic diagram (1) of FIG. 10, the particle generator 13 is in a selected state, and the particle generator 13 has an indicator box 17. When the user performs an editing operation on the particle generator 13, the particle generator 13 is in a selected state, but the indicator box 17 is hidden, as shown in the schematic diagram (2) of FIG. 10.

### Edit the Particle Generator

### 1. Set the Base Color

A base 18 of the particle generator is configured to identify the particle generator. As shown in the schematic diagram (3) of FIG. 10, the base 18 of the particle generator is hidden on a play mode interface of the UGC editor, and is displayed on the editor interface 10 of the UGC editor.

A user may change a base representation form of the particle generator in a skin setting area 19 of the appearance area 16, for example, change the color of the base 18. After the user performs a click operation on a base color setting entry 20, a base color setting area 21 is entered. The user can set different base colors for different particle generators using the base color setting area 21. In this way, it may be more convenient and faster to distinguish between different particle generators.

The user may set two colors for the particle generator, which are respectively a base bottom color and a base top color. The base color displayed on the editor interface 10 gradually changes from the base bottom color to the base top color from bottom to top. A base bottom color display control and a base top color display control are separately displayed in the base color setting entry 20.

As shown in FIG. 12, the base color setting area 21 includes at least one of a base bottom color control 22, a base top color control 23, a color palette tab 24, a color picker tab 25, a history tab 26, a color selection operation control 27, a color saving area 28, and a color confirmation area 29. When the user triggers the base bottom color display control to enter the base color setting area 21, the base bottom color control 22 is in a selected state. To be specific, a color selection operation is performed on the base bottom color. When the user triggers the base top color display control to enter the base color setting area 21, the base top color control 23 is in a selected state. To be specific, a color selection operation is performed on the base top color. Three color selection modes are provided, and correspond to different tabs, respectively. The color saving area 28 includes a color saving control. When the color selection operation control is in a selected state, the color saving control is triggered, and a color corresponding to the color selection operation control in the selected state may be saved into the color saving area 28. The user may further decide, in the color confirmation area 29, whether to use the candidate color. After clicking a color confirmation control in the color confirmation area 29, the bottom color or the top color corresponding to the base is changed to the currently selected color, and the user exits the base color setting area 21, or still stays in the base color setting area 21.

As shown in FIG. 12, the color palette tab 24 includes 12 candidate colors, and each candidate color corresponds to one color selection operation control. When the user selects a color selection operation control, the color selection operation control is in a selected state, and a color display control in the color confirmation area 29 is also changed into a color consistent with the color corresponding to the color selection operation control and a color value corresponding to the color. The user may further select a color by inputting a color value on the color display control. The color palette tab 24 further includes a color palette selection control, and the user may switch a color combination of color selection controls displayed on the color palette tab 24 by clicking the color palette selection control. Candidate color palette colors in the color palette selection control are a preset color combination or a user-defined color combination.

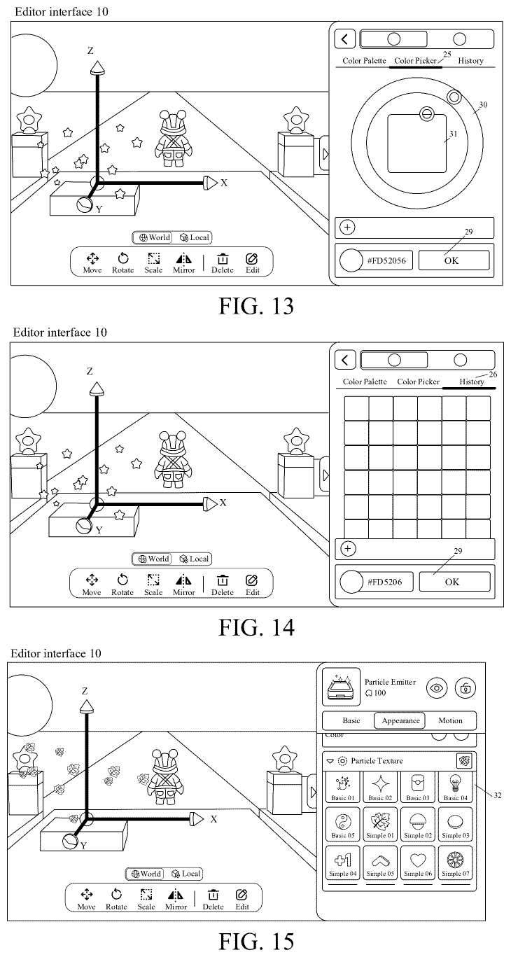

As shown in FIG. 13, when the user chooses to enter a color picker tab 25, a color wheel control 30, a lightness control 31, a color selection operation control corresponding to the color wheel control 30, and a color selection operation control corresponding to the lightness control 31 are displayed. The color wheel control 30 is an RGB color wheel or an RYB color wheel, i.e., a color selection interval obtained by mixing red, green, and blue or red, yellow, and blue as primary colors. The lightness control 31 indicates the intensity of color brightness. The lightness change displayed by the lightness control 31 is that from bottom to top, the lightness increases, i.e., the color gradually changes from black to white, and from left to right, the lightness decreases, i.e., the color gradually changes from white to black. When the user performs a color selection operation on the color wheel control 30, the lightness control 31 displays lightness transformation information corresponding to a color selected from the color wheel control. A color display control in the color confirmation area 29 is also changed into a color consistent with the color corresponding to the color selection operation control and a color value corresponding to the color. The user may further select a color by inputting a color value on the color display control.

As shown in FIG. 14, when the user chooses to enter the history tab 26, a color selection operation control corresponding to at least one candidate color is displayed. Each time the user triggers the color confirmation control in the color confirmation area 29, the color is stored in the history tab. The earlier a color selected, the lower the position of the color in the order. The user may alternatively switch the displayed candidate colors using a slide operation.

### 2. Set the Particle Texture

As shown in FIG. 15, the appearance area 16 further includes a particle texture selection area 32. The particle texture selection area 32 includes at least one candidate particle texture control, and different particle texture controls correspond to different particle textures. The particle texture selection area 32 further includes a currently selected particle texture display icon, and the particle texture display icon indicates a particle texture corresponding to the particle currently generated by the particle generator. The particle texture selection area 32 may collapse at least one candidate particle texture control in the particle texture selection area 32 by triggering a particle texture collapse control.

In some embodiments, a user can add a user-defined particle texture component to a texture selection area in a manner of importing a texture.

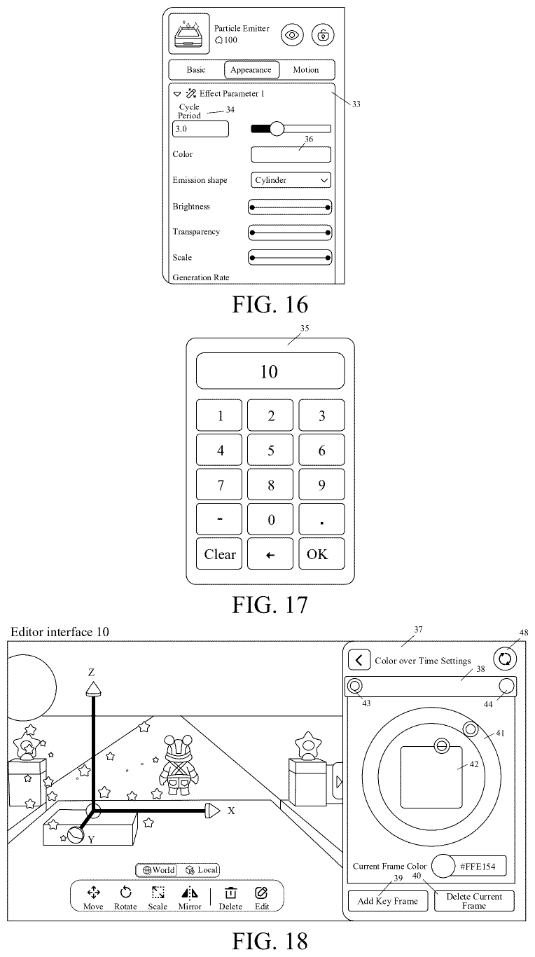

As shown in FIG. 16, the details area 14 further includes an effect parameter area 33, and the effect parameter area 33 is configured for setting the attribute parameter of the particle generated by the particle generator. The effect parameter area 33 may collapse at least one attribute setting control in the effect parameter area 33 by triggering an effect parameter collapse control.

Different attribute parameters correspond to different attribute setting controls. Different attribute parameters are set in different manners. The setting manner includes the following three manners:

Setting Manner 1: Set the attribute parameter based on a key frame control.

Setting Manner 2: Set an attribute parameter interval based on a maximum value control and/or a minimum value control.

Setting Manner 3: Set the attribute parameter directly.

The particle texture is also one type of attribute parameter, and a setting manner used for the particle texture is a Setting Manner 3. The attribute parameters of the particle and setting manners corresponding to the attribute parameters are described one by one below.

### 3. Set the Cycle Period of the Particle (Setting Manner 3)

The cycle period is a life cycle of the particle, and indicates duration of existence of the particle generated by the particle generator, i.e., duration from generation to disappearance of the particle generated by the particle generator.

As shown in FIG. 16, the effect parameter area 33 includes a cycle period setting control 34. The user may manually enter digits by clicking a cycle period input box to set the cycle period of the particle. The user may alternatively set the cycle period of the particle by dragging a cycle period attribute bar. After the cycle period input box is clicked, an input method application is invoked to enter the cycle period. Alternatively, as shown in FIG. 17, an input control 35 is displayed on the editor interface 10 to enter the cycle period. Cycle periods corresponding to the cycle period input box and the cycle period attribute bar are the same. When the cycle period of the particle generator is changed using the cycle period input box, a displayed length of the cycle period attribute bar is also changed correspondingly. Similarly, when the cycle period of the particle generator is changed using the cycle period attribute bar, a value displayed in the cycle period input box is also changed correspondingly.

In some embodiments, the cycle period set using the cycle period setting control 34 is a maximum cycle period of the particle generated by the particle generator. For example, if the cycle period set by the cycle period setting control 34 is 5, the cycle period of the particle generated by the particle generator is a random value within (0, 5]. For example, the particle generator generates particles a1 to a5, and cycle periods corresponding to the particles a1 to a5 are respectively 2, 4, 3, 2, and 5.

### 4. Set the Color of the Particle (Setting Manner 1)

The user can control, by setting the color of the particle, a color change of the particle generated by the particle generator in the cycle period of the particle.

As shown in FIG. 16, the effect parameter area 33 further includes a particle color setting entry 36. The particle color setting entry 36 displays a particle color preview control, and the color preview control indicates the color change of the particle generated by the particle generator in the cycle period.

As shown in FIG. 18, after the user performs a click operation on the particle color setting entry 36, a particle color setting area 37 is displayed. The user can set, using the particle color setting area 37, the color change of the particle generated by the particle generator in the cycle period. The particle color setting area 37 includes at least one of at least two color key frame controls, a color coordinate axis 38, a key frame addition control 39, a key frame deletion control 40, a color wheel control 41, and a lightness control 42. In an initial state, the particle color includes two key frame controls, which are respectively a start frame control 43 and an end frame control 44. The at least two key frame controls included for the color of the particle are located on the color coordinate axis, the start frame control 43 is located on the leftmost side of the color coordinate axis, and the end frame control 44 is located on the rightmost side of the color coordinate axis.

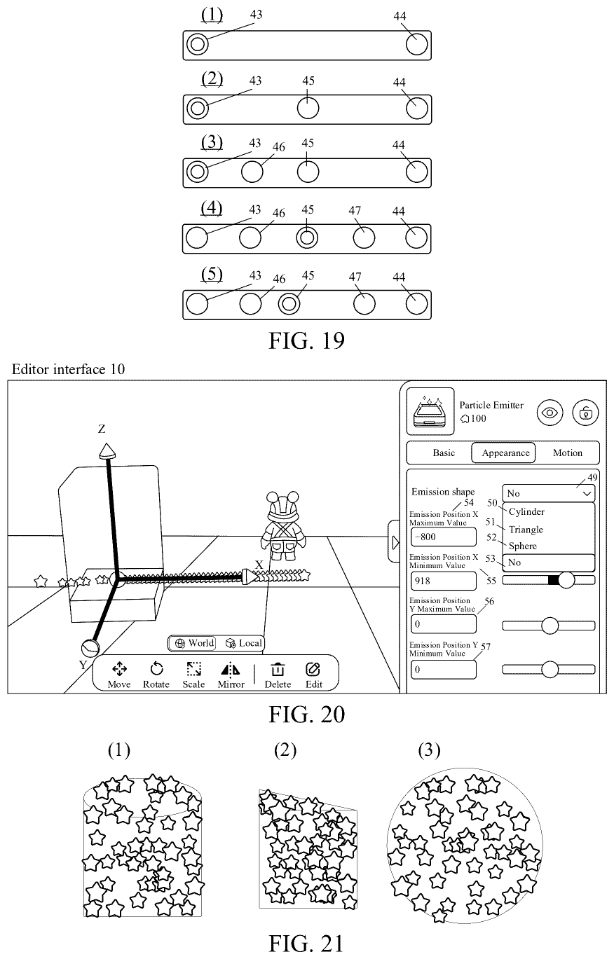

The user can add a key frame control to the color coordinate axis 38 by clicking the key frame addition control 39, and a newly added key frame control is located between the key frame control that is in a selected state and the first key frame control on the right side of the key frame control. As shown in FIG. 19, in the schematic diagram (1), the color coordinate axis includes the start frame control 43 and the end frame control 44. As shown in the schematic diagram (2) of FIG. 19, the start frame control 43 is in a selected state, and after the user clicks the key frame addition control, a new key frame control 45 is added between the start frame control 43 and the end frame control 44. As shown in the schematic diagram (3) of FIG. 19, still the start frame control 43 is in a selected state, and after the user clicks the key frame addition control, a new key frame control 46 is added between the start frame control 43 and the key frame control 45. As shown in the schematic diagram (4) of FIG. 19, the key frame control 45 is in a selected state, and after the user clicks the key frame addition control, a new key frame control 47 is added between the key frame control 45 and the end frame control 44. When a new key frame control is added between two key frame controls, the new key frame control is located at a midpoint of the two key frame controls. The color coordinate axis 38 includes at most 5 key frame controls. When the number of the key frame controls on the color coordinate axis 38 reaches 5, if the key frame addition control 39 continues to be clicked, prompt information “The current number of key frames has reached the maximum number. No further additions are allowed.” is displayed on the editor interface.

As shown in FIG. 18, the user can delete, by clicking the key frame deletion control 40, a key frame control selected from the color coordinate axis 38. The start frame control 43 and the end frame control 44 cannot be deleted. When the user performs an operation on deleting the start frame control 43 or the end frame control 44, prompt information “Deletion of the start frame is not allowed” or “Deletion of the end frame is not allowed” is displayed on an editor interface.

Key frame controls other than the start frame control 43 and the end frame control 44 may be moved on the color coordinate axis 38 to change positions. As shown in the schematic diagram (5) of FIG. 19, after the key frame control 45 is selected, the key frame control 45 is moved to the left.

As shown in FIG. 18, the particle color setting area 37 includes the color wheel control 41, the lightness control 42, a color selection operation control corresponding to the color wheel control 41, and a color selection operation control corresponding to the lightness control 42. The color wheel control 41 is an RGB color wheel or an RYB color wheel, i.e., a color selection interval obtained by mixing red, green, and blue or red, yellow, and blue as primary colors. The lightness control 42 indicates the intensity of color brightness. The lightness change displayed by the lightness control 42 is that from bottom to top, the lightness increases, i.e., the color gradually changes from black to white, and from left to right, the lightness decreases, i.e., the color gradually changes from white to black. When the user performs a color selection operation on the color wheel control 41, the lightness control 42 displays lightness transformation information corresponding to a color selected from the color wheel control. The user selects the key frame control 43 on the color coordinate axis 38, selects a desired color by adjusting the color wheel control 41 and the lightness control 42, and adds the color to the selected key frame control 43. The color coordinate axis 38 displays a gradient that transitions from a color corresponding to the key frame control 43 to a color corresponding to the key frame control 44. When the color coordinate axis includes more than two key frame controls, as shown in the schematic diagram (3) of FIG. 19, the color coordinate axis 38 displays gradients that transition sequentially from the color corresponding to the key frame control 43 to a color corresponding to the key frame control 46 to a color corresponding to the key frame control 45 to the color corresponding to the key frame control 44.

As shown in FIG. 18, the particle color setting area 37 further includes a color reset control 48. After the user clicks the color reset control 48, the color displayed on the color coordinate axis 38 is restored to a state upon entry into the particle color setting area 37. Alternatively, after the user clicks the color reset control 48, the color displayed on the color coordinate axis 38 is changed to the color corresponding to the selected key frame control.

As shown in FIG. 18, the particle color setting area 37 further includes a color display control. The color display control is configured to display a currently selected color and a color value corresponding to the currently selected color. The user may further select a color by inputting a color value on the color display control.

The color selection operation for the color of the particle may alternatively be any color selection operation for the base shown in FIG. 12 to FIG. 14. To be specific, the particle color setting area 37 includes a color selection tab, and the color selection tab includes at least one of the color palette tab, the color picker tab, and the history tab.

### 5. Set the Emission Shape (Emission Position) (Setting Manner 2)

FIG. 20 is a schematic diagram of a UGC effect generation method in a game program according to an embodiment of this disclosure.

The emission position indicates the initial position of the particle generated by the particle generator. The emission position may also be referred to as an emission shape. After a user performs a click operation on an emission position entry 49, at least one emission position control is displayed. The emission position control includes a cylindrical parameter control 50, a triangular parameter control 51, a spherical parameter control 52, and a user-defined parameter control 53.

As shown in the schematic diagram (1) of FIG. 21, when the user selects the cylindrical parameter control 50, the particles generated by the particle generator are located on the surface of a cylinder and inside the cylinder. As shown in the schematic diagram (2) of FIG. 21, when the user selects the triangular parameter control 51, the particles are located on the surface of a triangular prism and inside the triangular prism. As shown in the schematic diagram (3) of FIG. 21, when the user selects the spherical parameter control 51, the particles are located on the surface of a sphere and inside the sphere.

When the user selects the user-defined parameter control 53, the editor interface displays the user-defined parameter control. The user-defined parameter control includes at least one of an x-axis maximum value setting control 54, an x-axis minimum value setting control 55, a y-axis maximum value setting control 56, a y-axis minimum value setting control 57, a z-axis maximum value setting control, and a z-axis minimum value setting control.

A representation form of the emission position of the particle is (x, y, z), and the user may separately set maximum values and minimum values of x, y, and z. The particles are generated at random positions in an area set by the user.

### 6. Set the Transparency of the Particle (Setting Manner 1)

The transparency parameter indicates a transparency level of the particle generated by the particle generator in the cycle period. A value range of the transparency parameter is 0 to 1. When the transparency parameter is 0, the particle is displayed as completely opaque. When the transparency parameter is 1, the particle is displayed as completely transparent.

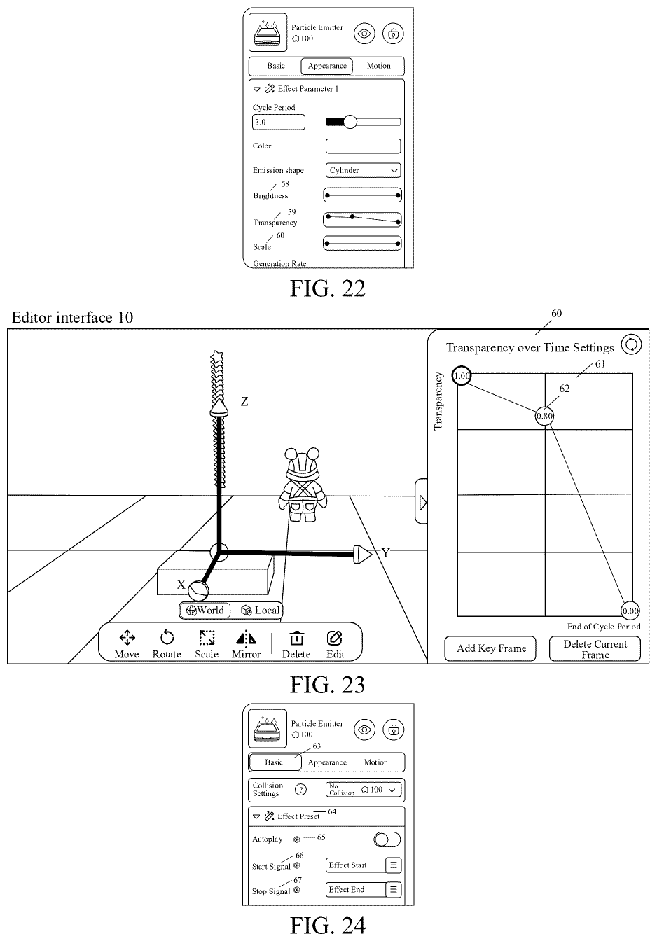

As shown in FIG. 22, the effect parameter area 33 further includes a transparency setting entry 59. The transparency setting entry 59 further displays a currently set transparency trend. After the transparency setting entry 59 is clicked, a transparency setting area 60 is entered. As shown in FIG. 23, the transparency setting area 60 includes a transparency coordinate system 61 and at least two transparency key frame controls 62 located in the transparency coordinate system 61. The user may set the transparency change trend by dragging a transparency key frame control.

A manner in which the user operates the transparency key frame control and adjusts the transparency parameter is similar to the foregoing manner of adjusting the color of the particle, and details are not described herein again.

### 7. Set the Brightness of the Particle (Setting Manner 1)

The brightness parameter indicates a brightness level of the particle generated by the particle generator in the cycle period. The value of the brightness parameter may be negative. When the brightness parameter value is a negative value having a larger absolute value, the particle is displayed darker, i.e., is closer to black. When the brightness parameter value is 0, no brightness is applied to the particle, and the color of the particles is directly displayed. When the brightness parameter is a larger positive value, the particle is displayed brighter.

In some embodiments, an upper limit of the brightness parameter is a preset value. For example, the upper limit of the brightness parameter is 10.

In some embodiments, a lower limit of the brightness parameter is a preset value. For example, the upper limit of the brightness parameter is −10.

The effect parameter area 33 further includes a brightness setting entry 58, and the brightness setting entry 58 further displays a currently set brightness trend. After the brightness setting entry 58 is clicked, a brightness setting area is entered. The brightness setting area is shown in the schematic diagram (3) of FIG. 5, and details are not described herein again.

### 8. Set the Particle Scale Parameter (Setting Manner 1)

The scale parameter of the particle is similar to the transparency and brightness. The scale parameter indicates a scaling factor of the particle generated by the particle generator in the cycle period. The scaling factor indicates a scaling ratio relative to a default particle size. A minimum value of the particle scale parameter is 0. When the particle scale parameter is 0, the particle size is 0 times the default particle size. When the particle scale parameter is 1, the particle size is 1 time the default particle size. When the particle scale parameter is 2.5, the particle size is 2.5 times the default particle size.

As shown in FIG. 22, the effect parameter area 33 further includes a scale setting entry 60. After the scale setting entry is clicked, a scale setting area is entered. The scale setting area is shown in the schematic diagram (1) of FIG. 5, and details are not described herein again.

### 9. Set the Generation Rate of the Particle (Setting Manner 3)

The generation rate of the particle indicates the quantity of particles generated by the particle generator in a unit time. The unit time is a preset value. Alternatively, the unit time is a value set by the user.

For example, the unit time is 1 second, and the generation rate indicates a quantity of particles generated by the particle generator in 1 second. Alternatively, the unit time is a value of 20 seconds set by the user, and the generation rate indicates a quantity of particles generated by the particle generator in 20 seconds.

### 10. Set the Emission Velocity of the Particle (Setting Manner 2)

A representation form of the emission velocity of the particle is (x, y, z), and indicates initial velocities of the particle in different directions. The emission velocity includes at least one of the x-axis emission velocity, the y-axis emission velocity, and the z-axis emission velocity. When the emission velocity of the particle is set, ranges of the velocities in different directions may be set. For example, the range of the velocity in the x-axis direction is set to [−10, 20]. To be specific, the generated particle has a velocity with a maximum value of 10 and a minimum value of 0 in the negative X-axis direction, and has a velocity with a maximum value of 20 and a minimum value of 0 in the positive x-axis direction.

### 11. Set the Acceleration of the Particle (Setting Manner 2)

A representation form of the acceleration of the particle is (x, y, z), and indicates the acceleration of the particle of the particle generator, and the acceleration includes at least one of the x-axis acceleration, the y-axis acceleration, and the z-axis acceleration. The user can set accelerations in different directions.

When the x-axis acceleration of the particle is positive, the direction of the acceleration is a positive x-axis direction; when the x-axis acceleration of the particle is negative, the direction of the acceleration is a negative x-axis direction; when the y-axis acceleration of the particle is positive, the direction of the acceleration is a positive y-axis direction; when the y-axis acceleration of the particle is negative, the direction of the acceleration is a negative y-axis direction; when the z-axis acceleration of the particle is positive, the direction of the acceleration is a positive z-axis direction; and when the z-axis acceleration of the particle is negative, the direction of the acceleration is a negative z-axis direction.

### 12. Set the Rotation Parameter of the Particle (Setting Manner 2)

The rotation parameter may also be referred to as a rotation angle. The rotation parameter of the particle indicates an initial rotation angle of the particle. A user can set a random value of the initial rotation angle of the particle by specifying a maximum value and a minimum value of the rotation parameter.

The rotation angle is a rotation angle relative to a preset orientation of the particle. A value range of the rotation angle is [0, 360]. Alternatively, the value range of the rotation angle is [−180, 180]. For example, the value range of the rotation angle is [0, 360]. When the rotation angle of the particle is 120 degrees, the particle rotates by 120 degrees clockwise or anticlockwise relative to the preset orientation of the particle. Alternatively, the value range of the rotation angle is [−180, 180]. When the rotation angle of the particle is 120 degrees, the particle rotates by 120 degrees clockwise or anticlockwise relative to the preset orientation of the particle. When the rotation angle of the particles is −60 degrees, the particle rotates by 60 degrees anticlockwise or clockwise relative to the preset orientation of the particle.

### 13. Set the Rotation Velocity of the Particle (Setting Manner 2)

The rotation velocity may also be referred to as a rotation speed. The rotation velocity of the particle indicates an angular velocity of the particle. A user can set a random value of the angular velocity of the particle by specifying a maximum value and a minimum value of the rotation velocity.

### Add Signal Control to the Particle Generator

A user may add a control signal to the particle generator to control particle emission of the particle generator. As shown in FIG. 24, the user may set a control signal in an effect preset area 64 of a basic area 63. The control signal includes an automatic generation signal, a start signal, and a stop signal. Different signals respectively correspond to different controls. An autoplay control 65 corresponds to an automatic generation signal, and can only be set to start automatic generation or stop automatic generation. A start signal control 66 corresponds to a start signal, and a stop signal control 67 corresponds to a stop signal. The start signal indicates the particle generator to start generating particles. The stop signal indicates the particle generator to stop generating particles. For example, autoplay is disabled for the particle generator, and then a start signal is set for the particle generator, so that the particle generator generates a particle only when the start signal is triggered. Alternatively, autoplay is disabled for the particle generator, and a start signal and a stop signal are set for the particle generator, so that whether to generate a particle may be controlled by triggering the start signal and the stop signal of the particle generator. Alternatively, autoplay is disabled for the particle generator, and the stop signal is set for the particle generator, so that when the stop signal is triggered, particle generation is stopped.

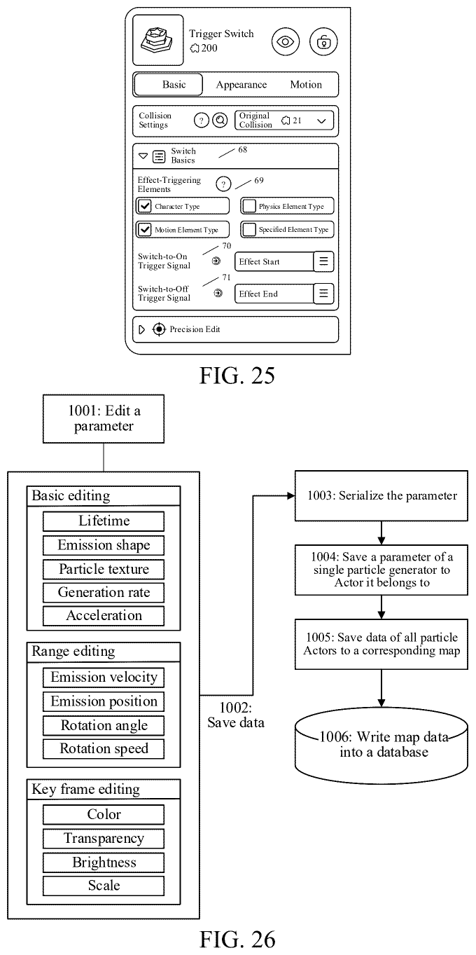

After the control signal is set, a corresponding signal trigger or signal trigger control needs to be set to trigger the control signal. For example, the signal trigger includes a trigger switch. A signal control area of the trigger switch is shown in FIG. 25. An element selection control 69, a switch-to-on trigger signal 70, and a switch-to-off trigger signal 71 are displayed in a switch basic area 68 of the trigger switch. For example, when the start signal control 66 and the switch-to-on trigger signal 70 are both set to “Effect Start” and the stop signal control 67 and the switch-to-off trigger signal 71 are both set to “Effect Stop”, a character type and a motion element type are selected using the element selection control 69. When an element of the character type or the motion element type triggers a sensing signal, the trigger switch is switched to an “on” state, and the corresponding particle generator starts generating particles. When the user designs a virtual environment using a UGC editor, the user can use an element provided by the UGC editor. The element includes at least one of various virtual objects pre-designed by a developer, virtual objects designed and saved by the user, basic elements for designing virtual objects, and virtual characters for interaction. The element may also be referred to as a component. The virtual object is, for example, a virtual tree or a virtual stone. The basic element is, for example, a cuboid, a cube, a ball, or a cylinder. The virtual character may be a virtual character manipulated by a player, may be a virtual character whose interaction logic is generated by a game program, or may be a virtual character without interaction logic. A virtual character that has no interaction logic may be considered as a virtual object. Elements that can trigger a trigger switch include a character type, a motion element type, a physics element type, and a specified element. The character type is a virtual character manipulated by a player, or a virtual character that exists in a virtual environment. The motion element type is an element for which a motion mode is set, and moves in a virtual environment based on motion logic corresponding to the motion mode after the motion mode is set for the element. The physics element type is an element added with a physical property. For example, gravity, flammability, or another physical property is added to the element. An effect in the real environment can be simulated in a virtual environment using the element of this type. For example, two spherical elements are simultaneously placed at a height in the virtual environment. One sphere is added with gravity, and the other sphere is not added with gravity. At the beginning of playing, the object that is added with gravity falls freely, and the object that is not added with gravity still floats in situ. The specified element is an element or an element type that is set by the user and that can trigger a trigger switch, for example, an element number that can trigger a trigger switch is added to the trigger switch.

### Add Motion Control to the Particle Generator

A user may set a motion unit mode for the particle generator, to control a motion manner of the particle generator.

The motion unit mode includes at least one of a full-range motion mode, a one-way displacement mode, a reciprocating displacement mode, a unidirectional rotation mode, an oscillatory motion mode, and a waypoint motion mode.

Different motion attributes may be set for different motion unit modes.

The waypoint motion mode indicates that a virtual object moves along a motion path formed by at least two waypoints. The positions, rotations, and scales of the at least two waypoints are the same or different, and each of the waypoints indicates at least one of a position, a rotation, and a scale of the virtual object when the virtual object moves to the waypoint. The one-way displacement mode indicates a single constant-speed motion on a straight line, and the mode stops after the motion ends. The user can set motion duration or the like of the single motion to control the single motion. The reciprocating displacement mode indicates a constant-speed reciprocating motion on the same straight line. The unidirectional rotation mode indicates that the virtual object performs a constant-speed rotation with the axis unchanged. The axis is the center of the virtual object. The oscillatory motion mode indicates rotational oscillation with the axis unchanged, for example, a pendulum. The full-range motion mode indicates a motion according to a motion logic. In the full-range motion mode, all motion behaviors can be implemented through setting, for example, at least one of the one-way displacement mode, reciprocating displacement mode, unidirectional rotation mode, and oscillatory motion mode. A variable motion may alternatively be set in the full-range motion mode.

In some embodiments, the particle generator includes at least one of a particle parameter editor, a particle signal manager, a particle parameter randomization manager, and a particle parameter key frame manager.

The particle parameter editor is configured to graphically edit an attribute parameter of a particle. The particle signal manager is configured to add a control signal to the particle generator. The particle parameter randomization manager is configured to make an attribute parameter value of the particle meet an attribute parameter interval set by the user. The particle parameter key frame manager is configured to support setting of an attribute parameter of a particle using a key frame, and make the attribute of the particle meet an attribute parameter requirement set for the key frame during particle generation.

In some embodiments, when the user sets a control signal for the particle generator, the particle signal manager is added to the particle generator, so that the particle generator can receive a corresponding control signal, and the particle generator is controlled using the control signal to be turned on or turned off.

In some embodiments, when no particle parameter randomization manager exists in the particle generator, the particle parameter randomization manager is added to the particle generator. When an attribute parameter interval corresponding to an attribute parameter T is modified, a corresponding maximum value Max<T> and a corresponding minimum value Min<T> are uploaded to the particle parameter randomization manager. The particle parameter randomization manager sets the maximum value Max<T> and the minimum value Min<T> for an attribute parameter variable corresponding to the attribute parameter T based on a type of the attribute parameter T.

In some embodiments, when no particle parameter randomization manager exists in the particle generator, the particle parameter key frame manager is added to the particle generator. A key frame K includes a key frame moment T and an attribute parameter value V. All key frames of each attribute parameter are stored in a key frame array Array<K>, and the array is arranged in an ascending order of time. When an attribute parameter corresponding to a moment RT needs to be obtained, a previous key frame K0 and a next key frame K1 that correspond to the moment RT are found in the key frame array Array <K> using the moment RT. Search efficiency may be optimized using search methods such as a dichotomic search method and an interpolation search method during a search. After the previous key frame K0 and the next key frame K1 are found, an attribute parameter value corresponding to RT are obtained through interpolation. An interpolation formula is shown below.

$$RV = K 0. V + ( K 1. V - K 0. V ) * ( ( RT - K 0. T ) / ( K 1. T - K 0. T ) )$$

RV represents the attribute parameter value corresponding to the moment RT. K0.V represents an attribute parameter value corresponding to the previous key frame K0. K1.V indicates an attribute parameter value corresponding to the next key frame K1. RT represents a given moment. K0.T represents a key frame moment corresponding to the previous key frame K0. K1.T represents a key frame moment corresponding to the next key frame K1.

FIG. 26 is a flowchart of a UGC effect generation method in a game program according to an embodiment of this disclosure. This method is performed by a computer device. The computer device may be the terminal device or server in FIG. 1 or FIG. 2. The method includes the following operations.

### Operation 1001: Edit a Parameter.

In some embodiments, a user edits an attribute parameter of a particle generator using the foregoing method. According to different editing methods, the editing a parameter includes basic editing, range editing, and key frame editing. The basic editing corresponds to the foregoing Setting Manner 1, and the attribute parameter is directly set. The range editing corresponds to the foregoing Setting Manner 2, and the attribute parameter is set based on an attribute parameter interval. The key frame editing corresponds to the foregoing Setting Manner 1, and the attribute parameter is set based on a key frame.

### Operation 1002: Save Data.

In some embodiments, in response to a save operation performed by the user on the attribute parameter, the attribute parameter is saved. Alternatively, in response to a save operation performed by the user on map data, the map data and the attribute parameter of the particle generator on the map are saved.

### Operation 1003: Serialize the Parameter.

In some embodiments, the computer device serializes the saved parameter. For example, the terminal device serializes the saved attribute parameter. Alternatively, the terminal device extracts the attribute parameter of the particle generator saved in the map data, and serializes the attribute parameter.

Operation 1004: Save a Parameter of a Single Particle Generator to Actor it Belongs To.

In some embodiments, the attribute parameter of each particle generator is saved to corresponding Actor. Actor is a basic type of a game object in a game engine, and any virtual object that can be added to a virtual environment needs to inherit from the Actor class. The Actor class is a base class of all virtual objects that can be added to a virtual environment.

### Operation 1005: Save Data of all Particle Actors to a Corresponding Map.

In some embodiments, data of all particle Actors is saved to a map corresponding to the particle generator. Particle Actor indicates Actor corresponding to each particle generator, and Actor stores the attribute parameter of the particle generator.

Operation 1006: Write Map Data into a Database.

In some embodiments, a server writes map data into a database, and the map data is uploaded by the terminal device. For example, the map data includes a map corresponding to the particle generator, and the map stores each particle generator added to the map and the attribute parameter of each particle generator.

In summary, the method provided in the embodiments of this disclosure shows an effect that when map data is saved, a particle generator and an attribute parameter corresponding to the particle generator are also saved along with the map data, so that the particle generator and the attribute parameter corresponding to the particle generator can also be saved during subsequent editing or playing.

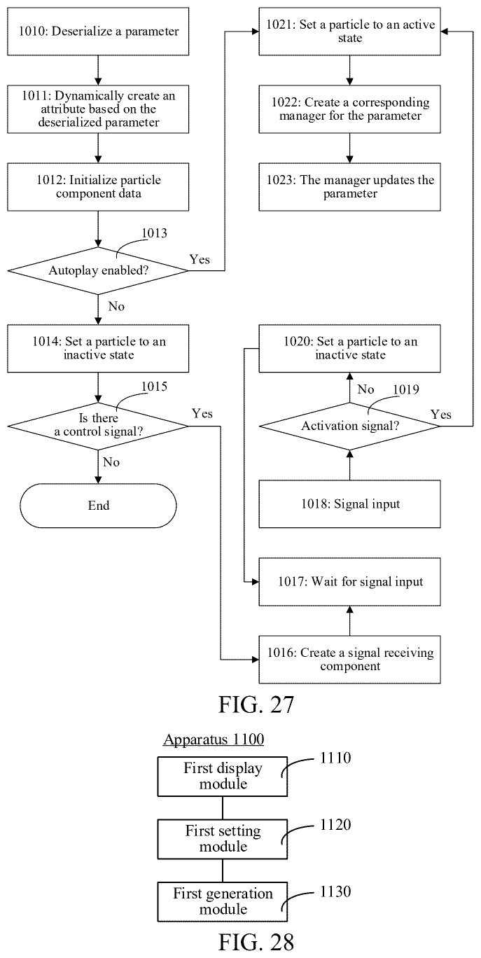

FIG. 27 is a flowchart of a UGC effect generation method in a game program according to an embodiment of this disclosure. This method is performed by a terminal device. The terminal device may be the terminal device in FIG. 1 or FIG. 2. The method includes the following operations.

### Operation 1010: Deserialize a Parameter.

In some embodiments, the terminal device receives map data transmitted by a server, extracts a map corresponding to a particle generator from the map data, extracts the particle generator in the map and an attribute parameter corresponding to the particle generator one by one, and deserializes the attribute parameter to obtain a deserialized attribute parameter.

### Operation 1011: Dynamically Create an Attribute Based on the Deserialized Parameter.

In some embodiments, the terminal device dynamically creates an instance of the particle generator based on the deserialized parameter, i.e., instantiates the particle generator.

### Operation 1012: Initialize Particle Component Data.

In some embodiments, the particle generator performs initialization based on the attribute parameter to obtain an attribute parameter value or an attribute parameter interval of each attribute parameter.

### Operation 1013: Determine Whether Autoplay is Enabled.

In some embodiments, it is determined whether an automatic generation signal is set for the particle generator, and if yes, Operation 1021 is performed, or if not, Operation 1014 is performed.

### Operation 1014: Set a Particle to an Inactive State.

In some embodiments, an automatic generation signal is not set for the particle generator, i.e., autoplay is disabled, and the particle generator is set to an inactive state.

Operation 1015: Determine Whether there is a Control Signal.

In some embodiments, it is determined whether there is a control signal, and if a control signal exists, Operation 1016 is performed. If no control signal exists, it indicates that the particle generator does not support autoplay, and cannot generate a particle based on the control signal. The particle generator is invalid, and calculation for the particle generator is ended.

### Operation 1016: Create a Signal Receiving Component.

In some embodiments, when a control signal exists, a signal receiving component is created, and the signal receiving component is configured to receive signal input.

### Operation 1017: Wait for Signal Input.

In some embodiments, the process waits for signal input, and when signal input is received, Operation 1018 is performed, or otherwise the process keeps waiting for signal input until the particle generator is deleted.

### Operation 1018: Signal Input.

### Operation 1019: Determine Whether an Inputted Signal is a Start Signal.

In some embodiments, it is determined whether an inputted signal is a start signal, and if yes, Operation 1021 is performed, or if not, Operation 1020 is performed.

### Operation 1020: Set a Particle to an Inactive State.

In some embodiments, the particle generator is kept in an inactive state.

### Operation 1021: Set a Particle to an Active State.

In some embodiments, the particle generator is set to an active state, i.e., starts generating a particle.

### Operation 1022: Create a Corresponding Manager for the Parameter.

In some embodiments, corresponding managers are created based on different attribute parameters.

### Operation 1023: The Manager Updates the Parameter.

In some embodiments, the attribute parameter value of the particle generated by the particle generator is updated based on a manager Tick.

In summary, the method provided in the embodiments of this disclosure shows a method in which a terminal device obtains a particle generator based on previously saved data during editing of a virtual environment or playing in a virtual environment, and manages the particle generator during running of a game program. The method ensures implementation of the particle generator and implementation of a signal control function.

Apparatus embodiments of this disclosure are provided below, and may be configured to perform the method embodiment of this disclosure. For details not disclosed in the apparatus embodiments of this disclosure, refer to the method embodiments of this disclosure.

FIG. 28 is a structural block diagram of a UGC effect generation apparatus in a game program according to an embodiment of this disclosure. The apparatus has a function of implementing the foregoing example of the UGC effect generation method in a game program. The function may be implemented by hardware, or may be implemented by hardware by executing corresponding software. As shown in FIG. 26, the apparatus 1100 may include a first display module 1110, a first setting module 1120, and a first generation module 1130.

The first display module 1110 is configured to display a particle generator on an editor interface of the UGC editor.

The first setting module 1120 is configured to receive, in response to an attribute setting operation on the particle generator, an attribute parameter set for the particle generator.

The first generation module 1130 is configured to generate, in response to a trigger operation on the particle generator, a particle effect based on the attribute parameter, the particle effect including at least one particle generated by the particle generator.

In some embodiments, the first setting module 1120 includes a first display submodule and a first determination submodule.

The first display submodule is configured to display at least two key frame controls on the editor interface in response to the attribute setting operation on the particle generator.

The first determination submodule is configured to determine, in response to a trigger operation on an i^{th} key frame control of the at least two key frame controls, that an attribute parameter of the particle at an i^{th} key frame moment is an attribute parameter corresponding to the i^{th} key frame control.

In some embodiments, the first display submodule includes a first display unit, and the first determination submodule includes a first determination unit.

The first display unit is configured to display at least two color key frame controls and a particle color selection operation control on the editor interface in response to a trigger operation on a color setting entry of the particle generator.

The first determination unit is configured to determine, in response to a trigger operation on the particle color selection operation control when an i^{th} color key frame control of the at least two color key frame controls is in a selected state, that the attribute parameter of the particle at the i^{th} key frame moment is a color parameter selected by the particle color selection operation control.

In some embodiments, the first display submodule includes a second display unit, and the first determination submodule includes a second determination unit.

The second display unit is configured to display, in response to a trigger operation on an attribute setting entry of the particle generator, an attribute coordinate system and at least two key frame controls located in the attribute coordinate system on the editor interface, a first coordinate axis of the attribute coordinate system indicating the cycle period, and a second coordinate axis of the attribute coordinate system indicating the attribute parameter.

The second determination unit is configured to determine, in response to a drag operation on the i^{th} key frame control when the i^{th} key frame control of the at least two key frame controls is in a selected state, that the attribute parameter of the particle at the i^{th} key frame moment is an attribute parameter corresponding to the i^{th} key frame control in the attribute coordinate system.

In some embodiments, the second display unit includes a third display unit, and the second determination unit includes a third determination unit.

The third display unit is configured to display, in response to a trigger operation on a scale setting entry of the particle generator, a scale coordinate system and at least two scale key frame controls located in the scale coordinate system on the editor interface, a first coordinate axis of the scale coordinate system indicating the cycle period, and a second coordinate axis of the scale coordinate system indicating the scale parameter.

The third determination unit is configured to determine, in response to a drag operation on an i^{th} scale key frame control of the at least two scale key frame controls when the i^{th} scale key frame control is in a selected state, that the attribute parameter of the particle at the i^{th} key frame moment is a scale parameter corresponding to the i^{th} scale key frame control in the scale coordinate system.

In some embodiments, the second display unit includes a fourth display unit, and the second determination unit includes a fourth determination unit.

The fourth display unit is configured to display, in response to a trigger operation on a transparency setting entry of the particle generator, a transparency coordinate system and at least two transparency key frame controls located in the transparency coordinate system on the editor interface, a first coordinate axis of the transparency coordinate system indicating the cycle period, and a second coordinate axis of the transparency coordinate system indicating the transparency parameter.

The fourth determination unit is configured to determine, in response to a drag operation on an i^{th} transparency key frame control of the at least two transparency key frame controls when the i^{th} transparency key frame control is in a selected state, that the attribute parameter of the particle at the i^{th} key frame moment is a transparency parameter corresponding to the i^{th} transparency key frame control in the transparency coordinate system.

In some embodiments, the second display unit includes a fifth display unit, and the second determination unit includes a fifth determination unit.

The fifth display unit is configured to display, in response to a trigger operation on a brightness setting entry of the particle generator, a brightness coordinate system and at least two brightness key frame controls located in the brightness coordinate system on the editor interface, a first coordinate axis of the brightness coordinate system indicating the cycle period, and a second coordinate axis of the brightness coordinate system indicating the brightness parameter.

The fifth determination unit is configured to determine, in response to a drag operation on an i^{th} brightness key frame control of the at least two brightness key frame controls when the i^{th} brightness key frame control is in a selected state, that the attribute parameter of the particle at the i^{th} key frame moment is a brightness parameter corresponding to the i^{th} brightness key frame control in the brightness coordinate system.

In some embodiments, the apparatus 1100 further includes a key frame addition module.

The key frame addition module is configured to: when the i^{th} key frame control is in a selected state, if the attribute parameter corresponds to n key frame controls, insert a new key frame control between the i^{th} key frame control and an (i+1)^{th} key frame control in response to a key frame addition operation to obtain n+1 key frame controls corresponding to the attribute parameter, n being a positive integer.

In some embodiments, the apparatus 1100 further includes a key frame deletion module.

The key frame deletion module is configured to: when the i^{th} key frame control is in a selected state, delete the i^{th} key frame control in response to a key frame deletion operation, where i is a positive integer.

In some embodiments, the first setting module 1120 includes a second determination submodule.

The second determination submodule is configured to determine an attribute parameter interval in response to the attribute setting operation on the particle generator, the attribute parameter interval indicating a parameter range of the attribute parameter of the particle generated by the particle generator.

In some embodiments, the apparatus 1100 further includes a second display module, and the second determination submodule further includes at least one of a first maximum value unit and a first minimum value unit.

The second display module is configured to display at least one of a maximum value setting control or a minimum value setting control on the editor interface.

The first maximum value unit is configured to determine a maximum value of the parameter range in response to an attribute setting operation on the maximum value setting control.

The first minimum value unit is configured to determine a minimum value of the parameter range in response to an attribute setting operation on the minimum value setting control.

In some embodiments, the first maximum value unit includes at least one of a second maximum value unit, a third maximum value unit, and a fourth maximum value unit. The first minimum value unit includes at least one of a second minimum value unit, a third minimum value unit, and a fourth minimum value unit.

The second maximum value unit is configured to determine a maximum value of an x-axis emission velocity range of the particle in response to an attribute setting operation on the x-axis emission velocity maximum value setting control.

The third maximum value unit is configured to determine a maximum value of a y-axis emission velocity range of the particle in response to an attribute setting operation on the y-axis emission velocity maximum value setting control.

The fourth maximum value unit is configured to determine a maximum value of a z-axis emission velocity range of the particle in response to an attribute setting operation on the z-axis emission velocity maximum value setting control.

The second minimum value unit is configured to determine a minimum value of the x-axis emission velocity range of the particle in response to an attribute setting operation on the x-axis emission velocity minimum value setting control.

The third minimum value unit is configured to determine a minimum value of the y-axis emission velocity range of the particle in response to an attribute setting operation on the y-axis emission velocity minimum value setting control.

The fourth minimum value unit is configured to determine a minimum value of the z-axis emission velocity range of the particle in response to an attribute setting operation on the z-axis emission velocity minimum value setting control.

In some embodiments, the second determination submodule further includes a sixth determination unit.

The sixth determination unit is configured to determine an emission position interval of the particle in response to a trigger operation on an emission position control, the emission position interval indicating a parameter range of the emission position of the particle generated by the particle generator.

In some embodiments, the apparatus 1100 further includes a sixth display unit.

The sixth display unit is configured to display an emission position control on the editor interface in response to a trigger operation on an emission position setting entry of the particle generator, the emission position control including at least one of a spherical parameter control, a triangular parameter control, a cylindrical parameter control, and a user-defined parameter control.

In some embodiments, the sixth determination unit further includes a seventh determination unit and an eighth determination unit.

The seventh determination unit is configured to determine a target radius in response to a setting operation on the radius setting control.

The eighth determination unit is configured to determine the emission position interval of the particle as a first spatial range based on the target radius, the first spatial range including a spherical surface of a sphere and a spatial coordinate interval inside the sphere, and the sphere with the target radius as a spherical radius.

In some embodiments, the sixth determination unit further includes at least one of a ninth determination unit and a tenth determination unit, and the sixth determination unit further includes an eleventh determination unit.

The ninth determination unit is configured to determine a first side length in response to a setting operation on the side length setting control.

The tenth determination unit is configured to determine a first prism height in response to a setting operation on the triangular prism height setting control.

The eleventh determination unit is configured to determine the emission position interval of the particle as a second spatial range based on at least one of the first side length and the first prism height, the second spatial range including a triangular prism surface of a triangular prism and a spatial coordinate interval inside the triangular prism, and the triangular prism being determined based on at least one of the first side length and the first prism height.

In some embodiments, the sixth determination unit further includes at least one of a twelfth determination unit and a thirteenth determination unit, and the sixth determination unit further includes a fourteenth determination unit.

The twelfth determination unit is configured to determine a cylinder radius in response to a setting operation on the cylinder radius setting control.

The thirteenth determination unit is configured to determine a cylinder height in response to a setting operation on the cylinder height setting control.

The fourteenth determination unit is configured to determine the emission position interval of the particle as a third spatial range based on at least one of the cylinder radius and the cylinder height, the third spatial range including a cylindrical surface of a cylinder and a spatial coordinate interval inside the cylinder, and the cylinder being determined based on at least one of the cylinder radius and the cylinder height.

In some embodiments, the sixth determination unit includes at least one of a fifteenth determination unit, a sixteenth determination unit, a seventeenth determination unit, an eighteenth determination unit, a nineteenth determination unit, and a twentieth determination unit.

The fifteenth determination unit is configured to determine a maximum value of the particle in an x-axis position range in response to an attribute setting operation on the x-axis maximum value setting control.

The sixteenth determination unit is configured to determine a minimum value of the particle in the x-axis position range in response to an attribute setting operation on the x-axis minimum value setting control.

The seventeenth determination unit is configured to determine a maximum value of the particle in a y-axis position range in response to an attribute setting operation on the y-axis maximum value setting control.

The eighteenth determination unit is configured to determine a minimum value of the particle in the y-axis position range in response to an attribute setting operation on the y-axis minimum value setting control.

The nineteenth determination unit is configured to determine a maximum value of the particle in a z-axis position range in response to an attribute setting operation on the z-axis maximum value setting control.

The twentieth determination unit is configured to determine a minimum value of the particle in the z-axis position range in response to an attribute setting operation on the z-axis minimum value setting control.

In some embodiments, the first maximum value unit further includes a fifth maximum value unit, and the first minimum value unit further includes a fifth minimum value unit.

The second display module is further configured to display at least one of a rotation angle maximum value setting control and a rotation angle minimum value setting control on the editor interface.

The fifth maximum value unit is configured to determine a maximum value of a rotation angle range of the particle in response to an attribute setting operation on the rotation angle maximum value setting control.

The fifth minimum value unit is configured to determine a minimum value of the rotation angle range of the particle in response to an attribute setting operation on the rotation angle minimum value setting control.

In some embodiments, the first maximum value unit further includes a sixth maximum value unit, and the first minimum value unit further includes a sixth minimum value unit.

The second display module is further configured to display at least one of a rotation speed maximum value setting control or a rotation speed minimum value setting control on the editor interface.

The sixth maximum value unit is configured to determine a maximum value of a rotation speed range of the particle in response to an attribute setting operation on the rotation speed maximum value setting control.

The sixth minimum value unit is configured to determine a minimum value of the rotation speed range of the particle in response to an attribute setting operation on the rotation speed minimum value setting control.

In some embodiments, the first setting module 1120 further includes a third determination submodule.

The third determination submodule is configured to determine an attribute parameter value of the particle in response to the attribute setting operation on the particle generator.

In some embodiments, the apparatus 1100 further includes a third display module, and the third determination submodule includes a twenty-first determination unit.

The third display module is configured to display a cycle period setting control on the editor interface.

The twenty-first determination unit is configured to determine a cycle period value of the particle in response to an attribute setting operation on the cycle period setting control.

In some embodiments, the third determination submodule includes at least one of a twenty-second determination unit, a twenty-third determination unit, and a twenty-fourth determination unit.

The third display module is further configured to display the emission position control on the editor interface in response to the trigger operation on the emission position setting entry of the particle generator, the emission position control including at least one of the spherical parameter control, the triangular parameter control, and the cylindrical parameter control.

The twenty-second determination unit is configured to determine, in response to a selection operation on the spherical parameter control if the emission position control includes the spherical parameter control, that the emission position interval of the particle is a fourth spatial range, the fourth spatial range including a spherical surface of a sphere and a spatial coordinate interval inside the sphere, and the sphere with a first radius as a spherical radius.

The twenty-third determination unit is configured to determine, in response to a selection operation on the triangular parameter control if the emission position control includes the triangular parameter control, that the emission position interval of the particle is a fifth spatial range, the fifth spatial range including a triangular prism surface of a triangular prism and a spatial coordinate interval inside the triangular prism, the triangular prism being a triangular prism with a second side length as a side length of an equilateral triangle and a second prism height as a height.

The twenty-fourth determination unit is configured to determine, in response to a selection operation on the cylindrical parameter control if the emission position control includes the cylindrical parameter control, that the emission position interval of the particle is a sixth spatial range, the sixth spatial range including a cylindrical surface of a cylinder and a spatial coordinate interval inside the cylinder, and the cylinder being a cylinder with a second radius as a bottom radius and a third prism height as a height.

In some embodiments, the third determination submodule includes a twenty-fifth determination unit.

The third display module is further configured to display a particle texture selection area on the editor interface, the particle texture selection area including at least one particle texture control, and different particle texture controls corresponding to different particle textures.

The twenty-fifth determination unit is configured to determine the particle texture of the particle in response to a selection operation on the particle texture control.

In some embodiments, the apparatus 1100 further includes a change module.

The change module is configured to change, in response to a trigger operation on the particle texture selection area, the at least one particle texture control displayed in the particle texture selection area.

In some embodiments, the third determination submodule includes a twenty-sixth determination unit.

The third display module is further configured to display a generation rate setting control on the editor interface.

The twenty-sixth determination unit is configured to determine the generation rate of the particle in response to an attribute setting operation on the generation rate setting control.

In some embodiments, the third determination submodule includes at least one of a twenty-seventh determination unit, a twenty-eighth determination unit, and a twenty-ninth determination unit.

The third display module is further configured to display at least one of an x-axis acceleration setting control, a y-axis acceleration setting control, and a z-axis acceleration setting control on the editor interface.

The twenty-seventh determination unit is configured to determine an x-axis acceleration value of the particle in response to an attribute setting operation on the x-axis acceleration setting control.

The twenty-eighth determination unit is configured to determine a y-axis acceleration value of the particle in response to an attribute setting operation on the y-axis acceleration setting control.

The twenty-ninth determination unit is configured to determine a z-axis acceleration value of the particle in response to an attribute setting operation on the z-axis acceleration setting control.

In some embodiments, the first generation module includes a first generation submodule.

The first generation submodule is configured to display, in the preview area in response to an attribute confirmation operation on the particle generator in the editing area, the particle effect generated by the particle generator based on the attribute parameter.

In some embodiments, the first generation submodule includes a first generation unit.

The first generation unit is configured to display, in the preview area in response to a color parameter confirmation operation on the particle generator in the editing area, the particle effect generated by the particle generator based on the color parameter, the color parameter including at least two color key frame controls, different color key frame controls corresponding to the same or different color values, and the particle effect including an animation in which the color of the particle changes gradually or abruptly between color values corresponding to the at least two color key frame controls.

In some embodiments, the first generation submodule further includes a second generation unit.

The second generation unit is configured to display, in the preview area in response to a scale parameter confirmation operation on the particle generator in the editing area, the particle effect generated by the particle generator based on the scale parameter, the scale parameter including at least two scale key frame controls, different scale key frame controls corresponding to the same or different scale parameter values, and the particle effect including an animation in which the scaling factor of the particle changes gradually or abruptly between scale parameter values corresponding to the at least two scale key frame controls.

In some embodiments, the first generation submodule further includes a third generation unit.

The third generation unit is configured to display, in the preview area in response to a transparency parameter confirmation operation on the particle generator in the editing area, the particle effect generated by the particle generator based on the transparency parameter, the transparency parameter including at least two transparency key frame controls, different transparency key frame controls corresponding to the same or different transparency parameter values, and the particle effect including an animation in which the transparency level of the particle changes gradually or abruptly between transparency parameter values corresponding to the at least two transparency key frame controls.

In some embodiments, the first generation submodule further includes a fourth generation unit.

The fourth generation unit is configured to display, in the preview area in response to a brightness parameter confirmation operation on the particle generator in the editing area, the particle effect generated by the particle generator based on the brightness parameter, the brightness parameter including at least two brightness key frame controls, different brightness key frame controls corresponding to the same or different brightness parameter values, and the particle effect including an animation in which the brightness level of the particle changes gradually or abruptly between brightness parameter values corresponding to the at least two brightness key frame controls.

In some embodiments, the first generation submodule further includes at least one of a fifth generation unit, a sixth generation unit, and a seventh generation unit.

The fifth generation unit is configured to display, in the preview area in response to an x-axis emission velocity confirmation operation on the particle generator in the editing area, the particle effect generated by the particle generator based on the x-axis emission velocity, the x-axis emission velocity including at least one of an x-axis emission velocity maximum value and an x-axis emission velocity minimum value, the particle effect including that an initial emission velocity of the particle in an x-axis direction is a random value within an x-axis emission velocity interval, and the x-axis emission velocity interval being determined based on at least one of the x-axis emission velocity minimum value and the x-axis emission velocity maximum value.

The sixth generation unit is configured to display, in the preview area in response to a y-axis emission velocity confirmation operation on the particle generator in the editing area, the particle effect generated by the particle generator based on the y-axis emission velocity, the y-axis emission velocity including at least one of a y-axis emission velocity maximum value and a y-axis emission velocity minimum value, the particle effect including that an initial emission velocity of the particle in a y-axis direction is a random value within a y-axis emission velocity interval, and the y-axis emission velocity interval being determined based on at least one of the y-axis emission velocity minimum value and the y-axis emission velocity maximum value.

The seventh generation unit is configured to display, in the preview area in response to a z-axis emission velocity confirmation operation on the particle generator in the editing area, the particle effect generated by the particle generator based on the z-axis emission velocity, the z-axis emission velocity including at least one of a z-axis emission velocity maximum value and a z-axis emission velocity minimum value, the particle effect including that an initial emission velocity of the particle in a z-axis direction is a random value within a z-axis emission velocity interval, and the z-axis emission velocity interval being determined based on at least one of the z-axis emission velocity minimum value and the z-axis emission velocity maximum value.

In some embodiments, the first generation submodule further includes an eighth generation unit.

The eighth generation unit is configured to display, in the preview area in response to an emission position confirmation operation on the particle generator in the editing area, the particle effect generated by the particle generator based on the emission position, the emission position including at least one of a spherical emission position, a triangular emission position, a cylindrical emission position, and a user-defined emission position, different emission positions corresponding to different emission position intervals, and the particle effect including that the particle is located in the emission position interval.

In some embodiments, the first generation submodule further includes a ninth generation unit.

The ninth generation unit is configured to display, in the preview area in response to a rotation angle confirmation operation on the particle generator in the editing area, the particle effect generated by the particle generator based on the rotation angle, the rotation angle including at least one of a rotation angle maximum value and a rotation angle minimum value.

The particle effect includes that the rotation angle of the particle is a random value within a rotation angle interval, and the rotation angle interval is determined based on at least one of the rotation angle minimum value and the rotation angle maximum value.

In some embodiments, the first generation submodule further includes a tenth generation unit.

The tenth generation unit is configured to display, in the preview area in response to a rotation speed confirmation operation on the particle generator in the editing area, the particle effect generated by the particle generator based on the rotation speed, the rotation speed including at least one of a rotation speed maximum value and a rotation speed minimum value.

The particle effect includes that the rotation speed of the particle is a random value within a rotation speed interval, and the rotation speed interval is determined based on at least one of the rotation speed minimum value and the rotation speed maximum value.

In some embodiments, the first generation submodule further includes an eleventh generation unit.

The eleventh generation unit is configured to display, in the preview area in response to a cycle period confirmation operation on the particle generator in the editing area, the particle effect generated by the particle generator based on the cycle period.

In some embodiments, the first generation submodule further includes a twelfth generation unit.

The twelfth generation unit is configured to display, in the preview area in response to a particle texture confirmation operation on the particle generator in the editing area, the particle effect generated by the particle generator based on the particle texture.

In some embodiments, the first generation submodule further includes a thirteenth generation unit.

The thirteenth generation unit is configured to display, in the preview area in response to a generation rate confirmation operation on the particle generator in the editing area, the particle effect generated by the particle generator based on the generation rate, the particle effect including a first quantity of particles generated by the particle generator in the second unit time, and the generation rate being positively correlated to the first quantity.

In some embodiments, the first generation submodule further includes at least one of a fourteenth generation unit, a fifteenth generation unit, and a sixteenth generation unit.

The fourteenth generation unit is configured to display, in the preview area in response to an x-axis acceleration confirmation operation on the particle generator in the editing area, the particle effect generated by the particle generator based on the x-axis acceleration.

The fifteenth generation unit is configured to display, in the preview area in response to a y-axis acceleration confirmation operation on the particle generator in the editing area, the particle effect generated by the particle generator based on the y-axis acceleration.

The sixteenth generation unit is configured to display, in the preview area in response to a z-axis acceleration confirmation operation on the particle generator in the editing area, the particle effect generated by the particle generator based on the z-axis acceleration.

In some embodiments, the apparatus 1100 further includes a second setting module.

The second setting module is configured to receive, in response to a base color setting operation on the particle generator, a base color set for the particle generator, a base of the particle generator indicating at least one of a position and an angle of the particle generator in a virtual environment on the editor interface.

In some embodiments, the apparatus 1100 further includes a fourth display module, and the second setting module includes at least one of a fourth determination submodule and a fifth determination submodule.

The fourth display module is configured to display at least one of a base bottom color control, a base top color control, a base color selection tab, and a base color selection operation control on the editor interface in response to a trigger operation on a base color setting entry of the particle generator.

The fourth determination submodule is configured to determine, in response to a trigger operation on the base color selection operation control when the base bottom color control is in a selected state, that a base bottom color of the particle generator is a color value selected from the base color selection operation control.

The fifth determination submodule is configured to determine, in response to a trigger operation on a second color selection operation control when the base top color control is in a selected state, that a base top color of the particle generator is a color value selected from the base color selection operation control.

The base color selection tab indicates a color selection mode; the base color selection tab includes at least one of a color palette tab, a color picker tab, and a history tab; different base color selection tabs correspond to different base color selection operation controls; the color palette tab corresponds to a color palette color selection control; the color picker tab corresponds to a color picker color selection control; the history tab corresponds to a history color selection control; and the base color selection operation control is configured to select a color from the at least one candidate color.

In some embodiments, the apparatus 1100 further includes a fourth display module.

The fourth display module is configured to display the set base color of the particle generator in the preview area in response to a base color confirmation operation on the particle editor in the editing area, the base color including a gradient that transitions from the base bottom color to the base top color from bottom to top, or a gradient that transitions from the base top color to the base bottom color from top to bottom.

In some embodiments, the apparatus 1100 further includes at least one of a first selection module and a second selection module.

The first selection module is configured to: set the particle generator to a selected state in response to a selection operation on the particle generator, and add an indicator box to the particle generator, the indicator box indicating the selected state.

The second selection module is configured to keep the particle generator in the selected state and hide the indicator box in response to an editing operation on the particle generator.

In some embodiments, the apparatus 1100 further includes a signal setting module.

The signal setting module is configured to receive, in response to a setting operation on a trigger signal of the particle generator, a trigger signal set for the particle generator.

The trigger signal includes at least one of an automatic generation signal, a start signal, and a stop signal; the automatic generation signal indicates the particle generator to automatically generate the particle; and the start signal indicates the particle generator to start generating the particle based on the start signal; and the stop signal indicates the particle generator to stop generating the particle based on the stop signal.

In some embodiments, the apparatus 1100 further includes a first control module and a second control module.

The first control module is configured to: set, in the virtual environment, a signal trigger for the particle generator, and control, in response to the signal trigger receiving a first trigger signal, the particle generator to generate the particle.

The second control module is configured to: display a signal trigger control on the editor interface, and in response to the signal trigger control receiving a second trigger signal, control the particle generator to generate the particle.

In some embodiments, the apparatus 1100 further includes a motion setting module.

The motion setting module is configured to set a motion mode for the particle generator in response to a motion control operation on the particle generator.

The motion mode of the particle generator includes one of a full-range motion mode, a one-way displacement mode, a reciprocating displacement mode, a unidirectional rotation mode, an oscillatory motion mode, and a waypoint motion mode.

When the apparatus provided in the foregoing embodiments implements the functions of the apparatus, division of the foregoing functional modules is only used as an example for description. During actual application, the foregoing functions may be allocated to different functional modules for implementation as required, to be specific, an inner structure of a device is divided into different functional modules, to implement all or some of the functions described above. In addition, the apparatuses provided in the foregoing embodiments and the method embodiments belong to the same concept. For specific implementation processes thereof, refer to the method embodiments. Details are not described herein again.

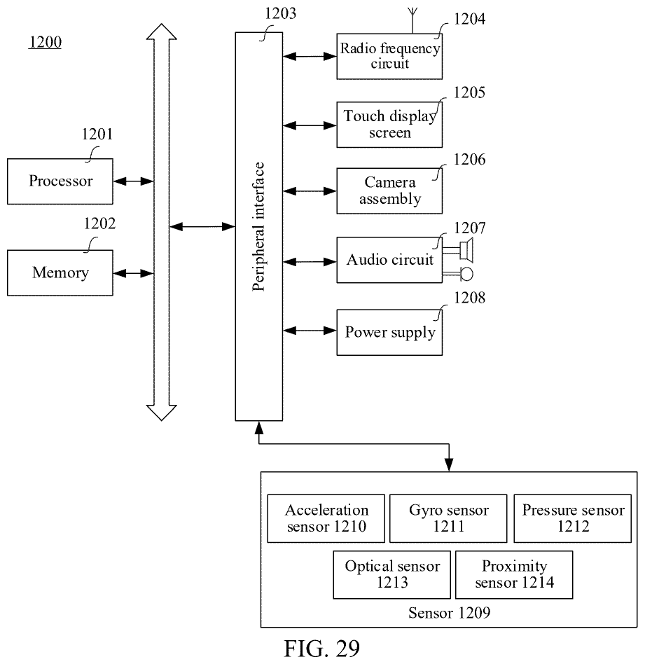

FIG. 29 is a structural block diagram of a computer device according to an embodiment of this disclosure.

The computer device 1200 may be a portable mobile terminal, also referred to as a mobile terminal in this embodiment. Examples include: smartphones, tablet computers, Moving Picture Experts Group Audio Layer III (MP3) players, and Moving Picture Experts Group Audio Layer IV (MP4) players. The computer device 1200 may also be referred to by other names such as user equipment or portable terminals.

In some examples, the computer device 1200 includes processing circuitry (e.g., a processor 1201) and a memory 1202.

The processor 1201 may include one or more processing cores, for example, a 4-core processor or an 8-core processor. The processor 1201 may be implemented in at least one hardware form of a digital signal processor (DSP), a field-programmable gate array (FPGA), and a programmable logic array (PLA). The processor 1201 may alternatively include a main processor and a coprocessor. The main processor is a processor for processing data in an awake state, also referred to as a central processing unit (CPU). The coprocessor is a low-power processor for processing data in a standby state. In some embodiments, the processor 1201 may be integrated with a graphics processing unit (GPU). The GPU is responsible for rendering and drawing content that needs to be displayed on a display screen. In some embodiments, the processor 1201 may alternatively include an artificial intelligence (AI) processor. The AI processor is configured to process computational operations related to machine learning.

The memory 1202 may include one or more computer-readable storage media. The computer-readable storage medium may be tangible and non-transitory. The memory 1202 may further include a high-speed random access memory and a non-volatile memory, for example, one or more disk storage devices and flash storage devices. In some embodiments, the non-transitory computer-readable storage medium in the memory 1202 is configured to store at least one instruction. The at least one instruction is executable by the processor 1201 to implement the UGC effect generation method in a game program provided in the embodiments of this disclosure.

In some embodiments, the computer device 1200 may further include a peripheral interface 1203 and at least one peripheral. Specifically, the peripheral includes at least one of a radio frequency circuit 1204, a touch display screen 1205, a camera 1206, an audio circuit 1207, and a power supply 1208.

The peripheral interface 1203 may be used to connect at least one input/output (I/O)-related peripheral to the processor 1201 and the memory 1202. In some embodiments, the processor 1201, the memory 1202, and the peripheral interface 1203 are integrated on the same chip or circuit board. In some other embodiments, any one or two of the processor 1201, the memory 1202, and the peripheral interface 1203 may be implemented on separate chips or circuit boards. This is not limited in the embodiments.

The radio frequency circuit 1204 is configured to transmit and receive radio frequency (RF) signals, also referred to as electromagnetic signals. The radio frequency circuit 1204 communicates with communication networks and other communication devices via electromagnetic signals. The radio frequency circuit 1204 converts electrical signals into electromagnetic signals for transmission, or converts received electromagnetic signals into electrical signals. For example, the radio frequency circuit 1204 includes an antenna system, an RF transceiver, one or more amplifiers, a tuner, an oscillator, a digital signal processor, a codec chipset, a subscriber identity module card, and the like. The radio frequency circuit 1204 may communicate with other terminals using at least one wireless communication protocol. The wireless communication protocol includes, but is not limited to, the World Wide Web, metropolitan area networks, intranets, various generations of mobile communication networks (2G, 3G, 4G, and 5G), wireless local area networks, and/or Wi-Fi networks. In some embodiments, the radio frequency 1204 may further include circuitry related to Near Field Communication (NFC). This is not limited in this disclosure.

The touch display screen 1205 is configured to display a User Interface (UI). The UI may include a graphic, a text, an icon, a video, and any combination thereof. The touch display screen 1205 further has a capability of acquiring a touch signal on or above a surface of the touch display screen 1205. The touch signal may be inputted to the processor 1201 as a control signal for processing. The touch display screen 1205 is configured to provide a virtual button and/or a virtual keyboard that are/is also referred to as a soft button and/or a soft keyboard. In some embodiments, one display screen 1205 may be provided, and is disposed on a front panel of the computer device 1200. In some other embodiments, at least two display screens 1205 may be provided, and are respectively disposed on different surfaces of the computer device 1200 or designed in a foldable shape. In some embodiments, the display screen 1205 may be a flexible display screen, disposed on a curved surface or a folded surface of the computer device 1200. Even, the touch display screen 1205 may be further configured in a non-rectangular irregular pattern, i.e., it is a special-shaped screen. The touch display screen 1205 may be made of a liquid crystal display (LCD), an organic light-emitting diode (OLED), or other materials.

The camera assembly 1206 is configured to capture images or videos. For example, the camera assembly 1206 includes a front-facing camera and a rear-facing camera. In some examples, the front camera is configured to implement a video call or self-portrait, and the rear camera is configured to shoot a picture or a video. In some embodiments, the number of the rear cameras is at least two, each of which is any one of a main camera, a depth of field camera, and a wide-angle camera, so as to implement a background blurring function by fusing the main camera and the depth of field camera, and panoramic shooting and Virtual Reality (VR) shooting functions by fusing the main camera and the wide-angle camera. In some embodiments, the camera assembly 1206 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 1207 is configured to provide an audio interface between the user and the computer device 1200. The audio circuit 1207 may include a microphone and a speaker. The microphone is configured to acquire sound waves of a user and an environment, and convert the sound waves into an electrical signal to input to the processor 1201 for processing, or input to the radio frequency circuit 1204 for implementing voice communication. For the purpose of stereo acquisition or noise reduction, a plurality of microphones may be provided, and are respectively arranged at different portions of the computer device 1200. The microphone may alternatively be an array microphone or an omni-directional acquisition type microphone. The speaker is configured to convert electrical signals from the processor 1201 or the radio frequency circuit 1204 into sound waves. The speaker may be a film speaker, or may be a piezoelectric ceramic speaker. When the speaker is the piezoelectric ceramic speaker, the speaker not only can convert an electrical signal into acoustic waves audible to a human being, but also can convert an electrical signal into acoustic waves inaudible to a human being, for ranging and other purposes. In some embodiments, the audio circuit 1207 may further include an earphone jack.

The power supply 1208 is configured to supply power to components in the computer device 1200. The power supply 1208 may be alternating current, direct current, a primary battery, or a rechargeable battery. When the power supply 1208 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the computer device 1200 further includes one or more sensors 1209. The one or more sensors 1209 include, but are not limited to, an acceleration sensor 1210, a gyro sensor 1211, a pressure sensor 1212, an optical sensor 1213, and a proximity sensor 1214.

The acceleration sensor 1210 may detect a magnitude of acceleration on three coordinate axes of a coordinate system established with the computer device 1200. For example, the acceleration sensor 1210 may be configured to detect components of gravity acceleration on the three coordinate axes. The processor 1201 may control, based on a gravity acceleration signal acquired by the acceleration sensor 1210, the touch display screen 1205 to display the UI in a landscape view or a portrait view. The acceleration sensor 1210 may be further configured to acquire motion data of a game or a user.

The gyro sensor 1211 may detect a body direction and a rotation angle of the computer device 1200. The gyro sensor 1211 may cooperate with the acceleration sensor 1210 to acquire a three-dimensional (3D) action by the user on the computer device 1200. The processor 1201 may implement the following functions based on the data acquired by the gyro sensor 1211: motion sensing (such as changing the UI according to a tilt operation on the user), image stabilization at shooting, game control, and inertial navigation.

The pressure sensor 1212 may be disposed at a side frame of the computer device 1200 and/or a lower layer of the touch display screen 1205. When the pressure sensor 1212 is arranged on the side frame of the computer device 1200, a holding signal of the user on the computer device 1200 may be detected, and left and right hand recognition or a quick operation may be performed according to the holding signal. When the pressure sensor 1212 is arranged on the low layer of the touch display screen 1205, an operable control on the UI may be controlled according to a pressure operation on the user on the touch display screen 1205. The operable control includes at least one of a button control, a scroll-bar control, an icon control, and a menu control.

The optical sensor 1213 is configured to acquire ambient light intensity. In an embodiment, the processor 1201 may control the display brightness of the touch display screen 1205 based on the ambient light intensity acquired by the optical sensor 1213. Specifically, when the ambient light intensity is relatively high, the display brightness of the touch display screen 1205 is increased. When the ambient light intensity is relatively low, the display brightness of the touch display screen 1205 is decreased. In another embodiment, the processor 1201 may further dynamically adjust a camera parameter of the camera assembly 1206 based on the ambient light intensity acquired by the optical sensor 1213.

The proximity sensor 1214, also referred to as a distance sensor, may be disposed on a front surface of the computer device 1200. The proximity sensor 1214 is configured to acquire a distance between the user and the front surface of the computer device 1200. In an embodiment, when the proximity sensor 1214 detects that the distance between the user and the front surface of the computer device 1200 gradually becomes smaller, the display screen 1205 is controlled by the processor 1201 to switch from a screen-on state to a screen-off state. In a case that the proximity sensor 1214 detects that the distance between the user and the front surface of the computer device 1200 gradually becomes larger, the display screen 1205 is controlled by the processor 1201 to switch from the screen-off state to the screen-on state.

A person skilled in the art may understand that the structure of the computer device 1200 shown in FIG. 27 does not constitute a limitation on the mobile phone, and the mobile phone may include more or fewer components than those shown in the figure, or some components may be combined, or a different component deployment may be used.

In embodiments, this disclosure provides a chip. The chip includes a programmable logic circuit and/or program instructions. The chip is configured to, when running on a computer device, implement the UGC effect generation method in a game program provided in the foregoing method embodiments.

This disclosure provides a computer-readable storage medium, such as a non-transitory computer-readable storage medium. The computer-readable storage medium has a computer program stored therein. The computer program is loaded and executed by a processor to implement the UGC effect generation method in a game program provided in the foregoing method embodiments.

This disclosure provides a computer program product or a computer program is provided. The computer program product or the computer program includes computer instructions. The computer instructions are stored in a computer-readable storage medium. A processor of a computer device reads the computer instructions from the computer-readable storage medium. The processor executes the computer instructions, so that the processor of the computer device is enabled to implement the UGC effect generation method in a game program provided in the foregoing method embodiments.

The above sequence numbers of the examples of this disclosure are only for description, and do not represent goodness and badness of the examples.

A person of ordinary skill in the art may understand that all or a part of the steps of the embodiments may be implemented by hardware or a program instructing relevant hardware. The program may be stored in a computer-readable storage medium. The computer-readable storage medium may be a read-only memory, a magnetic disk, an optical disc or the like.

A person skilled in the art is to be aware that in one or more examples in the foregoing, the functions described in the embodiments of this disclosure may be implemented by using hardware, software, firmware or any combination thereof. When software is used for implementation, these functions may be stored in a computer-readable medium or transmitted as one or more instructions or codes in the computer-readable medium. The computer-readable medium includes a computer storage medium and a communication medium. The communication medium includes any medium that transfers a computer program from one place to another place. The storage medium may be any usable medium accessible to a general-purpose or special-purpose computer.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing are merely examples of embodiments of this disclosure and are not to be used to limit this disclosure. Any changes, equivalent replacements, and improvements made within the spirit and principle of this disclosure shall fall within the scope of this disclosure.

What is claimed is:

1. A method of generating a particle effect in a virtual environment, the method comprising:
displaying, on a display of a terminal through execution of a game program by processing circuitry of the terminal, an editor interface of a user generated content (UGC) editor;
displaying a particle generator disposed in the virtual environment on the editor interface of the UGC editor, the particle generator including a base that is visible on the editor interface and hidden on a play mode interface of the UGC editor;
receiving at least one attribute parameter for the particle generator based on an attribute setting operation on the editor interface; and
generating the particle effect in the virtual environment based on the at least one attribute parameter, the particle effect corresponding to a visualization of at least one particle generated by the particle generator in the virtual environment.

2. The method according to claim 1, wherein
the receiving the at least one attribute parameter comprises:
displaying at least two key frame control elements on the editor interface based on the attribute setting operation on the particle generator, the at least two key frame control elements corresponding to different key frame moments within a cycle period; and
obtaining an attribute parameter for each of the key frame moments based on a trigger operation on the respective key frame control element, and
the cycle period corresponds to a duration from generation to disappearance of the at least one particle.

3. The method according to claim 2, wherein the at least one attribute parameter comprises at least one of:
a color parameter indicating a color of the at least one particle,
a scale parameter indicating a scaling factor of the at least one particle,
a transparency parameter indicating a transparency level of the at least one particle, and
a brightness parameter indicating a brightness level of the at least one particle.

4. The method according to claim 1, wherein the receiving the at least one attribute parameter comprises:
determining an attribute parameter interval based on the attribute setting operation on the editor interface, the attribute parameter interval indicating a parameter range of the at least one attribute parameter of the at least one particle.

5. The method according to claim 4, wherein the at least one attribute parameter comprises at least one of:
an emission velocity indicating an initial motion velocity of the at least one particle,
an emission position indicating an initial position of the at least one particle,
a rotation angle indicating an initial rotation angle of the at least one particle, and
a rotation speed indicating an initial rotation speed of the at least one particle.

6. The method according to claim 4, further comprising:
displaying at least one of a maximum value setting control element or a minimum value setting control element on the editor interface, wherein
the determining the attribute parameter interval includes at least one of:
determining at least one maximum value of the parameter range through the at least one maximum value setting control element; and
determining at least one minimum value of the parameter range through the at least one minimum value setting control element.

7. The method according to claim 4, wherein
the at least one attribute parameter includes an emission position indicating an initial position of the at least one particle, and
the method further includes displaying an emission position control element on the editor interface based on a trigger operation on an emission position setting entry of the editor interface for the particle generator, the emission position control element including at least one of:
a spherical parameter control element,
a triangular parameter control element,
a cylindrical parameter control element, and
a user-defined parameter control element.

8. The method according to claim 7, wherein
the emission position control element includes the spherical parameter control element,
the spherical parameter control element includes a radius setting control element, and
the determining the attribute parameter interval includes:
determining a target radius based on a setting operation on the radius setting control element; and
determining an emission position interval indicating a first spatial range based on the target radius, the first spatial range corresponding to a spherical surface of a sphere and a spatial coordinate interval inside the sphere, and the sphere being determined based on the target radius as a spherical radius of the sphere.

9. The method according to claim 7, wherein
the emission position control element includes the triangular parameter control element,
the triangular parameter control element includes at least one of a side length setting control element and a triangular prism height setting control element, and
the determining the attribute parameter interval includes:
determining a first side length based on a setting operation on the side length setting control element;
determining a first prism height based on a setting operation on the triangular prism height setting control element; and
determining an emission position interval indicating a second spatial range based on at least one of the first side length and the first prism height, the second spatial range corresponding to a triangular prism surface of a triangular prism and a spatial coordinate interval inside the triangular prism, and the triangular prism being determined based on at least one of the first side length and the first prism height.

10. The method according to claim 7, wherein
the emission position control element includes the cylindrical parameter control element,
the cylindrical parameter control element includes at least one of a cylinder radius setting control element and a cylinder height setting control element, and
the determining the attribute parameter interval includes:
determining a cylinder radius based on a setting operation on the cylinder radius setting control element;
determining a cylinder height based on a setting operation on the cylinder height setting control element; and
determining an emission position interval indicating a third spatial range based on at least one of the cylinder radius and the cylinder height, the third spatial range corresponding to a cylindrical surface of a cylinder and a spatial coordinate interval inside the cylinder, and the cylinder being determined based on at least one of the cylinder radius and the cylinder height.

11. The method according to claim 7, wherein
the emission position control element includes the user-defined parameter control element,
the user-defined parameter control element includes at least one of an x-axis maximum value setting control element, an x-axis minimum value setting control element, a y-axis maximum value setting control element, a y-axis minimum value setting control element, a z-axis maximum value setting control element, and a z-axis minimum value setting control element; and
the determining the attribute parameter interval includes:
determining a maximum value of the at least one particle in an x-axis position range based on an attribute setting operation on the x-axis maximum value setting control element;
determining a minimum value of the at least one particle in the x-axis position range based on an attribute setting operation on the x-axis minimum value setting control element;
determining a maximum value of the at least one particle in a y-axis position range based on an attribute setting operation on the y-axis maximum value setting control element;
determining a minimum value of the at least one particle in the y-axis position range based on an attribute setting operation on the y-axis minimum value setting control element;
determining a maximum value of the at least one particle in a z-axis position range based on an attribute setting operation on the z-axis maximum value setting control element; and
determining a minimum value of the at least one particle in the z-axis position range based on an attribute setting operation on the z-axis minimum value setting control element.

12. The method according to claim 1, wherein
the receiving the at least one attribute parameter includes:
determining an attribute parameter value based on the attribute setting operation on the editor interface, and
the at least one attribute parameter includes at least one of:
a cycle period indicating a duration from generation to disappearance of the at least one particle,
an emission position indicating an initial position of the at least one particle,
a particle texture indicating a texture of the at least one particle,
a generation rate indicating a quantity of particles generated by the particle generator in a first unit time, and
an acceleration indicating an acceleration of the at least one particle.

13. The method according to claim 1, wherein
the editor interface includes a preview area and an editing area, the preview area being configured to provide a preview of the at least one particle generated by the particle generator, and the editing area being configured to set the at least one attribute parameter for the particle generator, and
the generating the particle effect based on the at least one attribute parameter includes:
displaying, in the preview area based on an attribute confirmation operation in the editing area, the particle effect generated by the particle generator based on the attribute parameter.

14. The method according to claim 1, further comprising:
receiving, based on a base color setting operation on the editor interface, at least one base color for the base of the particle generator.

15. The method according to claim 14, wherein the receiving the at least one base color includes at least one of:
determining, based on a trigger operation on a first base color selection operation control element displayed on the editor interface when a base bottom color control element displayed on the editor interface is in a selected state, that a base bottom color of the base of the particle generator is a color value selected from the first base color selection operation control element; and
determining, based on a trigger operation on a second color selection operation control element displayed on the editor interface when a base top color control element displayed on the editor interface is in a selected state, that a base top color of the base of the particle generator is a color value selected from the second base color selection operation control element.

16. The method according to claim 1, further comprising at least one of:
setting the particle generator to a selected state based on a selection operation on the particle generator, and adding an indicator box to the particle generator, the indicator box indicating the selected state; and
keeping the particle generator in the selected state and hiding the indicator box when the particle generator is selected for editing in the editor interface.

17. The method according to claim 1, further comprising:
configuring the particle generator to perform one or more operations based on receiving one or more corresponding trigger signals, wherein
the one or more trigger signals include at least one of:
an automatic generation signal triggering the particle generator to automatically generate the at least one particle,
a start signal triggering the particle generator to start generating the at least one particle, and
a stop signal triggering the particle generator to stop generating the at least one particle.

18. The method according to claim 1, further comprising:
receiving, based on a motion control operation on the editor interface, a motion mode for the particle generator, wherein
the motion mode for the particle generator includes one of:
a full-range motion mode,
a one-way displacement mode,
a reciprocating displacement mode,
a unidirectional rotation mode,
an oscillatory motion mode, and
a waypoint motion mode.

19. An apparatus for generating a particle effect in a virtual environment, the apparatus comprising:
a display; and
processing circuitry coupled to the display and configured to:
display, on the display through execution of a game program by the processing circuitry, an editor interface of a user generated content (UGC) editor;
display a particle generator disposed in the virtual environment on the editor interface of the UGC editor, the particle generator including a base that is visible on the editor interface and hidden on a play mode interface of the UGC editor;
receive at least one attribute parameter for the particle generator based on an attribute setting operation on the editor interface; and
generate the particle effect in the virtual environment based on the at least one attribute parameter, the particle effect corresponding to a visualization of at least one particle generated by the particle generator in the virtual environment.

20. A non-transitory computer-readable storage medium storing instructions of a game program, which when executed by a processor, cause the processor to perform a method of generating a particle effect in a virtual environment, the method comprising:
displaying, on a display of a terminal that includes the processor, an editor interface of a user generated content (UGC) editor;
displaying a particle generator disposed in the virtual environment on the editor interface of the UGC editor, the particle generator including a base that is visible on the editor interface and hidden on a play mode interface of the UGC editor;
receiving at least one attribute parameter for the particle generator based on an attribute setting operation on the editor interface; and
generating the particle effect in the virtual environment based on the at least one attribute parameter, the particle effect corresponding to a visualization of at least one particle generated by the particle generator in the virtual environment.
